(19) United States
(12) Patent Application Publication
(10) Pub. No.: US 2008/0175597 A1
(43) Pub. Date: Jul. 24, 2008

(54) Optical clock signal regeneration device

(75) Inventor: Shin Arahira, Tokyo (JP)

Correspondence Address: RABIN & Berdo, PC, 1101 14TH STREET, NW, SUITE 500, WASHINGTON, DC, 20005, US

(73) Assignee: OKI ELECTRIC INDUSTRY CO., LTD., Tokyo (JP)

(21) Appl. No.: 11/998,433

(22) Filed: Nov. 30, 2007

(30) Foreign Application Priority Data
Jan. 24, 2007 (JP) 2007-014119
Feb. 5, 2007 (JP) 2007-025863

(51) Int. Cl. H04B 10/00

(52) U.S. Cl. 398/152

(57) ABSTRACT

An optical clock signal regeneration device, which includes a mode-locking laser element, a signal light provision component and an optical clock signal formation component, is provided. The signal light provision component includes a birefringent medium, at which a polarization group delay time between orthogonal polarization signals, which is caused by a difference in refractive indices between orthogonal optical axes, is a natural number multiple of a signal time interval of an inputted signal light, and, on the basis of orthogonal polarization signal light obtained by passing input signal light which is inputted from outside through the birefringent medium, provides at least a signal light component with a light polarization direction that matches an oscillation polarization direction of the mode-locking semiconductor laser to the mode-locking laser element.

### CROSS-REFERENCE TO RELATED APPLICATION

This application claims priority under 35 USC 119 from Japanese Patent Applications No. 2007-014119 and No. 2007-025863, the disclosures of which are incorporated by reference herein.

### BACKGROUND OF THE INVENTION

1. Field of the Invention

The present invention relates to an optical clock signal regeneration device, and is applicable to, for example, an optical clock signal regeneration device that is used at an optical repeater in long-distance, high-capacity optical fiber communications.

2. Description of the Related Art

In recent years, serious increases in distance and capacity of optical communication networks have been pursued. In long-distance, high-capacity optical fiber communications, deteriorations in quality of optical signals occur after long-distance propagation, due to light losses in optical fiber propagation paths, deteriorations in SNR caused by multi-stage use of optical amplification, group velocity dispersion in optical fibers, distortion of waveforms due to non-linear optical effects in the optical fibers, and so forth. Therefore, it is common to perform regeneration of an optical signal at repeaters which are provided at intervals of certain distances (tens of kilometers to hundreds of kilometers) over a fiber propagation length. One of the main roles of such a repeater is a function of clock regeneration. This is a technology which, from a signal which has been distorted by propagation, provides a continuous pulse output (or it might be sinusoidal) with a frequency corresponding to a bit rate of the signal (hereafter referred to as a bit-rate frequency).

As such a clock regeneration technology for a long-distance optical communications system, a system which has come to be used heretofore is a system as follows. This is a process in which an input optical signal is opto-electronically converted by a photodiode or the like, an electronic output therefrom is passed through a narrow bandwidth electronic filter, of which a central frequency is close to the bit-rate frequency of the input signal, and thus only an electronic signal at the bit-rate frequency is selectively extracted. Thereafter, an optical pulse laser device such as a semiconductor laser or the like is operated using the electronic signal, and thus this process provides a continuous series of optical pulses of which repetition matches the bit-rate frequency, that is, a regenerated optical clock.

An O/E conversion characteristic of a photodiode commonly has a small dependency on polarization (light polarization) of an input optical signal. Therefore, in the above-described optical clock regeneration device that has come to be used in optical communication systems heretofore, stable clock regeneration operations without dependency on polarization planes of input optical signals could be expected.

Meanwhile, serious increases in capacity of optical communication networks are also being pursued. Signal bit rates for individual wavelength channels have been accelerated, and optical time division multiplexing (OTDM) is a system with promise for the future. When such an OTDM system is used, high-bit rate clock regeneration operations, at 40 Gigabit/s and above, are required. However, it is difficult for electronic devices to keep up with clocks with such high bit rates. For example, if the application of the above-described previous method of clock regeneration using a photodiode and an electronic narrow bandwidth filter is attempted: firstly, operational speeds of currently existing photodiodes cannot keep up; and secondly, development of corresponding narrow bandwidth filters which extract ultra-high frequency components has not been achieved. Therefore, implementation of the above-described previous clock regeneration method is difficult.

In consideration of the situation described above, as a method for generating a clock from an ultra-high speed optical signal in an optical communication network employing an OTDM system, an all-optical clock regeneration method which directly regenerates and outputs an optical clock from an optical data signal without performing an opto-electronic conversion is desirable.

### REFERENCES

Reference 1: Japanese National Publication No. 7-506231
Reference 2: Japanese Patent Application Laid-open (JP-A) No. 2004-363873
Reference 3: JP-A No. 6-88981
Reference 4: T. Ono, T. Shimizu, Y. Yano, and H. Yokoyama, “Optical clock extraction from 10-Gbit/s data pulses by using monolithic mode-locked laser diodes”, OFC '95 Technical Digest, ThL4
Reference 5: S. Arahira and Y. Ogawa, “Retiming and reshaping function of all-optical clock extraction at 160 Gb/s in monolithic mode-locked laser diode”, IEEE Journal of Quantum Electronics, vol. 41, No. 7, pp. 937 to 944, 2005
Reference 6: H. A. Haus, “Theory of mode locking with a slow saturable absorber”, IEEE Journal of Quantum Electronics, vol. QE-11, No. 9, pp. 736 to 746, 1975.
Reference 7: D. J. Derickson, R. J. Helkey, A. Mar, J. R. Karin, J. G. Wasserbauer, and J. E. Bowers, “Short pulse generation using multisegment mode-locked semiconductor lasers”, IEEE Journal of Quantum Electronics, vol. 28, No. 10, pp. 2186 to 2202, 1992
Reference 8: Toshio Morioka, “Research into ultra high speed all-optical switches”, thesis, Waseda University Faculty of Science and Engineering Postgraduate School, December 1995
Reference 9: Masanori Hanawa, Toshiya Fujimoto, and Kazuhiko Nakamura, “Clock extraction from high-speed NRZ optical signal by π-shift FBG”, 2005 General Conference of the Institute of Electronics, Information and Communication Engineers, B-10-111

As an all-optical clock regeneration system, methods which use mode-locking lasers have been reported in the disclosures of reference 1 and reference 4 heretofore. That is, at a mode-locking laser which generates pulses with a repetition close to the bit-rate frequency of an input optical signal, signal light is inputted and pulse repetition of the mode-locking laser is synchronized with the bit rate of the optical signal, and thus optical clock regeneration is performed.

In reference 1, all-optical clock regeneration using a fiber-type mode-locking laser is described. Therein, the optical clock pulses which cycle in the fiber laser consequent to the input of data light are modulated with the data light by cross-phase modulation (XPM) in accordance with the optical Kerr effect, which is one type of non-linearity optical effect. As a result, the optical clock pulses cycling in the fiber laser are synchronized with the input signal light, and hence a regenerated optical clock is provided.

Furthermore, in reference 1 and reference 4, a method using a passive mode-locking semiconductor laser with a saturable absorber is described. Therein, an absorption coefficient of the saturable absorber is modulated principally by the input of data light, the optical clock pulses cycling in the passive mode-locking semiconductor laser are synchronized with the input signal and, as a result, a regenerated optical clock is provided.

In reference 5, all-optical clock regeneration with a data rate of 160 Gbit/s using a passive mode-locking semiconductor laser with a repetition of 160 GHz is reported, which illustrates that all-optical clock regeneration technologies using mode-locking semiconductor lasers are useful as clock regeneration technologies for ultra-high speed data signals, such as OTDM signals.

However, in previous systems of all-optical clock regeneration methods using mode-locking lasers, clock regeneration operations have been greatly dependent on light polarization states of the input optical signals. That is, if a polarization (light polarization) state of an input optical signal concurs with the oscillation polarization (light polarization) state of a mode-locking semiconductor laser, excellent clock regeneration operations are obtained, but if the same are orthogonal, excellent clock regeneration operations are not obtained.

Optical fibers which act as long-distance light propagation media for optical signals (usually single-mode optical fibers) do not have any polarization (light polarization)-preservation ability at all. Therefore, even if an optical signal that has been accurately controlled to a certain polarization (light polarization) state is inputted at an input end of an optical fiber, the polarization (light polarization) plane of the optical signal being propagated in the optical fiber is turned at random in accordance with conditions of installation of the optical fiber, the environment therearound along the propagation path, and suchlike. Thus, at an output end, a horizontal polarization (light polarization) state signal component and a vertical polarization (light polarization) state signal component end up matching one another.

As a result, all-optical clock regeneration operations of a mode-locking laser receiving this output optical signal become unstable, which is a problem that remains to be solved.

In order to address this problem, a means for eliminating a polarization (light polarization) plane dependency of all-optical clock regeneration operations of a mode-locking laser has been described in reference 2.

The technology described in reference 2 will be simply explained with reference to FIG. 35. A light polarization beam splitter 3-1 separates an input optical signal S10 into a horizontal polarized plane component (S11), which matches an oscillation polarization (light polarization) plane of a passive mode-locking semiconductor laser, and a vertical polarization (light polarization) component (S12), which is orthogonal thereto. The horizontal polarization (light polarization) component is inputted at one resonator end face R of a passive mode-locking semiconductor laser 14, which end face preserves a light polarization state. Meanwhile, the light polarization state of the vertical polarization (light polarization) component is turned through 90° by a Faraday device 12, is aligned with the resonator end faces of the passive mode-locking semiconductor laser 14, and is inputted at the other resonator end face L of the passive mode-locking semiconductor laser 14. By employing the structure described above, an all-optical clock regeneration operation which has no dependency on a polarization (light polarization) plane of an input optical signal is proposed.

However, with the technology illustrated in reference 2, in comparison with the technologies illustrated in reference 4, reference 5 and reference 1, multiples of additional optical components such as the light polarization beam splitter, a phase regulator, a gain regulator and the like are required, and a structural arrangement thereof is complicated. This brings about an increase in costs, due to the increase in the number of components and more complex assembly, and also an increase in equipment size. In optical communication systems in practice, small size, simplicity of structure and lowered costs are strongly required. Therefore, provision of a lower-cost device with a simpler structure than the technology illustrated in reference 2 may be required.

Moreover, with the technology illustrated in reference 2, there is the following problem: In such a system, both of the resonator end faces of the passive mode-locking semiconductor laser are used for inputting the input optical signal to the passive mode-locking semiconductor laser. Therefore, reflectances of the two resonator end faces must both be low enough to guide the input optical lights into the passive mode-locking semiconductor laser. That is, if one or other of the end face reflectances of the passive mode-locking semiconductor laser is very high, then required all-optical clock regeneration operations which are independent of the polarization (light polarization) state of the input optical signal may not be obtained.

Further, cases in which there is a necessity to raise an end face reflectance of the passive mode-locking semiconductor laser can be considered. This may be important particularly for an increase in speed of the repetition frequency of the passive mode-locking semiconductor laser, which is to say, an increase in speed of a clock frequency of the regenerated optical clock signal in the optical clock regeneration operations which are an object of the present invention. This necessity arises due to circumstances as described following.

Firstly, a repetition frequency of a passive mode-locking semiconductor laser is inversely proportional to resonator length. That is, as the repetition frequency increases with an increase in speed, it is necessary for the resonator length of the passive mode-locking semiconductor laser to be made shorter. However, a lasing threshold of the laser increases when the resonator length is made shorter. Therefore, in order to increase the speed of a repetition frequency, to enable laser oscillation, it is first necessary to lower resonator losses of the passive mode-locking semiconductor laser with the shortened resonator. Resonator losses of a laser are a sum of propagation losses within the resonator and reflection losses at the resonator end faces, and are reduced when the reflectances of the resonator end faces are higher.

Secondly, in order to increase the repetition frequency of a passive mode-locking semiconductor laser, it is of course necessary to correspondingly narrow the width of the light pulses that are generated. Reference 6 is a theoretical investigation into pulse characteristics of passive mode-locking lasers, and illustrates, in FIG. 26A to FIG. 26H thereof, a reciprocal relationship between the Q value of a resonator and pulse width. The Q value of a resonator is a value proportional to a reciprocal of resonator losses, which illustrates that a reduction in resonator losses is an important parameter for an increase in speed of a repetition frequency of a passive mode-locking semiconductor laser.

Furthermore, if one end face of a saturable absorption region serves as a resonator end face, and that resonator end face is coated with a high-reflection film, colliding-pulse mode-locking operations will arise, and an absorption saturation energy of the saturable absorption region may be effectively reduced, which is illustrated in FIG. 14, etc. of reference 7. This means that an improvement in stability of mode-locking operations is desirable.

Considering these various circumstances, if an all-optical clock regeneration device can be realized using a passive mode-locking semiconductor laser in which a high-reflection film has been formed at one resonator end face, then desirable effects in practice can be anticipated, such as an increase in operation speed, which is to say an increase in speed of the clock frequency of the optical clock signal that is regenerated, a shortening of pulses of the regenerated optical clock signal, an improvement in stability, and the like.

### SUMMARY OF THE INVENTION

One object of the present invention is to provide an optical clock signal regeneration device that has a relatively simple device structure and is capable of generating a regenerated optical clock signal from an optical signal, at a repetition frequency (clock frequency) that matches a bit-rate frequency of the optical signal, without being dependent on a light polarization state of the input optical signal.

Another object of the present invention is to provide an optical clock signal regeneration device that, even if a passive mode-locking semiconductor laser in which a high-reflection film has been formed at one resonator end face is used, is capable of generating a regenerated optical clock signal from an optical signal, at a repetition frequency (clock frequency) matching a bit-rate frequency of the optical signal, without being dependent on a light polarization direction of the input optical signal.

An optical clock signal regeneration device of one aspect of the present invention includes: (1) a mode-locking laser element that oscillates laser oscillation light in the form of a series of light pulses with a repetition frequency close to a bit-rate frequency of an inputted signal light; (2) a signal light provision component that includes a birefringent medium, at which a polarization (light polarization) group delay time between orthogonal polarization (light polarization) signals, which is caused by a difference in refractive indices between orthogonal optical axes, is a natural number multiple of a signal time interval of the inputted signal light, and, on the basis of orthogonal polarization (light polarization) signal light obtained by passing input signal light which is inputted from outside through the birefringent medium, provides at least a signal light component with a light polarization direction that matches an oscillation polarization (light polarization) direction of the mode-locking semiconductor laser to the mode-locking laser element; and (3) an optical clock signal formation component that forms a regenerated optical clock signal based on the laser oscillation light in the form of the series of light pulses oscillated from the mode-locking laser element.

An optical clock signal regeneration device of another aspect of the present invention includes: (1) a mode-locking laser element that oscillates laser oscillation light in the form of a series of light pulses with a repetition frequency close to a bit-rate frequency of an inputted signal light; (2) a signal light provision component that includes a polarization (light polarization) separation section that polarization (light polarization)-separates inputted input signal light, adjusts a polarization (light polarization) direction of at least one of one polarization (light polarization)-separated light and another polarization (light polarization)-separated light with respectively orthogonal optical axes, which have been polarization (light polarization)-separated by the polarization (light polarization) separation section, such that the respective polarization (light polarization) directions of the two polarization (light polarization)-separated lights match, adjusts a signal time interval such that a time interval between the two polarization (light polarization)-separated lights is a natural number multiple of a signal time interval of the input signal light, and provides coupled light, in which the one polarization (light polarization)-separated light and the other polarization (light polarization)-separated light are coupled, to the mode-locking laser element; and (3) an optical clock signal formation component that forms a regenerated optical clock signal based on the laser oscillation light in the form of the series of light pulses oscillated from the mode-locking laser element.

According to the present invention, there is a simpler structure and it is possible to generate a regenerated optical clock signal from an optical signal, at a repetition frequency (clock frequency) that matches a bit-rate frequency of the optical signal, without dependency on a light polarization state of the input optical signal.

According to an optical clock regeneration device of the present invention, it is possible to generate a regenerated optical clock signal from an optical signal, at a repetition frequency (clock frequency) matching a bit-rate frequency of the optical signal, without dependency on a light polarization direction of the input optical signal. Thus, an increase in speed of the clock frequency of the regenerated optical clock signal, and a shortening of pulses and an improvement in stability of the regenerated optical clock signal are enabled.

### BRIEF DESCRIPTION OF THE DRAWINGS

FIG. 1 is a structural block diagram of an optical clock signal regeneration device of a first embodiment of the present invention.

FIG. 2 is a diagram showing a structural example of a mode-locking semiconductor laser of the first embodiment of the present invention.

FIG. 3A and FIG. 3B are diagrams showing relationships in the first embodiment of the present invention between light polarization directions of light passing through a polarization (light polarization)-dependent type isolator, optical axis directions of a birefringent medium, and an oscillation polarization (light polarization) direction of the mode-locking semiconductor laser.

FIG. 4A to FIG. 4C are explanatory diagrams describing signal waveforms and polarization (light polarization) states of an input optical signal and optical clock signals in the first embodiment of the present invention.

FIG. 5A and FIG. 5B are diagrams showing polarization extinction ratio (PER) dependencies of minimum values and maximum values of normalized average intensities of an optical signal in the first embodiment of the present invention.

FIG. 6 is a diagram showing a dependency of timing jitter of an optical clock signal on input light intensity in the first embodiment of the present invention.

FIG. 7 is a diagram showing a dependency of time jitter of the optical clock signal on polarization (light polarization) of the input light in the first embodiment of the present invention.

FIG. 8 is views showing sampling oscilloscope observation waveforms of respective signals in cases between which a polarization extinction ratio of the input optical signal is varied, in the first embodiment of the present invention.

FIG. 9 is views showing a comparison of sampling oscilloscope waveforms of regenerated optical clock signals in cases in which a polarization (light polarization) state of the input optical signal is changed to form a polarization (light polarization)-scrambled signal, for the first embodiment of the present invention.

FIG. 10 is a structural block diagram of an optical clock signal regeneration device of a second embodiment of the present invention.

FIG. 11A and FIG. 11B are diagrams showing relationships in the second embodiment of the present invention between light polarization directions of light passing through a polarization (light polarization)-dependent type optical isolator, optical axis directions of a birefringent medium, and an oscillation polarization (light polarization) direction of a mode-locking semiconductor laser.

FIG. 12A and FIG. 12B are explanatory diagrams describing signal waveforms and polarization (light polarization) states of an input optical signal and an optical clock signal in the second embodiment of the present invention.

FIG. 13 is a structural block diagram of an optical clock signal regeneration device of a third embodiment of the present invention.

FIG. 14A and FIG. 14B are diagrams showing relationships in the third embodiment of the present invention between light polarization directions of light passing through a polarization (light polarization)-dependent type optical isolator, optical axis directions of a birefringent medium, and an oscillation polarization (light polarization) direction of a mode-locking semiconductor laser.

FIG. 15A to FIG. 15C are explanatory diagrams describing signal waveforms and polarization (light polarization) states of an input optical signal and optical clock signals in the third embodiment of the present invention.

FIG. 16 is a structural block diagram of an optical clock signal regeneration device of a fourth embodiment of the present invention.

FIG. 17 is a block diagram showing a variant example of structure of the optical clock signal regeneration device of the fourth embodiment of the present invention.

FIG. 18A and FIG. 18B are diagrams showing relationships in the fourth embodiment of the present invention between light polarization directions of light passing through a polarization (light polarization)-dependent type optical isolator, optical axis directions of a birefringent medium, and an oscillation polarization (light polarization) direction of a mode-locking semiconductor laser.

FIG. 19A to FIG. 19C are explanatory diagrams describing signal waveforms and polarization (light polarization) states of an input optical signal in the fourth embodiment of the present invention.

FIG. 20A to FIG. 20C are diagrams showing a structural example of a variable birefringence medium of the fourth embodiment of the present invention.

FIG. 21 is a structural block diagram of an optical clock signal regeneration device of a fifth embodiment of the present invention.

FIG. 22 is an explanatory view describing the generation of an RZ converted signal by a delay interferometer in the fifth embodiment of the present invention.

FIG. 23A to FIG. 23C are explanatory diagrams describing signal waveforms and polarization (light polarization) states of an input optical signal and optical clock signals in the fifth embodiment of the present invention.

FIG. 24 is a structural block diagram of an optical clock signal regeneration device of a sixth embodiment of the present invention.

FIG. 25 is a diagram showing a structural example of a mode-locking semiconductor laser of the sixth embodiment of the present invention.

FIG. 26A to FIG. 26H are explanatory diagrams describing signal waveforms and polarization (light polarization) states of an input optical signal and optical clock signals in the sixth embodiment of the present invention.

FIG. 27 is a diagram showing a dependency of timing jitter of an optical clock signal on input light intensity in the sixth embodiment of the present invention.

FIG. 28 is a diagram showing a dependency of timing jitter of the optical clock signal on a polarization extinction ratio of input light in the sixth embodiment of the present invention.

FIG. 29 is views showing sampling oscilloscope observation waveforms of respective signals in cases between which a polarization extinction ratio of the input optical signal is varied, in the sixth embodiment of the present invention.

FIG. 30 is a block diagram of a variant structure of the optical clock signal regeneration device of the sixth embodiment of the present invention.

FIG. 31A to FIG. 31J are explanatory diagrams describing signal waveforms and polarization (light polarization) states of an input optical signal and optical clock signals in the variant structure of the sixth embodiment of the present invention.

FIG. 32 is a structural block diagram of an optical clock signal regeneration device of a seventh embodiment of the present invention.

FIG. 33 is an explanatory view describing the generation of an RZ converted signal by a delay interferometer in the seventh embodiment of the present invention.

FIG. 34A to FIG. 34H are explanatory diagrams describing signal waveforms and polarization (light polarization) states of input optical signal and optical clock signals in the seventh embodiment of the present invention.

FIG. 35 is a diagram showing a structural example of an optical clock signal regeneration device in the related art.

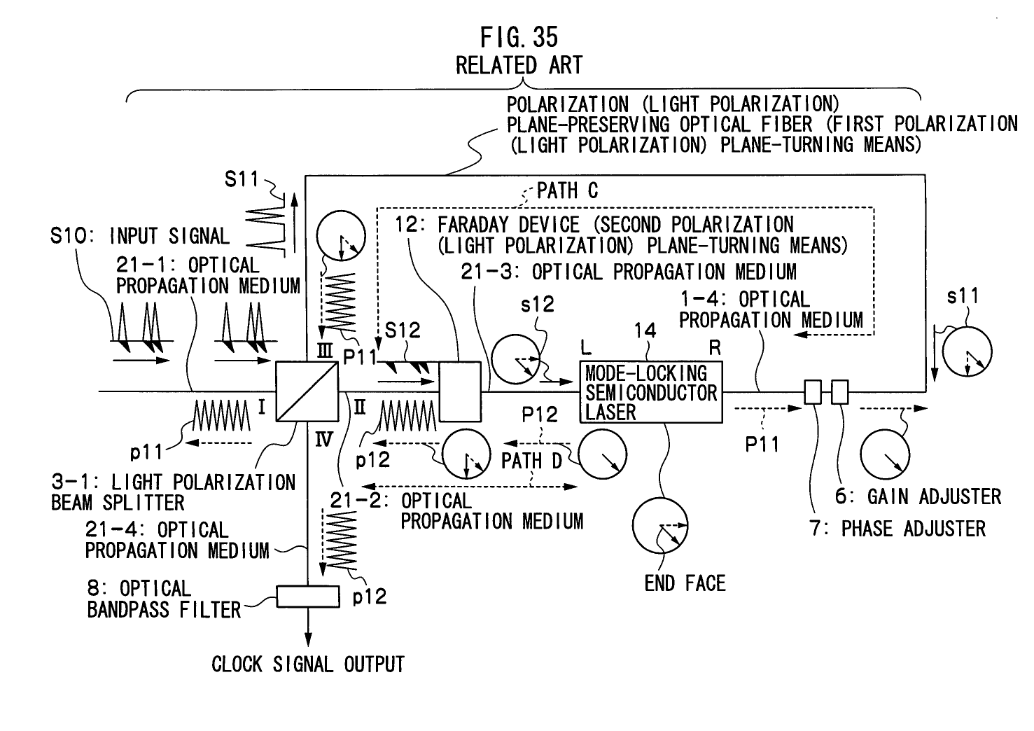

### DETAILED DESCRIPTION OF THE INVENTION

### (A) First Embodiment

Below, a first embodiment in which an optical clock signal regeneration device of the present invention is employed will be described in detail with reference to the drawings.

### (A-1) Structure of the First Embodiment

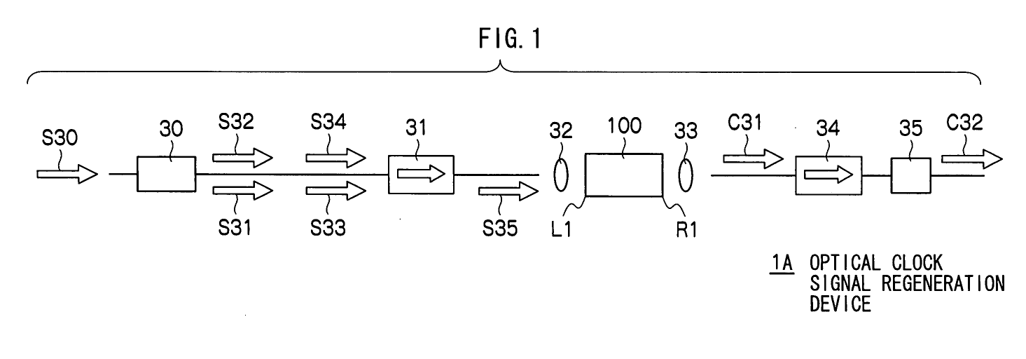

FIG. 1 is a block structural diagram describing structure of an optical clock signal regeneration device 1A of the first embodiment.

In FIG. 1, the optical clock signal regeneration device 1A of the first embodiment is structured to include at least a mode-locking semiconductor laser 100, a birefringent medium 30, a polarization (light polarization)-dependent type optical isolator 31, focusing lenses 32 and 33, an optical isolator 34 and a wavelength filter 35.

In FIG. 1, S30 indicates an input optical signal (signal light), of which a bit rate is f_{bit-rate} (bit/s) and a polarization (light polarization) state is undefined. A frequency corresponding to the bit rate is defined as being a bit-rate frequency. That is, a bit-rate frequency corresponding to the input optical signal with bit rate f_{bit-rate} (bit/s) is f_{bit-rate} (Hz). A signal time interval T_{bit-rate} of the input optical signal is provided by a reciprocal of the bit-rate frequency. That is, the signal time interval T_{bit-rate} of the input optical signal with bit rate f_{bit-rate} (bit/s) is 1/f_{bit-rate} (s).

The mode-locking semiconductor laser 100 is a passive mode-locking semiconductor laser which includes resonator end faces R1 and L1, and in which a repetition frequency of an optical pulse series generated when mode-locking operations occur is close to the bit-rate frequency of the input optical signal. The condition that the repetition frequency of the passive mode-locking semiconductor laser is close to the bit-rate frequency of the input optical signal means that a difference between the bit-rate frequency of the input optical signal and the repetition frequency of oscillation light in the form of a pulse series generated by the passive mode-locking semiconductor laser is small to such an extent that a frequency pulling effect is manifested.

The mode-locking semiconductor laser 100 is desirably a semiconductor laser with a multi-electrode structure. Moreover, it is desirable that the mode-locking semiconductor laser 100 assures operational stability in practice and, with a view to providing the device at a lower cost, is an integrated semiconductor laser which is not structured with an external resonator using focusing lenses or the like.

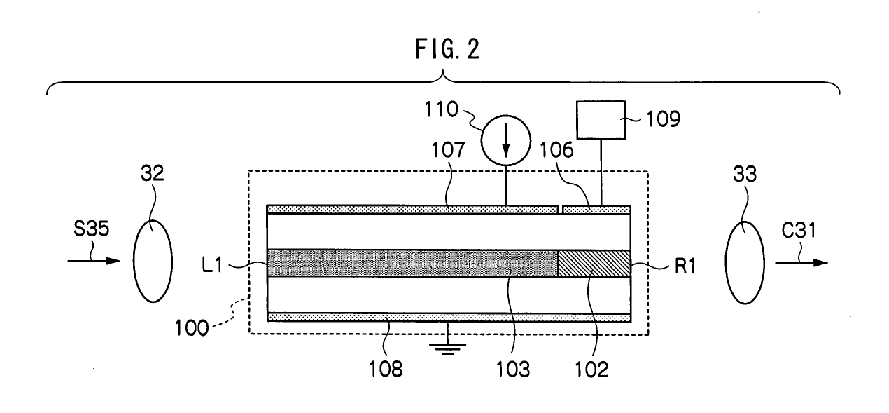

FIG. 2 is a diagram showing a structural example of the mode-locking semiconductor laser 100. The mode-locking semiconductor laser 100 of FIG. 2 illustrates an example of a two-electrode passive mode-locking semiconductor laser. An element structure of the mode-locking semiconductor laser 100 is structured with a gain region 103, for providing laser oscillation, and a saturable absorption region 102, which operates as an optical switch for mode-locking operations. Current is applied to the gain region 103 from a constant current source 110 via a p-type electrode 107 and an n-type common electrode 108, and a reverse bias voltage is applied to the saturable absorption region 102 from a constant voltage source 109 via a p-type electrode 106 and the n-type common electrode 108. Hence, a passive mode-locking operation occurs, and an optical pulse series with a repetition frequency close to a natural number multiple of a resonator cycling frequency of the element is generated.

The element structure of the mode-locking semiconductor laser 100 is not limited to the structure shown in FIG. 2. A structure in which a passive waveguide region, a distributed Bragg reflector region and the like are integrated could also provide the effects of the first embodiment. Moreover, for objectives such as an improvement in pulse characteristics and the like, the gain region could just as well have a plurally divided structure. Further, arrangements of such a gain region, saturable absorption region, passive waveguide region and distributed Bragg reflector region are not particularly limited. For example, there could be an element structure in which the saturable absorption region, gain region and passive waveguide region are arranged in this order in a propagation direction of the optical pulses, and there could be an element structure in which the saturable absorption region, passive waveguide region and gain region are arranged in this order. In regard to material type, parallel mode-locking semiconductor lasers which use various semiconductor compounds, such as an InP-type, a GaAs-type or the like, in accordance with desired operation wavelengths can be employed. Further yet, a substrate that is used is not limited to an n-doped substrate and could just as well be a p-doped substrate.

Herebelow, where it is necessary to schematically describe a wave direction and signal waveform of an optical data signal (hereafter referred to simply as an optical signal), an optical clock signal or the like, linear polarization (light polarization) light having a light polarization direction perpendicular to the plane of a drawing will be defined as TE polarization (light polarization) light. Linear polarization (light polarization) light that is orthogonal to such TE polarization (light polarization) light, having a light polarization direction in the plane of a drawing, will be defined as TM polarization (light polarization) light. An oscillation polarization (light polarization) direction of the mode-locking semiconductor laser 100 will be defined as the TE polarization (light polarization).

The birefringent medium 30 is a birefringent medium featuring birefringence, such as a birefringent optical crystal, a birefringent optical fiber or the like. For example, a uniaxial crystal, biaxial crystal, or any type of optical crystal may be employed as the birefringent medium 30. Furthermore, the birefringent medium 30 need not be an optical crystal; amorphous materials such as a birefringent optical fiber as mentioned above or the like, or oriented polymer films, can be widely employed as long as they satisfy the conditions described below.

For reasons described below, the birefringent medium 30 is formed with a length of the birefringent medium 30 having been adjusted such that a total amount of a polarization (light polarization) delay time difference between signal lights of orthogonal polarizations (light polarizations), which is caused by a difference in refractive indices between orthogonal optical axes, is n×T_{bit-rate} (n is an integer other than zero). Moreover, the birefringent medium 30 is desirably a transparent medium with light losses that are as small as possible for a wavelength of the input optical signal S30. Alternatively, the birefringent medium 30 may be a birefringent medium with optical gain, such as an erbium-containing birefringent optical fiber or the like.

The polarization (light polarization)-dependent type optical isolator 31 transmits, of inputted light, only light with a certain light polarization direction, and blocks all output light when light is inputted in the opposite direction. This is a “polarization (light polarization)-dependent type optical isolator”. This kind of polarization (light polarization)-dependent type optical isolator 31 may be easily fabricated using, for example, a light polarization prism, a Faraday rotator, as have been widely known heretofore, or a previously known optical isolator fabricated using such components may be employed.

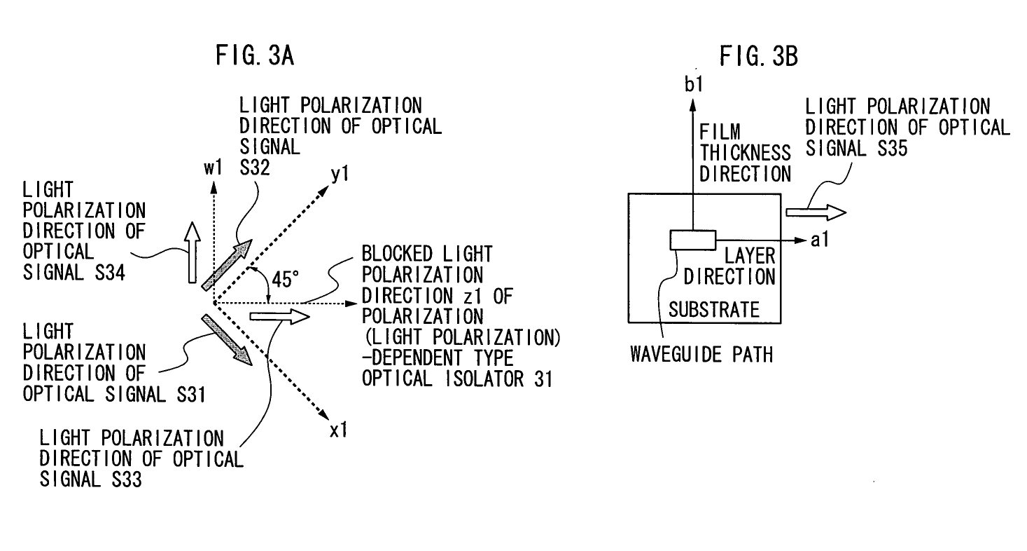

Light polarization directions of light that passes through the polarization (light polarization)-dependent type optical isolator 31, the optical axis directions of the birefringent medium 30, and the oscillation polarization (light polarization) direction of the mode-locking semiconductor laser 100 have the relationships illustrated in FIG. 3A and FIG. 3B.

That is, a light polarization direction of light that passes through the polarization (light polarization)-dependent type optical isolator 31 and is outputted (in the drawings, the light parallel to the light polarization direction of the optical signal S35) coincides with the oscillation polarization (light polarization) direction of the mode-locking semiconductor laser 100 (the TE polarization (light polarization) direction, which is the direction of axis a1). Further, the light polarization direction of the light that passes through the polarization (light polarization)-dependent type optical isolator 31 and is allowed to be outputted, when entering the polarization (light polarization)-dependent type optical isolator 31 (the direction of axis z1), is set to form angles of 45° with the orthogonal optical axis directions of the birefringent medium 30 (axis x1 and axis y1).

The focusing lens 32 and the focusing lens 33 are disposed at one resonator end face L1 and the other resonator end face R1 of the mode-locking semiconductor laser 100, and are focusing lenses for focusing between the mode-locking semiconductor laser 100 and optical fibers or the like.

As described above, a light path passing through the optical components 30 to 32 is desirably structured by a polarization (light polarization)-preserving optical system that includes the optical components 30 to 32. Alternatively, it is possible to obtain the effects of the first embodiment by including a polarization (light polarization) plane controller, which controls polarization (light polarization) plane preservation, at a suitable location on the light path such as, for example, a location at which the birefringent medium 30 connects with the polarization (light polarization)-dependent type optical isolator 31, a location at which the polarization (light polarization)-dependent type optical isolator 31 connects with the focusing lens 32, or the like.

It is desirable to include the optical isolator 34 on the optical path of an optical clock signal that is outputted from the mode-locking semiconductor laser 100, in order to prevent operational instability due to back-reflected light. This optical isolator 34, as long as it can block back-reflected light, could just as well be either a polarization (light polarization)-dependent type optical isolator as described above or a polarization (light polarization)-independent type optical isolator which transmits light of arbitrary polarization (light polarization) directions in only one direction.

The wavelength filter 35 may be included on the optical path of the optical clock signal that is outputted from the mode-locking semiconductor laser 100. The wavelength filter 35 transmits only a wavelength component of the optical clock signal and blocks light of a wavelength component of the input optical signal. As the wavelength filter 35, it is possible to employ a previously known optical filter, provided it transmits only the optical clock signal wavelength component.

### (A-2) Operation of the First Embodiment

Next, operation of the optical clock signal regeneration device 1A of the first embodiment will be described with reference to the drawings. Operations of the optical clock signal regeneration device 1A of the first embodiment are principally realized by the following two steps.

(A) A step of obtaining the optical signal S35 with the TE polarization (light polarization) from the input optical signal S30 with undefined polarization (light polarization), and (B) a step of generating a regenerated optical clock signal C31 by inputting the optical signal S35.

Firstly, operations of step (A) will be described with reference to the drawings.

In FIG. 1, the input optical signal S30, which has been transmitted through an optical fiber propagation network or the like and is undefined polarization (light polarization) light, is inputted to the birefringent medium 30.

When the input optical signal S30 is inputted to the birefringent medium 30, the optical signal is divided in the birefringent medium 30 into light polarization components parallel to the orthogonal optical axes x1 and y1, propagates within the birefringent medium 30, and is then outputted from the birefringent medium 30. Of the optical signal outputted from the birefringent medium 30, the component with light polarization parallel to the optical axis x1 serves as an optical signal S31, and the component with light polarization parallel to the optical axis y1 serves as an optical signal S32.

Here, due to the birefringence function of the birefringent medium 30, a relative phase difference (θ) between respective optical carrier waves and a relative group delay time difference (ΔT) between respective wave speeds arise between the optical signal S31 and the optical signal S32. A polarization (light polarization) group delay time difference over a unit of length is sometimes referred to as a “polarization mode dispersion” or “differential group delay” in the field of optical communications.

Now, the relative phase difference θ between the optical carrier waves of the optical signal S31 and the optical signal S32 is represented by the following equation.

$$θ = \frac{2 π}{{λ}_{s}} Δ n L \qquad ( 1 )$$

Therein, λs represents the wavelength of the input optical signal, Δn represents birefringence of the birefringent medium 30, and L represents a length of the birefringent medium 30.

The relative group delay time difference ΔT of the respective wave speeds, if the birefringent medium 30 is transparent for the wavelength of the input optical signal, is provided by the following equation.

$$Δ T = \frac{Δ n}{c} L \qquad ( 2 )$$

Therein, c represents the speed of light in a vacuum.

Herein, for reasons that will be described for step (B) hereafter, the length of the birefringent medium 30 is set such that ΔT is a natural number multiple of the signal time interval of the input optical signal S30, that is to say, nT_{bit-rate} (n being a natural number).

ΔT=nT_{bit-rate} (n is a natural number) (3)

Now, a specific example of a design process for the length of the birefringent medium 30 will be described.

For example, a case of employing a PANDA fiber, which is commonly used in optical communications, as the birefringent medium 30 will be considered. For the 1.5-μm wavelength band, a typical value of Δn (referred to as modal birefringence in cases of optical fibers) of a PANDA fiber is of the order of 3×10⁻⁴.

In such a case, from equation (2), the polarization (light polarization) mode dispersion ΔT of the PANDA fiber is of the order of around 1 ps/m. If the bit rate of the input optical signal S30 is at 40 Gbit/s, then the signal time interval T_{bit-rate} is 25 ps.

Therefore, if n=1, that is, if the polarization (light polarization) group delay time is set to a time difference corresponding to 1 bit, then a length of the PANDA fiber that satisfies equation (3) is 25 m.

For PANDA fibers, it is known that there is no significant deterioration in characteristics even when wound round a bobbin with a diameter of the order of 5 cm or suchlike. Furthermore, the size of such a fiber can be a diameter of around 400 μm.

Therefore, when a PANDA fiber of such a length is added to the device, an increase in size of the device does not cause a problem in regard to installation. Furthermore, because PANDA fibers are already widely distributed in the market, a cost increase can be restrained.

As a further example, a case of employing an optical crystal as the birefringent medium 30 will be considered. In this case, the birefringent medium 30 can just as well be a uniaxial crystal or a biaxial crystal, as long as the polarization (light polarization) group delay time caused by birefringence satisfies equation (3).

Here, a more compact device structure can be enabled by using an optical crystal with a large birefringence. For example, a case of using an yttrium vanadate (YVO₄) crystal, which has been used in recent years as an optical isolator material for optical communications, is tested.

Refractive indices n of a YVO₄ crystal are around 1.9447 (for ordinary light) and 2.1486 (for extraordinary light) for a wavelength of 1.55 μm. Therefore, taking a difference therebetween, the birefringence Δn is around 0.2039.

If the bit rate of the input optical signal S30 is 40 Gbit/s (T_{bit-rate}=25 ps) and n=1, then the length of a YVO₄ crystal that satisfies equation (3) is about 36.8 mm. Compared to the previously described example using a PANDA fiber, this value is about 1/700 of the length. Thus, a further reduction in size of the device structure is enabled.

As is seen from equation (3), when the bit rate of the input optical signal S30 is increased and the signal time interval T_{bit-rate} is reduced, the required group delay time difference ΔT is reduced. That is, the higher the bit rate of the optical signal, the smaller in size the birefringent medium 30 can be, and hence the smaller in size the device can be.

If a hypothetical application of the optical clock signal regeneration device 1A of the first embodiment to an optical signal with a high bit rate is considered, this reduction in device size in accordance with an increase in the applied bit rate is preferable for industrial applications.

Resuming the description of operations of FIG. 1, when the optical signal S31 and the optical signal S32 are outputted from the birefringent medium 30, the optical signal S31 and the optical signal S32 are respectively inputted to the polarization (light polarization)-dependent type optical isolator 31. The optical signal S35 that is outputted from the polarization (light polarization)-dependent type optical isolator 31 is inputted, via the focusing lens 32, to the mode-locking semiconductor laser 100.

Now, the transmission light polarization direction of transmission through the polarization (light polarization)-dependent type optical isolator 31 is z1, and the light polarization direction orthogonal to this transmission light polarization direction z1 is w1. Here, the axis directions z1 and w1 form respective angles of 45° with the light polarization directions of the optical signal S31 and the optical signal S32.

Thus, this means that an optical signal that can pass through the polarization (light polarization)-dependent type optical isolator 31 is only an optical signal S33 with a light polarization direction parallel to z1 which is obtained by combining the optical signal S31 and the optical signal S32. In contrast, an optical signal S34 with a light polarization direction parallel to w1 which is obtained by combining the optical signal S31 and the optical signal S32 cannot pass through the polarization (light polarization)-dependent type optical isolator 31 but is blocked.

The light polarization direction of the optical signal that can pass through the polarization (light polarization)-dependent type optical isolator 31 matches the oscillation polarization (light polarization) direction of the mode-locking semiconductor laser 100 (i.e., the TE polarization (light polarization) direction). Therefore, the light polarization direction of the optical signal S35 that is outputted from the polarization (light polarization)-dependent type optical isolator 31 matches the oscillation polarization (light polarization) direction of the mode-locking semiconductor laser 100 (the TE polarization (light polarization) direction).

In other words, the polarization (light polarization) direction of the optical signal S35 that is inputted to the mode-locking semiconductor laser 100 always matches the oscillation polarization (light polarization) direction of the mode-locking semiconductor laser 100 regardless of an initial polarization (light polarization) state of the input optical signal S30, and can be set to TE polarization (light polarization) light.

This can be simply realized by using a polarization (light polarization)-preserving optical system as the optical components 30 to 32, or by including a polarization (light polarization) plane controller at a suitable position of a light path of the optical components 30 to 32.

Consequently, the optical signal S35 is always inputted to the mode-locking semiconductor laser 100 with the TE polarization (light polarization), regardless of a polarization (light polarization) state of the input optical signal S30. Furthermore, similarly to the cases of reference 1 and reference 4, optical clock signal regeneration effects are caused at the mode-locking semiconductor laser 100 by the application of the effects of step (B), which is described in detail below, and a desired optical clock signal can be obtained.

Next, operations of step (B) will be described with reference to the drawings.

By the processing described for step (A), the optical signal S35 inputted to the mode-locking semiconductor laser 100 can always be set to the TE polarization (light polarization) regardless of a polarization (light polarization) state of the input optical signal S30.

The next matter to be considered is whether a signal waveform of the optical signal S35 changes in some way in accordance with a polarization (light polarization) state of the input optical signal S30, and whether this then in some way affects clock signal regeneration operations.

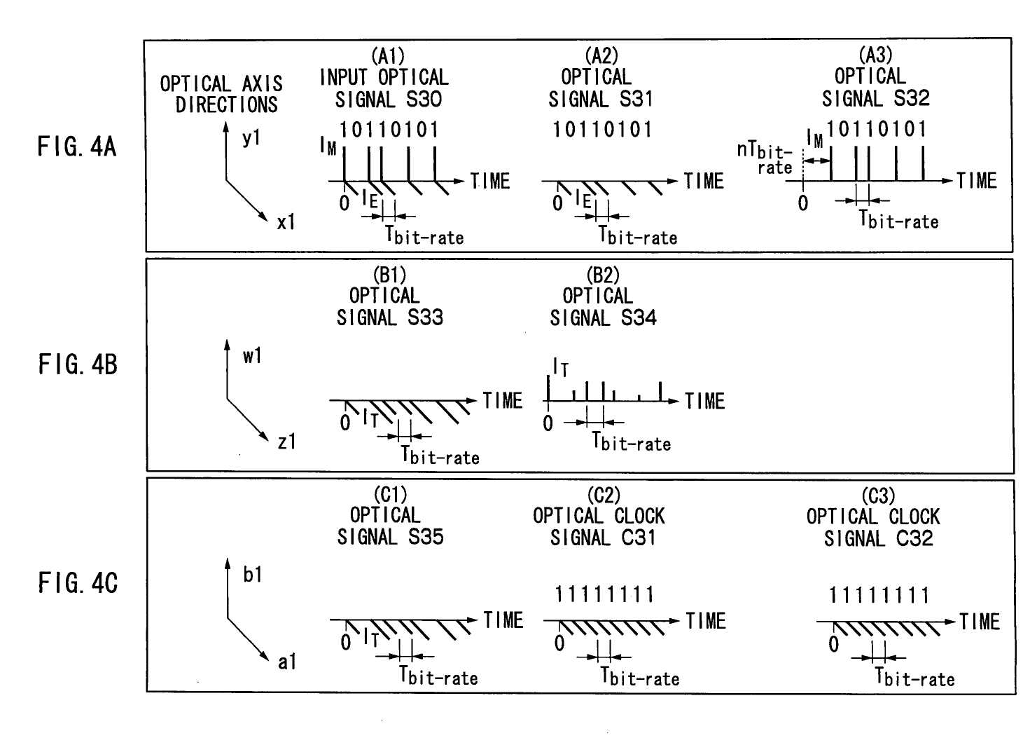

FIG. 4A to FIG. 4C schematically show states of changes in polarization (light polarization) states and signal waveforms of optical signals and optical clock signals.

In FIG. 4A to FIG. 4C, the input optical signal S30 is an 8-bit signal ‘10110101’. Here, ‘1’ means a state with a peak intensity being a significant intensity, and ‘0’ means a state which is substantially weaker than the peak intensity of the ‘1’ (and is desirably close to zero). In ordinary digital communications, binary digital signals with these strong and weak signal intensities are distinguished.

In (A1) of FIG. 4A, when the input optical signal S30 is in the ‘1’ state, the peak intensity of a component of the optical signal parallel to the optical axis x1 direction of the birefringent medium 30 is I_{E}, and the peak intensity of a component of the optical signal parallel to the optical axis y1 direction of the birefringent medium 30 is I_{M}. A total signal intensity for ‘1’ is given by I_{E}+I_{M}.

Here, a polarization extinction ratio of the input optical signal (below referred to as PER) is defined as a value in which I_{E} is divided by I_{M}, that is, I_{E}/I_{M}. Because the input optical signal S30 is an undefined polarization (light polarization) signal, arbitrary polarization extinction ratios can be obtained.

Furthermore, because phase relationships of optical carrier waves between the optical signal components that are respectively parallel to the orthogonal optical axis x1 and optical axis y1 (that is, the signal components I_{E} and I_{M}) are also undefined, a relative phase difference (φ) of the optical carrier waves between the optical signal components can take arbitrary values between 0 and 2π.

The polarization (light polarization) state of the input optical signal S30 can be defined by the above-mentioned polarization extinction ratio and relative phase difference φ between the optical carrier wave phases.

Clock regeneration operations being independent of the polarization (light polarization) state of the input optical signal means that, with arbitrary values of the polarization extinction ratio and the relative phase difference φ, large differences in time jitter of a regenerated optical clock signal do not occur, and values at or below certain defined values can always be realized.

An intensity time waveform I_{S30}(t) of the input optical signal S30 is defined by the following equation.

I_{S30}(t)=(I_{E}+I_{M})I(t) (4)

Therein, I(t) is a time waveform of an envelope of the optical signal, with a peak intensity being defined as 1.

Now, intensity time waveforms I_{S31}(t) and I_{S32}(t) of the optical signals S31 and S32 are as in equations (5) and (6), respectively.

S₃₁:I_{S31}(t)=I_{E}I(t), for \sqrt{I_{E}I(t)} an amplitude waveform (5)

S₃₂:I_{S32}(t)=I_{M}I(t−nT_{bit-rate}),

\sqrt{I_{M}I(t−nT_{bit-rate})}e^{j(φ+θ)} for an amplitude waveform (6)

An intensity time waveform I_{S35}(t) of the optical signal S35 that is inputted to the mode-locking semiconductor laser 100 can be represented as follows, in accordance with the discussion of step (A).

$${I}_{S 35} ( t ) = {\vert \sqrt{\frac{{I}_{E} I ( t )}{2}} + \sqrt{\frac{{I}_{M} I ( t - n {T}_{bit - rate} )}{2}} {e}^{j ( φ + θ )} \vert}^{2} \qquad ( 7 )$$

Herein, θ is the earlier-described relative phase difference between the optical carrier wave phases which occurs at the birefringent medium 30. As shown in equation (7), θ is included in the form of a sum in the same term with the initial relative phase φ of the original input optical signal S30. Therefore, in the following discussion, it will not be necessary to treat changes in θ separately from changes in φ. That is, a discussion concerning changes in the initial relative phase φ of the input signal S30 is actually a discussion of changes in φ+θ, which includes changes in θ. Therefore, for arbitrary values which can be taken by φ+θ (arbitrary values from 0 to 2π), provided stability of clock regeneration operations is assured, effects which are objectives for the first embodiment of the present invention will be achieved. Furthermore, assuring stability of clock regeneration operations for arbitrary values of θ means that, in the device structure, highly accurate length control of the birefringent medium 30, which includes control of the optical carrier wave phase, is not necessary. This means that assembly of a device capable of realizing the effects of the present invention can be implemented at low cost.

For the sake of simplicity in the above equations, excess light losses in the birefringent medium 30 and the polarization (light polarization)-dependent type optical isolator 31 are ignored.

If the waveform of the optical signal I_{S35}(t) is considered on the basis of equation (7), the following will be understood.

(i) In a case in which the relative delay time difference is zero (n=0), when I_{E}=I_{M} (the polarization extinction ratio=1) and φ+θ=π, a contribution from the optical signal S31 and a contribution from the optical signal S32 completely cancel out, and I_{S35}(t)=0.

(ii) In a case in which a relative delay difference is provided (n≠0), when there is a state in which the optical signal S31 is at ‘1’ and the optical signal S32 is at ‘0’, the optical signal S35, which is an interference waveform thereof, has a ‘1’ signal with a peak intensity (I_{T}) of I_{E}/2. On the other hand, when there is a state in which the optical signal S32 is at ‘1’ and the optical signal S31 is at ‘0’, there is a ‘1’ signal in the optical signal S35 of which the peak intensity (I_{T}) is I_{M}/2. Further, when there is a state in which the optical signal S31 and the optical signal S32 are both at ‘0’, there is a ‘0’ signal in the optical signal S35. On the other hand, when there is a state in which the optical signal S31 and the optical signal S32 are both at ‘1’, there is a ‘1’ signal in the optical signal S35, of which a peak intensity (I_{T}) will ordinarily be I_{E}/2+I_{M}/2+(I_{E}I_{M})² cos(φ+θ). However, in the state in which the optical signal S31 and the optical signal S32 are both at ‘1’, under conditions in which I_{E}=I_{M} (the polarization extinction ratio=1) and φ+θ=π, the optical signal S35 is a ‘0’ signal.

(iii) n must be a natural number. That is, n cannot be a rational number such as ½ or the like or an irrational number. When n is a natural number, even if the values of the polarization extinction ratio and/or φ+θ change, ‘1’ signals of the optical signal S35, referred from a single ‘1’ signal, are disposed regularly at time positions which are separated therefrom by integer multiples of T_{bit-rate}. By contrast, if n were not a natural number, time positions of ‘1’s of the optical signal S35 would be disposed irregularly at time positions differing from integer multiples of T_{bit-rate}, in accordance with values of the polarization extinction ratio and φ+θ. As a result, phase shifts would arise in the regenerated optical clock signal that would be generated, depending on values of the polarization extinction ratio and φ+θ.

From (i), when no relative delay time difference is obtained between the optical signals S31 and S32, under conditions of I_{E}=I_{M} and φ+θ=π, the optical signal S35 completely disappears. Under such conditions, no optical signal at all is inputted to the mode-locking semiconductor laser 100, and thus clock regeneration operations cannot occur. In order to avoid such conditions, it is necessary to obtain relative delay times corresponding to numbers of bits between the optical signals S31 and S32.

From (iii), it is necessary to avoid the occurrence of a phase shift, in the regenerated optical clock signal that is generated, for which the delay time difference is a natural number multiple of the signal time interval.

Furthermore, (ii) means the following. Firstly, as is understood from FIG. 4C, the signal pattern of the optical signal S35, which is to say a series of bits which are ‘1’s and bits which are ‘0’s, differs from the series of the original input clock signal S30. However, because an ultimate objective of the clock generation is the objective of obtaining output of a continuous pulse series (or sine wave), such a change from the signal pattern of the input optical signal will not be a problem in practice.

(ii) also means the following. Peak intensities of the ‘1’s of the optical signal S35 are not constant but are fundamentally provided with level changes. That is, even if the input optical signal S30 is a tidy signal in which peak intensities of ‘1’ signals are aligned and there are no intensity fluctuations, the optical signal S35 that is inputted to the mode-locking semiconductor laser 100 will be an optical signal with large “intensity fluctuations” in which peak intensities of ‘1’ signals are not aligned. As is seen from equation (7), these intensity fluctuations are dependent on the polarization extinction ratio and the relative phase difference φ. Furthermore, this means that even if an average intensity of the input signal S30 is constant, an average intensity of the optical signal S35 will change with dependency on the polarization extinction ratio and the phase difference φ (and θ) of the input optical signal S30.

Accordingly, because the above-described issues do not affect clock regeneration operations, the mode-locking semiconductor laser 100 of the first embodiment features the following characteristics.

(1) The optical clock regeneration operations feature an intensity noise absorption effect, which can absorb variations in peak intensity of the input optical signal.

(2) In the optical clock regeneration operations, a variation tolerance amount of average input intensity of the optical signal features a significant margin, which enables the realization of a significantly low time jitter in practice.

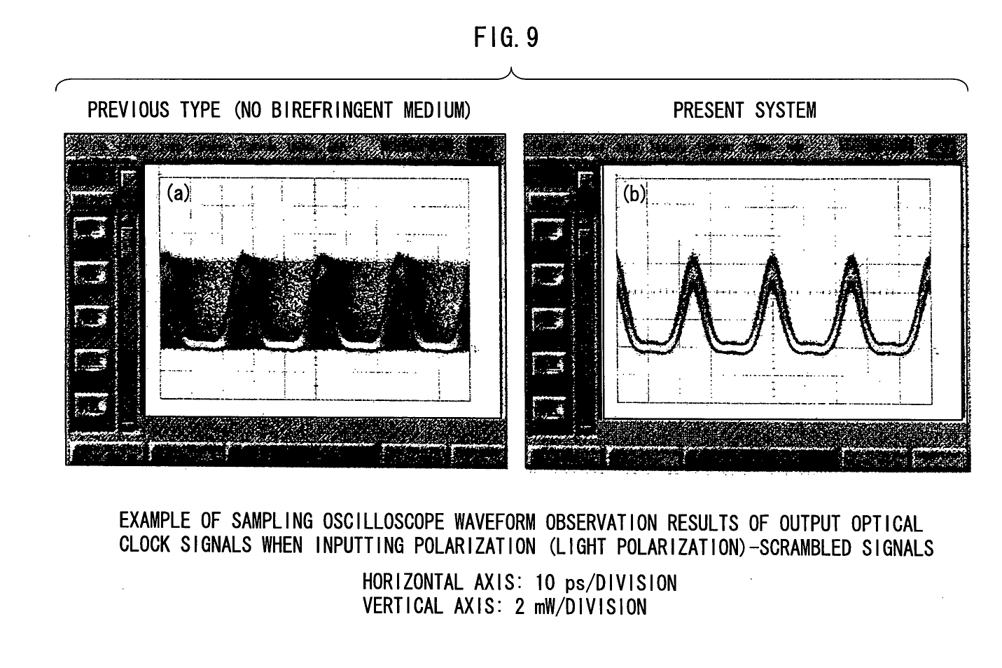

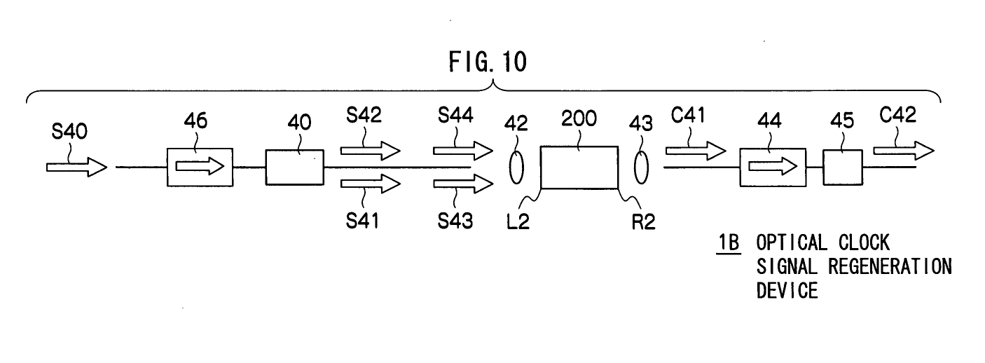

In regard to (1), we have already reported, in the previously mentioned reference 5, an intensity noise absorption effect in all-optical clock regeneration using a mode-locking semiconductor laser. According to the test results illustrated in FIG. 9 and FIG. 10 of reference 5, even with signal inputs with ±25% intensity noise, excellent optical clock signal regeneration is achieved, with small intensity fluctuations and time jitter.

As test results to be described in detail later will show, provided an intensity noise absorption effect is present to such an extent, this is sufficient in practice for realizing the first embodiment of the present invention. Therefore, peak intensity variations of ‘1’ signals of the optical signal S35 can be sufficiently absorbed in the first embodiment of the present invention, and consequently will not be a problem.

Now, in order to advance investigation of (2), it is estimated to what extent the average intensity of the optical signal S35 varies in accordance with the polarization extinction ratio and the phase (φ+θ) of the input optical signal S30.

Here, a pseudo-random signal, which are commonly used in evaluations of optical communication systems, is assumed as the signal pattern of the input optical signal S30. Such a signal pattern is illustrated in table 1. This signal is a “7-state bit pseudo-random signal”, and a number of bits is 2⁷−1=127 bits, of which 64 bits are ‘1’ signals and the other 63 bits are ‘0’ signals.

TABLE 1

| Bit numbers | Signal pattern |
|---|---|
| 1-16 | 1111111000000100 |
| 17-32 | 0001100001010001 |
| 33-48 | 1110010001011001 |
| 49-64 | 1101010011111010 |
| 65-80 | 0001110001001001 |
| 81-96 | 1011010110111101 |
| 97-112 | 1000110100101110 |
| 113-127 | 111001100101010 |

If signal energies of the individual ‘1’ signals are normalized to 1, a normalized average intensity of the input optical signal S30 is 1×64=64.

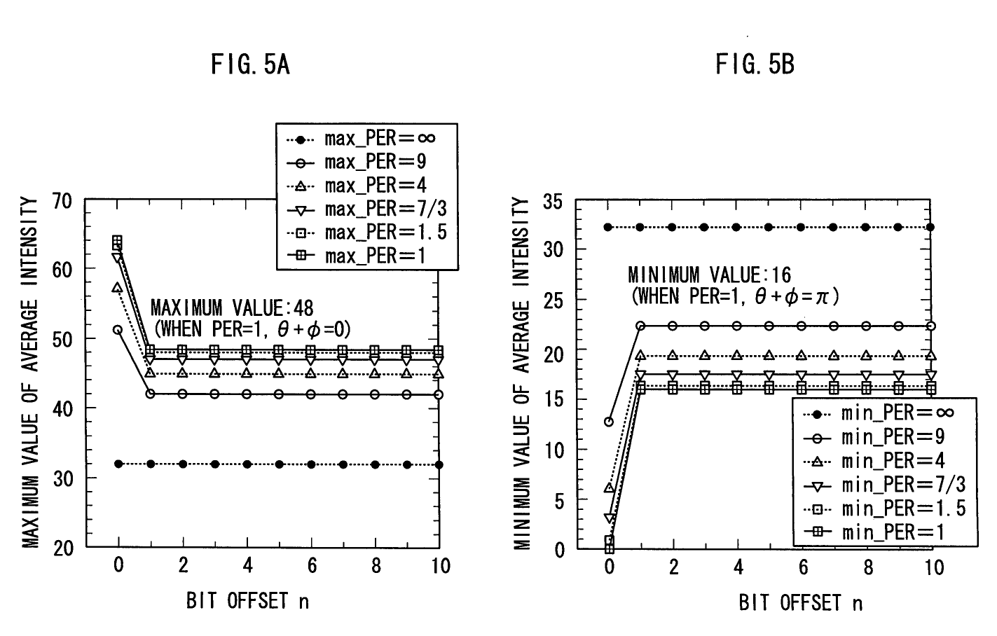

FIG. 5A and FIG. 5B are results of measurement of polarization extinction ratio (PER) dependencies of maximum values and minimum values of normalized average intensities of the optical signal S35 at such a time, with bit offsets of the optical signals S31 and S33 as horizontal axes. Here, the maximum values and minimum values of the normalized average intensities are respective maximum values and minimum values when the phase φ+θ is altered for a respective polarization extinction ratio.

When the bit offset n=0, the maximum value of the normalized average intensity is 64, and the minimum value is 0. The maximum value occurs when the polarization extinction ratio=1 and φ+θ=0, and the minimum value occurs when the polarization extinction ratio=1 and φ+θ=π. Such cases are, as has already been mentioned, results of the optical signals S31 and S32 with the same signal patterns and the same peak intensities interfering in phase and in anti-phase, respectively. However, because a case of obtaining a time delay corresponding to a number of bits between the optical signals S31 and S32 is being investigated here, this result can be excluded from consideration in the following discussion.

When the bit offset n≠0, the minimum value of the normalized average intensity is 16, while the maximum value is 48, which is a value three times the minimum value. The maximum value occurs when the polarization extinction ratio=1 and φ+θ=0, and the minimum value occurs when the polarization extinction ratio=1 and φ+θ=π. Dependencies on changes in the bit offset n are not apparent in the current results illustrated in FIG. 5A and FIG. 5B, which is a result reflecting characteristics of the pseudo-random signal pattern used for the evaluation.

From the above discussion, it is postulated that, for the optical clock signal regeneration device 1A relating to the first embodiment, the average intensity of the optical signal S35 inputted to the mode-locking semiconductor laser 100 varies in a range of ×3 (of the order of around 4.8 dB) in accordance with light polarization states of the input optical signal S30.

Therefore, the mode-locking semiconductor laser 100 of the first embodiment uses a structure in which clock regeneration operations have a margin in average input intensity of an optical signal of at least around 4.8 dB.

Furthermore, from the above discussion, because the mode-locking semiconductor laser 100 that is used has these clock regeneration operations with a margin for average input intensities of an optical signal of around 4.8 dB or more, even when the polarization (light polarization) state of the input optical signal S30 changes, a stable regenerated optical clock signal C31 with small time jitter is outputted from the mode-locking semiconductor laser 100 to which the optical signal S35 is inputted.

The regenerated optical clock signal C31 is outputted to the exterior through the focusing lens 33 from the end face R1 of the mode-locking semiconductor laser 100. The optical clock signal C31 is then transmitted through the optical isolator 34, in order to prevent operational instability due to back-reflected light, and is then outputted to the exterior as a regenerated optical clock signal C32. The optical isolator 34 here could just as well be either a polarization (light polarization)-dependent type optical isolator as mentioned earlier or a polarization (light polarization)-independent type optical isolator which transmits light of arbitrary polarization (light polarization) directions only in one direction. This is decided in accordance with whether or not operations of various optical devices that are used for subsequent signal processing of the regeneration optical signal C32 (for example, forming a regenerated optical signal by discrimination regeneration) feature polarization (light polarization) dependencies.

Similarly, in accordance with requirements, the wavelength filter 35 is included on the optical path along which the optical clock signal is outputted, only the optical clock signal wavelength component is outputted, and light of the input optical signal wavelength component is blocked.

### Example

Next, a demonstrative test performed in order to demonstrate the effects of the first embodiment will be described.

Here, an InP-based multi-electrode semiconductor laser with a saturable absorption region (length 250 μm), a gain region (610 μm) and a phase adjustment region (150 μm) arranged in this order is used as the passive mode-locking semiconductor laser 100. The resonator length is 1050 μm and the resonator cycling frequency is about 40 GHz. In a waveguide layer of the gain region, a multiple-quantum well structure is employed in which wells are formed by 0.6%-compressed InGaAsP layers and barrier layers are formed by unstrained InGaAsP layers, and the structure that is used is designed with composition ratios and thicknesses of the layers such that a photoluminescence peak wavelength thereof is 1562 nm. In waveguide layers of the saturable absorption region and the phase adjustment region, a multiple-quantum well structure is employed in which wells are formed by 0.6%-compressed InGaAsP layers and barrier layers are formed by unstrained InGaAsP layers, and the structures that are used are designed with composition ratios and thicknesses of the layers such that photoluminescence peak wavelengths thereof are 1480 nm. Resonator end faces at the two ends of the passive mode-locking semiconductor laser 100 utilize elements which are simply cleavage surfaces. When current is applied to the gain region of the passive mode-locking semiconductor laser 100, the laser oscillation threshold is about 30 mA and a slope efficiency is about 0.1 W/A, illustrating typical values for a semiconductor laser.

The length and composition of each region, thickness of each layer, photoluminescence peak wavelength and suchlike of the mode-locking semiconductor laser 100 illustrated here are simply a single structural example, and are not limitations.

When a direct current of 172.3 mA is applied to the gain region of the mode-locking semiconductor laser 100 and a reverse bias voltage of −0.98 V is applied to the saturable absorption region, passive mode-locking operations occur.

A pulse width of a mode-locking optical pulse series that is generated at this time is about 3.55 ps, a central wavelength is 1558.84 nm, and a full-width half-maximum spectrum width is 4.9 nm. A repetition frequency of the mode-locking optical pulse series generated at this time is 39.6648 GHz. An average light intensity output from the end face of the mode-locking semiconductor laser 100 at the phase adjustment region side thereof at this time is about 6.94 dBm.

The input optical signal is a pseudo-random optical signal in a “return-to-zero” (RZ) format, with a bit rate of 39.69012 Gbit/s, a central wavelength of 1545.30 nm and a pulse width of 4.53 ps, of which the light intensity temporarily falls to zero between successive ‘1’ signals. The number of pseudo-random state bits is 7 state bits (2⁷−1=127 bits).

As a birefringent medium, a commercially available PANDA fiber is used. A length of the PANDA fiber is about 22 m. A polarization (light polarization) group delay time difference ΔT is about 25.2 ps, which is a delay amount corresponding to a one-bit delay of the 39.69012 Gbit/s input optical signal.

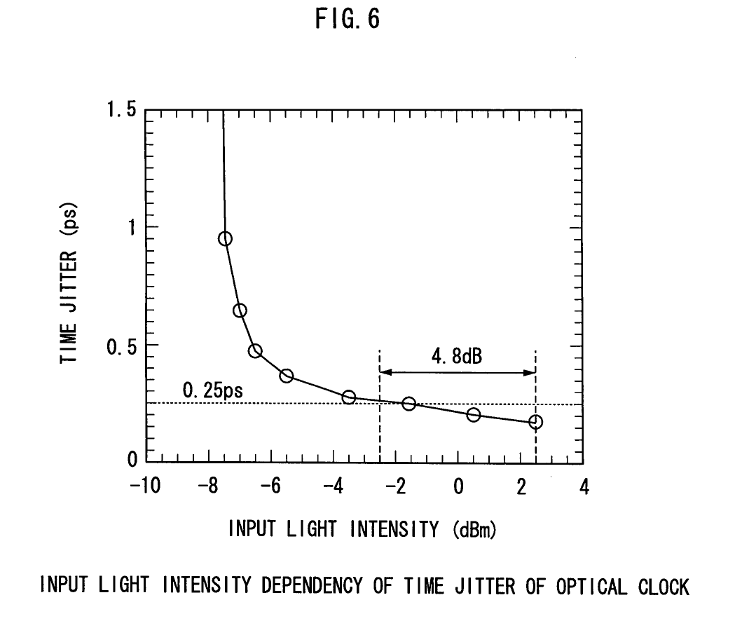

FIG. 6 shows test results of measurement of changes in time jitter of the regenerated optical clock signal generated by the mode-locking semiconductor laser 100 when the input optical signal intensity (average intensity) into the mode-locking semiconductor laser 100 changes.

This shows test results for an optical clock signal regeneration device of a previous type illustrated in reference 1, reference 4 and reference 5, at which the polarization (light polarization) state of an input optical signal is fixed in the TE polarization (light polarization). The optical signal is inputted through an end face of a mode-locking semiconductor laser device at a phase adjustment region side thereof.

From FIG. 6, it is seen that time jitter decreases as the input light intensity increases. In FIG. 6, it is seen that a lowered time jitter of not more than 0.25 ps is obtained with a range of input light intensity being from −2.7 dBm to +2.5 dBm. That is, this shows that obtaining an average input intensity margin in the optical signal of 5.2 dB realizes a time jitter of 0.25 ps or less. This value is a value which satisfies the earlier-described condition for providing the effects of the first embodiment (i.e., at least about 4.8 dB). This means that a margin of the average input intensity that is required in order to realize the first embodiment of the present invention can be realized with a practical mode-locking semiconductor laser element.

Next, test results of optical clock signal regeneration operations using the optical clock signal regeneration device 1A formed with the structure shown in FIG. 1 will be described with reference to the drawings.

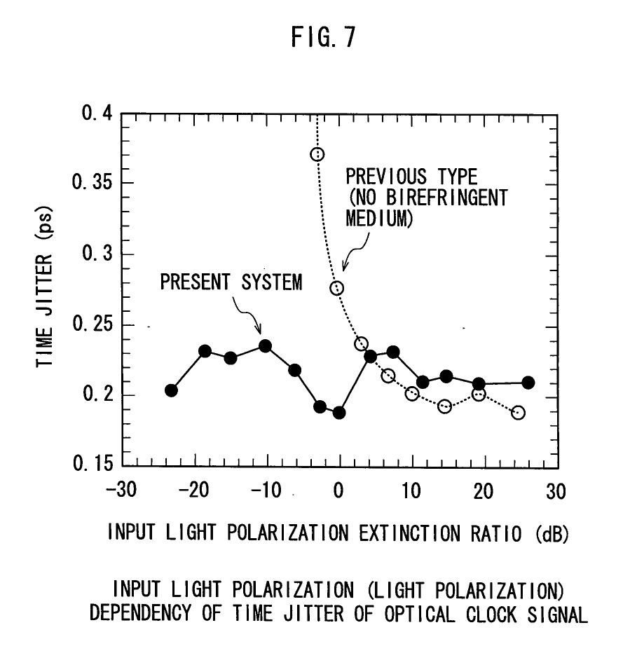

FIG. 7 is a diagram showing a relationship of changes in time jitter of a regenerated optical clock signal to changes in the polarization extinction ratio of the input optical signal.

In FIG. 7, the black circles are test results of a case of using the optical clock signal regeneration device 1A of the first embodiment, and the white circles are test results of a case of using an optical clock signal regeneration device that does not use a PANDA fiber as a birefringent medium. Note that the tests of FIG. 7 illustrate cases in which the input optical intensity is a fixed value at −0.6 dBm.

With the black circles of FIG. 7, it is seen that even if the polarization extinction ratio of the input optical signal changes greatly, from +26 dB to −24 dB, the time jitter changes in a very small range, within a range of 0.19 ps to 0.23 ps.

In contrast, with the white circles of FIG. 7, the time jitter starts to increase from when the polarization extinction ratio of the input optical signal becomes smaller than +10 dB. With a polarization extinction ratio of −5 dB or less, very soon frequency pulling does not occur in the mode-locking laser and clock signal regeneration operations become impossible.

As described above, it is demonstrated by the test results shown in FIG. 7 that, when the optical clock signal regeneration device 1A of the first embodiment is employed, it is possible to regenerate a stable all-optical clock signal with small time jitter regardless of polarization (light polarization) states of an input optical signal.

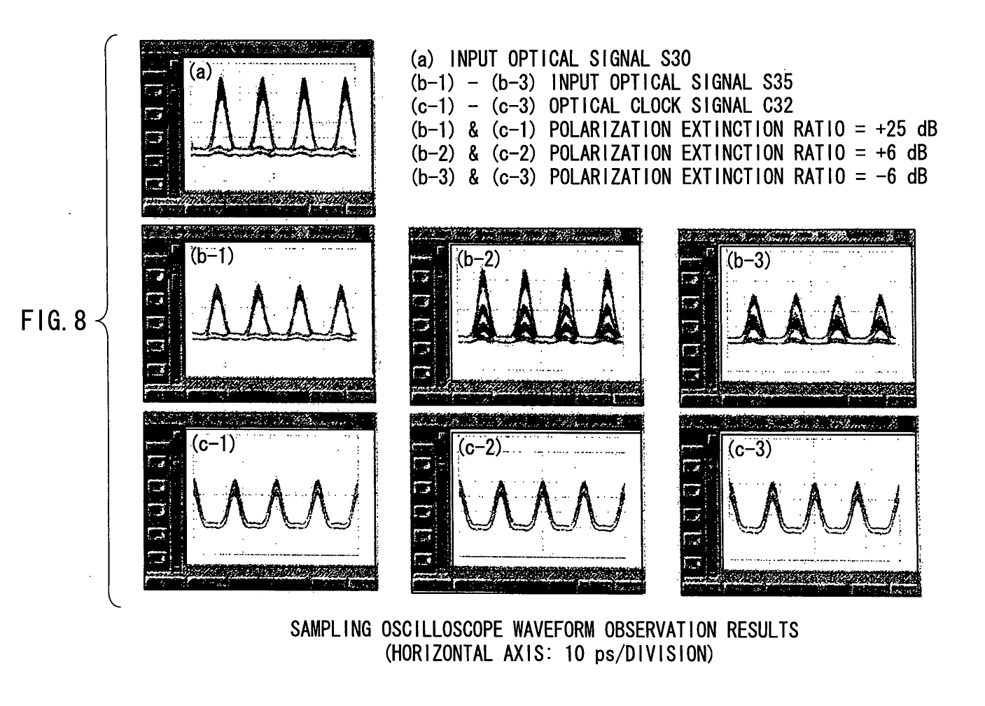

FIG. 8 is views showing sampling oscilloscope observation waveforms of respective signals in cases, using the optical clock signal regeneration device 1A, between which the polarization extinction ratio of the input optical signal is changed. (a) of FIG. 8 shows the input optical signal S30, (b) of FIG. 8 show the optical signal S35, and (c) of FIG. 8 show the regenerated optical clock signal C32.

When the polarization extinction ratio of the input optical signal is changed, variations in ‘1’ levels of the optical signal S35 change. In particular, the variations in the ‘1’ levels are large if the polarization extinction ratio is close to 1 (that is, if a TE component intensity and a TM component intensity are about the same).

This is seen from the ‘1’ levels of the sampling oscilloscope waveforms of the optical signal S35 varying greatly and the waveform markedly degrading when the polarization extinction ratio is +6 dB or −6 dB, according to the results shown in (b-2) and (b-3) of FIG. 8.

However, as in the results shown in (c-2) and (c-3) of FIG. 8, the sampling oscilloscope waveforms of the regenerated optical clock signal C32, even in situations in which variations of the ‘1’ levels of the optical signal S35 are large, are not inferior in comparison with a sampling oscilloscope waveform of the regenerated optical clock signal C32 when the polarization extinction ratio of the input optical signal S30 is high and thus variations in the ‘1’ levels of the optical signal S35 are small ((c-1) of FIG. 8). This is a test result demonstrating the effects of the first embodiment, illustrating that the intensity fluctuation absorption effect operates significantly at the mode-locking semiconductor laser 100.

FIG. 9 is views showing a comparison of sampling oscilloscope waveforms of regenerated optical clock signals in cases in which the polarization (light polarization) states of the input optical signal are a polarization (light polarization)-scrambled signal, which varies with a period of 1.2 seconds.

In (a) of FIG. 9, when clock signal regeneration operations are performed for a previous type at which a PANDA fiber (birefringent medium) is not included, a stable regenerated optical clock signal is not observed but the sampling oscilloscope waveform is a waveform which smears along the time axis. This is because clock signal regeneration operations are obtained in periods in which the polarization (light polarization) state of the polarization (light polarization)-scrambled signal happens to be close to the oscillation polarization (light polarization) state of the mode-locking semiconductor laser but clock signal regeneration operations are not obtained in periods in which the polarization (light polarization) state is greatly different from the oscillation polarization (light polarization) state of the mode-locking semiconductor laser.

In contrast, as shown in (b) of FIG. 9, when the aforementioned PANDA fiber is included and clock signal regeneration operations are performed in order to realize the effects of the first embodiment of the present invention, a stable regenerated optical clock signal waveform is observed, and the effects of the first embodiment can be verified.

From the test results described above, the effects of the first embodiment can be demonstrated.

### (A-3) Effects of the First Embodiment

As described above, according to the first embodiment, the following effects can be expected: All-optical clock signal regeneration operations from a high-bit rate optical data signal, which are not dependent on polarization (light polarization) of the optical data signal that is inputted, are enabled. Furthermore, the structure of the optical clock signal regeneration device 1A is a device structure formed simply by adding the birefringent medium to an all-optical clock signal regeneration device that uses a mode-locking laser of a previous type. Thus, an increase in complexity of device structure and an increase in costs can be thoroughly restrained, and provision of a low-cost device is enabled.

### (B) Second Embodiment

Next, a second embodiment in which an optical clock signal regeneration device of the present invention is employed will be described in detail with reference to the drawings.

### (B-1) Structure and Operation of the Second Embodiment

FIG. 10 is a block diagram describing structure of an optical clock signal regeneration device 1B of the second embodiment.

In FIG. 10, the optical clock signal regeneration device 1B of the second embodiment is structured to include at least a mode-locking semiconductor laser 200, a polarization (light polarization)-independent type optical isolator 46, a birefringent medium 40, focusing lenses 42 and 43, an optical isolator 44 and a wavelength filter 45.

The structure of the second embodiment shown in FIG. 10 differs from the structure of the first embodiment shown in FIG. 1 in the following respects.

Instead of employing the polarization (light polarization)-dependent type optical isolator 31, the polarization (light polarization)-independent type optical isolator 46 is employed. Moreover, the polarization (light polarization)-independent type optical isolator 46 is disposed at a forward side (a preceding stage) of the birefringent medium 40.

Furthermore, an active layer of the mode-locking semiconductor laser 200 is a layer which uses a material of which optical characteristics are very strongly polarization (light polarization)-dependent. As such an active layer of the mode-locking semiconductor laser 200, it is desirable to employ a multiple-quantum well structure into which unstrained portions or compression distortions are introduced.

Other structural elements are similar to the first embodiment shown in FIG. 1, so detailed descriptions thereof will not be given here.

In the first embodiment, the role of the polarization (light polarization)-dependent type optical isolator 31 is to suppress operational instability due to back-reflected light, and input into the mode-locking semiconductor laser 100 only the optical signal S35 of which the polarization (light polarization) direction matches the oscillation polarization (light polarization) direction of the mode-locking semiconductor laser 100.

This is because, if an optical signal of which the polarization (light polarization) direction is orthogonal to the oscillation polarization (light polarization) direction of the mode-locking semiconductor laser 100 is inputted into the mode-locking semiconductor laser 100, an optical gain, optical absorption and refractive index within the mode-locking semiconductor laser 100 may change as a result.

As can be surmised from the discussions described for the first embodiment, similarly to changes in the average intensity of the component of the optical signal S35 with the polarization (light polarization) direction matching the oscillation polarization (light polarization) direction of the mode-locking semiconductor laser 100 in accordance with the polarization extinction ratio and relative phase difference φ+θ of the input optical signal S30, average intensity of the optical signal component S34 with a polarization (light polarization) direction orthogonal to the oscillation polarization (light polarization) direction of the mode-locking semiconductor laser changes in accordance with the polarization extinction ratio and relative phase difference φ+θ of the input optical signal S30. This means that if the optical signal S34 were to be inputted, the optical gain, optical absorption and refractive index within the mode-locking semiconductor laser would change in accordance with the polarization (light polarization) state of the input optical signal S30. Such changes in optical parameters of the mode-locking semiconductor laser would cause changes in the mode-locking characteristics of the mode-locking optical laser, which would lead to changes in optical pulse characteristics of the regenerated optical clock signal that was generated, and thus would be a cause of operational instability of the optical clock signal regeneration operations.

However, if the optical characteristics of a mode-locking semiconductor laser have great polarization (light polarization) dependency, even if an optical signal with a polarization (light polarization) direction orthogonal to the oscillation polarization (light polarization) direction of the mode-locking semiconductor laser is inputted thereto, then hardly any effect is applied to the optical characteristics thereof. In such a case, even when an optical signal corresponding to the optical signal S34 of the first embodiment is inputted to the mode-locking semiconductor laser, this will not lead to a change in optical pulse characteristics of a regenerated optical clock signal, which is to say, stable operation of the optical clock signal regeneration operations will be assured.

An example of an excellent structure to serve as an active layer structure of such a mode-locking semiconductor laser is a multiple-quantum well structure into which unstrained portions or compression distortions are introduced. In a quantum well structure, optical characteristics thereof are subject to very strong polarization (light polarization) dependency. In particular, in a multiple-quantum well structure into which unstrained portions or compression distortions are introduced, with light with a polarization (light polarization) direction parallel to a thickness direction of the quantum well layers (i.e., the TM polarization (light polarization)), there is hardly any optical gain and a change in refractive index due to optical excitation is small. On the other hand, with light with a polarization (light polarization) direction parallel to an in-plane direction of the quantum wells (i.e., the TE polarization (light polarization)), which is orthogonal to the TM polarization (light polarization) direction, large changes in optical gain and refractive index occur. For this reason, laser oscillation also occurs in the TE polarization (light polarization).

The second embodiment utilizes the mode-locking semiconductor laser 200 which includes, at the active layer, a multiple-quantum well structure into which unstrained portions or compression distortions are introduced in such a manner. Therefore, when an optical signal S44 corresponding to the optical signal S34 of the first embodiment is inputted, stable operation of optical clock signal regeneration operations can be guaranteed.

Furthermore, by using the mode-locking semiconductor laser 200 as in the second embodiment, even when the optical signal S44 with the polarization (light polarization) direction orthogonal to the oscillation polarization (light polarization) of the mode-locking semiconductor laser 200 (i.e., the optical signal corresponding to the optical signal S34) is inputted, as long as a stable optical clock signal can be regenerated, an optical isolator that would be used at the optical signal input side is not required for blocking such a polarization (light polarization)-orthogonal optical signal, and need be capable only of suppressing operational instability due to back-reflected light.

Accordingly, with the second embodiment, an optical light input side optical isolator that is employed features at least the function of blocking back-reflected light. That is, in the second embodiment, the polarization (light polarization)-independent type optical isolator 46 is employed, which does not block a particular polarization (light polarization) component of the input optical light S40.

Therefore, there is no need for the polarization (light polarization)-independent type optical isolator 46 to be included partway along a light path joining the birefringent medium with the mode-locking semiconductor laser, and the polarization (light polarization)-independent type optical isolator 46 can be disposed forward (at a preceding stage) of the birefringent medium 40.

Disposing the polarization (light polarization)-independent type optical isolator 46 forward of the birefringent medium 40 enables a simplification of optical axis adjustment of the optical components 46, 40, 42 and 200. Thus, processes and costs relating to assembly can be reduced compared to the structure of the first embodiment.

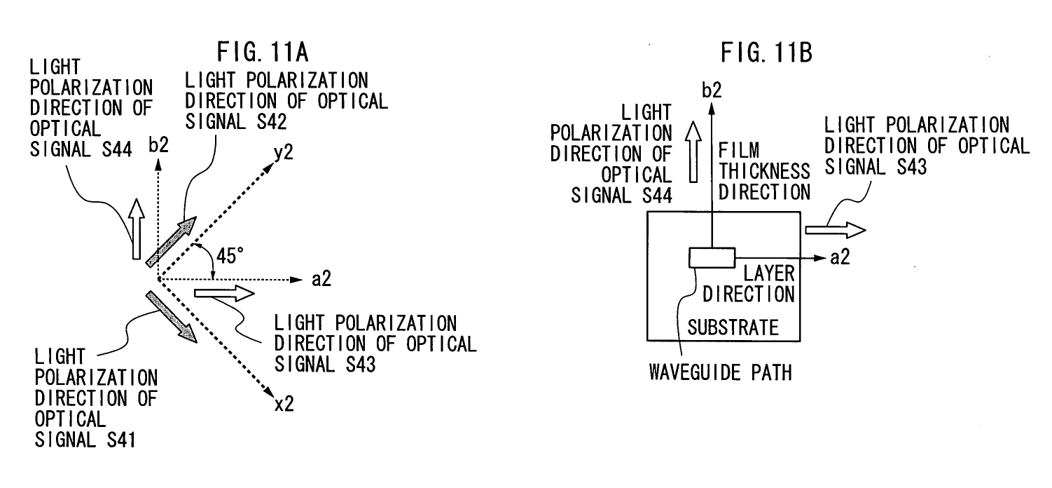

That is, as shown in FIG. 11A and FIG. 11B, the only location that particularly requires optical axis adjustment at the optical components 46, 40, 42 and 200 of the optical clock signal regeneration device 1B is a location for adjustment such that each of the optical axis directions of the birefringent medium 40 (axes x2 and y2) forms angles of 45° with an axis direction parallel to the oscillation polarization (light polarization) of the mode-locking semiconductor laser 200 (axis a2) and a perpendicular polarization (light polarization) direction (axis b2).

In contrast, in the case of the first embodiment, optical axis adjustment is required at two locations: a location for adjustment such that the optical axis directions of the birefringent medium 30 (axes x1 and y1) form angles of 45° with the transmission polarization (light polarization) light direction of the polarization (light polarization)-dependent type optical isolator 31 (axis z1); and a location for adjustment such that the polarization (light polarization) direction of the optical signal (S35) that passes through the polarization (light polarization)-dependent type optical isolator 31 matches the oscillation polarization (light polarization) direction of the mode-locking semiconductor laser 100 (axis a1).

Thus, in comparison with the first embodiment, the second embodiment reduces the number of locations requiring adjustment of optical axis directions during optical adjustment. That is, processes and costs relating to assembly can be reduced, and as a result, better yields and cheaper device provision are enabled.

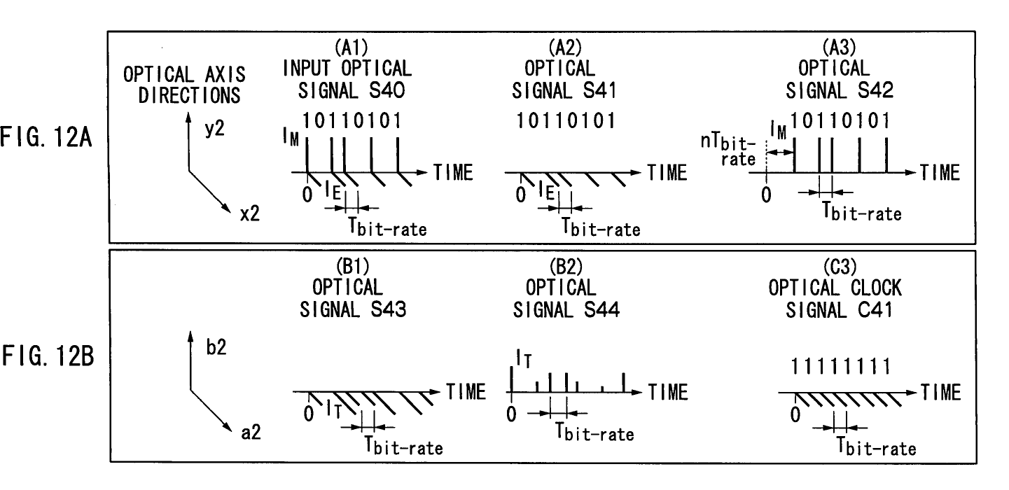

FIG. 12A and FIG. 12B are diagrams schematically showing polarization (light polarization) states of the input optical signal S40, the optical signals S41 to S44 and the optical clock signal C41 of the second embodiment, and states of signal waveforms thereof.

Here, the optical signals S40, S41, S42, S43 and S44 and the optical clock signal C41 are signals corresponding, respectively, to the optical signals S30, S31, S32, S33 and S34 and the optical clock signal C31 of the first embodiment, shown in FIG. 4A to FIG. 4C. The optical signals S43 and S44 are signals provided by the step (A) described for the first embodiment.

When the optical signal S43 and the optical signal S44 are inputted to the mode-locking semiconductor laser 200, the mode-locking semiconductor laser 200 responds only to the optical signal S43, because of the very strong polarization (light polarization) dependency of the optical characteristics thereof.

Hence, because of the effects described for step (B) of the first embodiment, a stable optical clock signal C41 is generated by the mode-locking semiconductor laser 200.

Thereafter, the optical clock signal C41 passes through the optical isolator 44 for preventing back-reflected light and the wavelength filter 45, which is provided in accordance with requirements, and finally a desired optical clock signal C42 is created.

### (B-2) Effects of the Second Embodiment

As described above, according to the second embodiment, in addition to the effects described for the first embodiment, effects as illustrated following can be provided. According to the second embodiment, locations at which adjustment of optical axis directions is required can be reduced in number, and thus processes and costs relating to assembly can be further reduced, as a result of which provision of inexpensive devices with better yields is enabled.

### (C) Third Embodiment

Next, a third embodiment in which an optical clock signal regeneration device of the present invention is employed will be described in detail with reference to the drawings.

### (C-1) Structure of the Third Embodiment

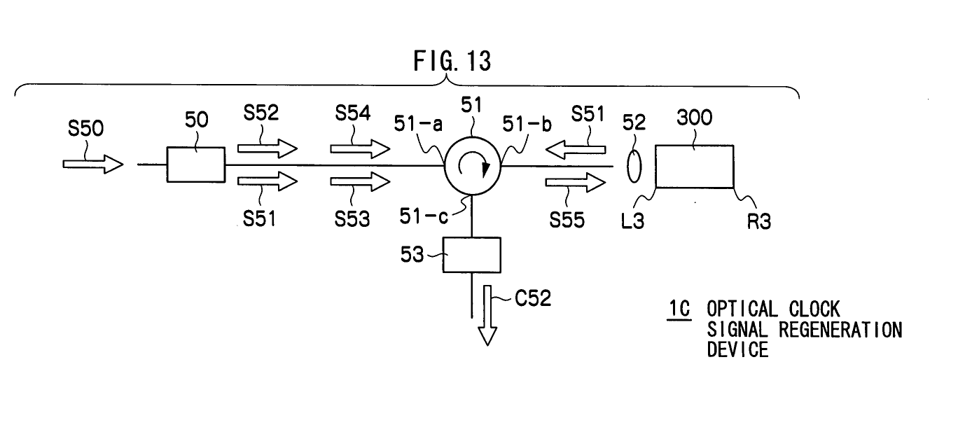

FIG. 13 is a block diagram describing structure of an optical clock signal regeneration device 1C relating to the third embodiment.

In FIG. 13, the optical clock signal regeneration device 1C is structured to include at least a mode-locking semiconductor laser 300, a birefringent medium 50, a polarization (light polarization)-dependent type optical circulator 51, a focusing lens 52 and a wavelength filter 53.

The third embodiment, differently from the first and second embodiments, is implemented with input of an optical signal and output of an optical clock signal by the mode-locking semiconductor laser 300 being caused to pass through the same resonator end face.

The birefringent medium 50 is a birefringent medium of which a polarization (light polarization) delay time is nT_{bit-rate}, and can employ the birefringent medium 30 of the first embodiment.

The wavelength filter 53 is an optical filter that transmits an optical clock signal wavelength component, and can employ the wavelength filter 35 of the first embodiment.

The polarization (light polarization)-dependent type optical circulator 51 is a polarization (light polarization)-dependent type three-port optical circulator. That is, when light is inputted through a port 51-a, of the input light from the port 51-a, the polarization (light polarization)-dependent type optical circulator 51 outputs only light of a certain polarization (light polarization) direction through a port 51-b, and blocks a component orthogonal to the light of the certain polarization (light polarization) direction.

When light is inputted through the port 51-b, the polarization (light polarization)-dependent type optical circulator 51 outputs, from a port 51-c, only light of a polarization (light polarization) direction that matches the polarization (light polarization) direction of light that is outputted from the port 51-b when light is inputted through the port 51-a, and blocks a component orthogonal to the same. The polarization (light polarization)-dependent type optical circulator 51 can employ, for example, a circulator fabricated employing the previously mentioned polarization (light polarization)-dependent type optical isolator, a previously known circulator, or the like.

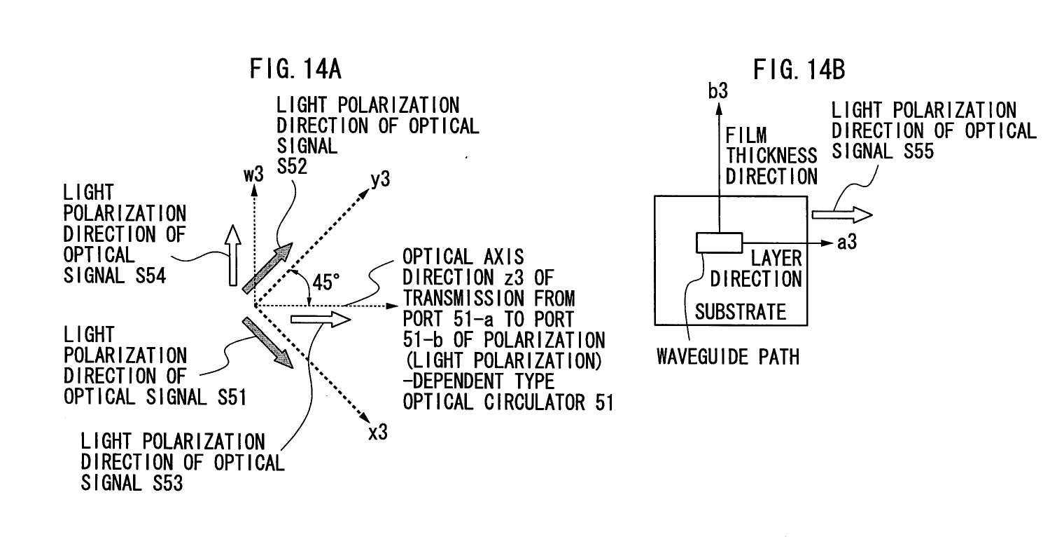

Now, relationships between a light polarization direction of light passing through the polarization (light polarization)-dependent type optical circulator 51, optical axis directions of the birefringent medium 50 and an oscillation polarization (light polarization) direction of the mode-locking semiconductor laser 300 will be described with reference to FIG. 14A and FIG. 14B.

In FIG. 14A, a polarization (light polarization) direction of output light which is inputted through the port 51-a of the polarization (light polarization)-dependent type optical circulator 51 and is outputted through the port 51-b is defined as the direction of an axis z3.

As shown in FIG. 14A and FIG. 14B, the light polarization direction of light that is inputted through the port 51-a of the polarization (light polarization)-dependent type optical circulator 51 and is outputted passing through the port 51-b (i.e., light with a light polarization direction parallel to an optical signal S55 of FIG. 13) is matched with an oscillation polarization (light polarization) direction of the mode-locking semiconductor laser 300 (i.e., the TE polarization (light polarization) direction, which is the direction of an axis a3). Furthermore, the polarization (light polarization) direction of the light that is allowed to pass through the port 51-b from the port 51-a of the polarization (light polarization)-dependent type optical circulator 51 and be outputted (the direction of axis z3 mentioned above) is set so as to form angles of 45° with each of the orthogonal optical axis directions of the birefringent medium 50 (an axis x3 and an axis y3).

### (C-2) Operation of the Third Embodiment

Next, optical clock signal regeneration operations in the optical clock signal regeneration device 1C of the third embodiment will be described.

Herebelow, overall operations for optical clock signal regeneration of the third embodiment will be described.

Firstly, an input optical signal S50 passes through the birefringent medium 50, and is then inputted to the port 51-a of the polarization (light polarization)-dependent type optical circulator 51 and is outputted passing through the port 51-b.

The optical signal S55 that is outputted from the port 51-b of the polarization (light polarization)-dependent type optical circulator 51 is inputted, via the focusing lens 52, into one resonator end face L3 of the mode-locking semiconductor laser 300.

Then, an optical clock signal C51 that is formed by the mode-locking semiconductor laser 300 is outputted from the resonator end face L3 of the mode-locking semiconductor laser 300, the same resonator end face as that at which the optical signal S55 is inputted.

The optical clock signal C51 from the mode-locking semiconductor laser 300 is inputted at the port 51-b of the polarization (light polarization)-dependent type optical circulator 51 and is outputted passing through the port 51-c.

Then, similarly to the first and second embodiments, the optical clock signal from the polarization (light polarization)-dependent type optical circulator 51 passes through the wavelength filter 53, which is provided in accordance with requirements, and finally a desired regenerated optical clock signal C52 is provided.

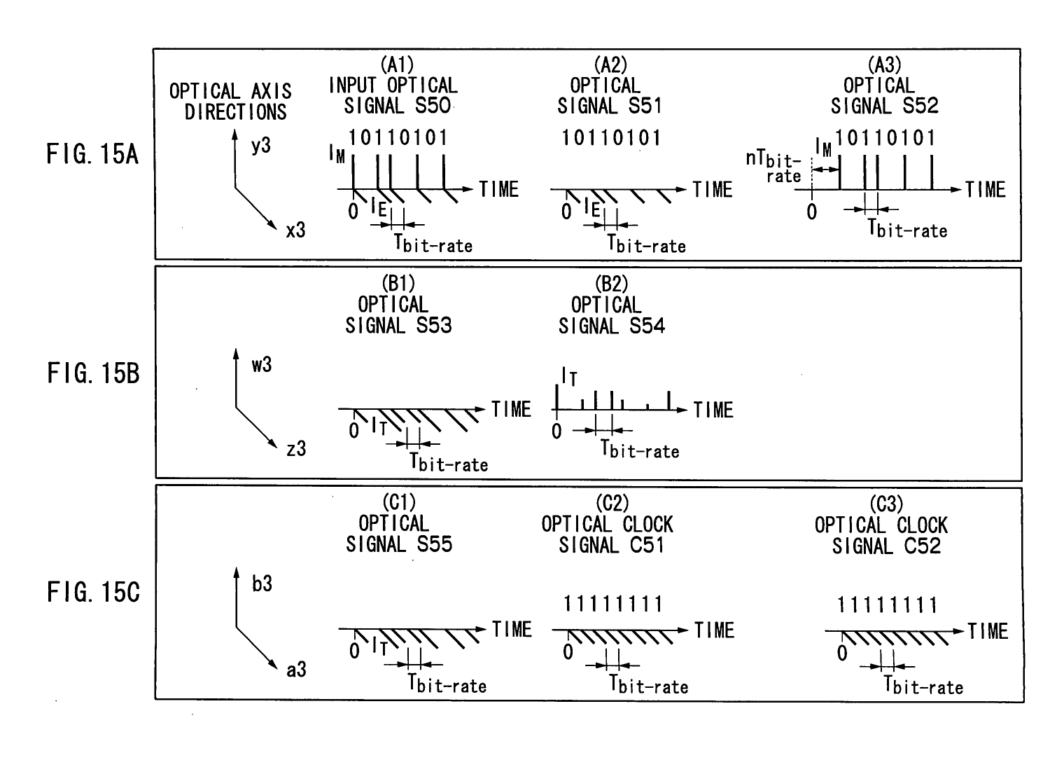

FIG. 15A to FIG. 15C are diagrams schematically showing polarization (light polarization) states of the input optical signal S50, signals S51 to S54, which are intermediately generated optical signals, the optical signal S55 that is inputted to the mode-locking semiconductor laser 300, and the optical clock signals C51 and C52, and states of signal waveforms thereof.

Here, the optical signals S51 to S54 are similar in nature to the optical signals S31 to S34 of the first embodiment. Moreover, the function of light inputted to the port 51-a of the polarization (light polarization)-dependent type optical circulator 51 being outputted from the port 51-b is similar to the function effected by the polarization (light polarization)-dependent type optical isolator 31 of the first embodiment. Therefore, the optical signal S55 is identical in nature to the optical signal S35 of the first embodiment. Therefore, the mode-locking semiconductor laser 300 which receives the optical signal S55 generates a stable optical clock signal C51 in accordance with the effects of steps (A) and (B) described for the first embodiment.

The polarization (light polarization) direction of the optical clock signal C51 is the oscillation polarization (light polarization) direction of the mode-locking semiconductor laser 300, and the polarization (light polarization) direction of the optical signal S55 is set so as to match the oscillation polarization (light polarization) direction of the mode-locking semiconductor laser 300. Therefore, when the optical clock signal C51 is inputted through the port 51-b of the polarization (light polarization)-dependent type optical circulator 51, the optical clock signal C51 will not be blocked but outputted through the port 51-c.

Because the polarization (light polarization)-dependent type optical circulator 51 simultaneously effects the role of an optical isolator, there is no need to separately prepare an optical isolator for blocking back-reflected light, on a path by which the optical clock signal C51 is outputted to the exterior, in the same manner as in the first and second embodiments.

An effect of the third embodiment arises because input and output of an optical signal and a regenerated optical clock signal are implemented through the same resonator end face L3 of the mode-locking semiconductor laser 300, and thus there is no need to consider input and output of light to and from the exterior through the other resonator end face R3 of the mode-locking semiconductor laser 300. That is, the effect is caused by formation of a high-reflection film coating at the resonator end face R3 being enabled.

This may be very important for, in particular, an increase in speed of a repetition frequency of a passive mode-locking semiconductor laser, which is to say, an increase in speed of a clock frequency of a regeneration optical clock signal in all-optical clock regeneration operations, which is an object of the present invention. This occurs due to the circumstances described following.

Firstly, the repetition frequency of a passive mode-locking semiconductor laser is inversely proportional to resonator length. That is, for such an increase in speed, it is necessary to shorten the resonator length of the passive mode-locking semiconductor laser. However, the lasing threshold of the laser increases when the resonator length is shortened. Therefore, in a passive mode-locking semiconductor laser of which the resonator is shortened in order to increase the speed of the repetition frequency, there is first a necessity to lower resonator losses in order to allow laser oscillation to occur. Resonator losses of a laser are a sum of propagation losses in the resonator and reflection losses at the resonator end faces. That is, the higher the reflectances of the resonator end faces, the lower the resonator losses.

Secondly, in order to increase the repetition frequency of a passive mode-locking semiconductor laser, it is of course necessary to correspondingly narrow the width of the light pulses that are generated. Reference 6 is a theoretical investigation into pulse characteristics of passive mode-locking lasers, and a reciprocal relationship between the Q value of a resonator and pulse width is illustrated in FIG. 3A and FIG. 3B of reference 6. As is shown therein, the pulse width is narrower when the Q value of the resonator is higher. The Q value of a resonator is a value proportional to a reciprocal of resonator losses, which illustrates that a reduction in resonator losses is an important parameter for an increase in speed of a repetition frequency of a passive mode-locking semiconductor laser.

Furthermore, if one end face of a saturable absorption region serves as a resonator end face, and that resonator end face is coated with a high-reflection film, colliding-pulse mode-locking operations will arise, and an absorption saturation energy of the saturable absorption region may be effectively reduced, which is illustrated by FIG. 14, etc. of reference 7. This means that an improvement in stability of mode-locking operations is desirable.

Considering these various circumstances, if an all-optical clock regeneration device can be realized using a passive mode-locking semiconductor laser in which a high-reflection film has been formed at one resonator end face, then desirable effects in practice can be anticipated, such as an increase in operation speed, which is to say an increase in speed of the clock frequency of the optical clock signal that is regenerated, a shortening of pulses of the regenerated optical clock signal, an improvement in stability, and the like.

In the third embodiment, because input and output of the optical signal and the regenerated optical clock signal are implemented through the same resonator end face L3 of the mode-locking semiconductor laser 300, a saturable absorber can be disposed at the resonator end face R3 side thereof, and a high-reflection film coating can be formed. As a result, it is possible to provide an optical clock signal regeneration device which creates a regenerated optical clock signal with more excellent high-speed operation characteristics and pulse quality than in the cases of the first and second embodiments.

In the descriptions hitherto, device structure and effects have been described for a case of combination with the first embodiment. However, the third embodiment will provide the same effects even with a device structure that is combined with the second embodiment. In such a case, as described for the second embodiment, a structure is possible which uses the mode-locking semiconductor laser 200 with the active layer of which the optical characteristics show very strong polarization (light polarization)-dependency, and which uses a polarization (light polarization)-independent type optical circulator instead of the polarization (light polarization)-dependent type optical circulator 51, with the polarization (light polarization)-independent type optical circulator being disposed forward of the birefringent medium 50.

### (C-3) Effects of the Third Embodiment

As described above, according to the third embodiment, in addition to the effects provided by the first and second embodiments, the following effects can be provided: By using a mode-locking semiconductor laser at which a high-reflection film coating is formed at one resonator end face, it is possible to provide an optical clock signal regeneration device which is more excellent in high frequency operation characteristics and pulse quality.

### (D) Fourth Embodiment

Next, a fourth embodiment in which an optical clock signal regeneration device of the fourth embodiment is employed will be described in detail with reference to the drawings.

A refraction index distribution of an optical fiber, which structures a fiber propagation network that propagates optical signals, in practice includes a distribution form which is different from an ideal full circle-shaped refraction index distribution, because of limitations on fabrication accuracy. Therefore, fibers that are supplied in practice include birefringence to a statistically significant degree. This is a principal cause of instability of polarization (light polarization) states of optical signals which have been propagated by a fiber propagation network.

Furthermore, as a propagation distance becomes longer and a total phase shift due to the statistical birefringence of an optical fiber becomes larger, the statistical birefringence effect of this optical fiber is manifested in the form of a time delay between orthogonal polarization (light polarization) components of an optical signal. This is referred to as polarization mode dispersion (below referred to as PMD). In an optical communication system to which polarization (light polarization)-preserving characteristics, such as in polarization (light polarization)-preserving fibers, are not applied, the PMD of optical fibers that are commonly used is known to increase in proportion to the square root of the propagation distance, and is known to have values of the order of 0.1 ps/√km to 1 ps/√km as typical values thereof. Note that such values change with environmental factors such as temperature and the like.

Therefore, due to such a polarization mode dispersion effect, there is a time delay between orthogonal polarization (light polarization) components of an input optical signal S60. Furthermore, if this varies, it is necessary to add a correction mechanism. That is, if an optical clock signal regeneration device is employed without providing such a correction mechanism, phase fluctuations will occur in the optical clock signals that are generated and it may consequently be impossible to provide a stable optical clock signal.

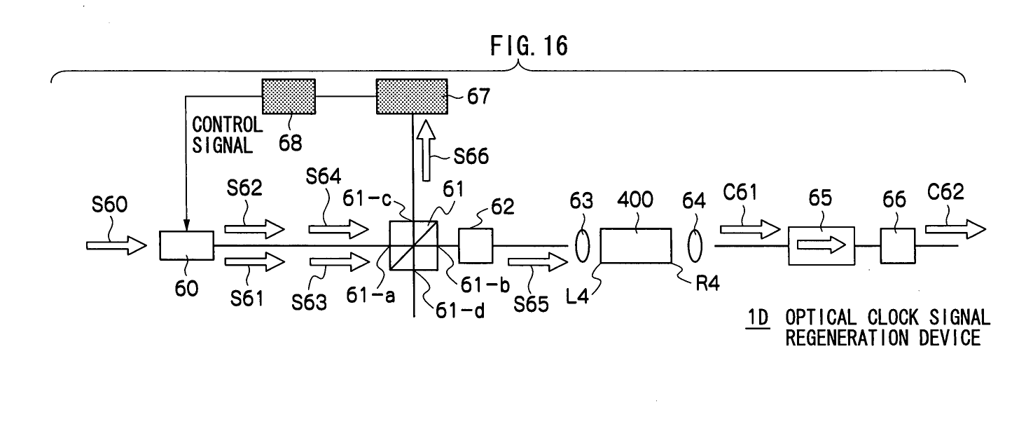

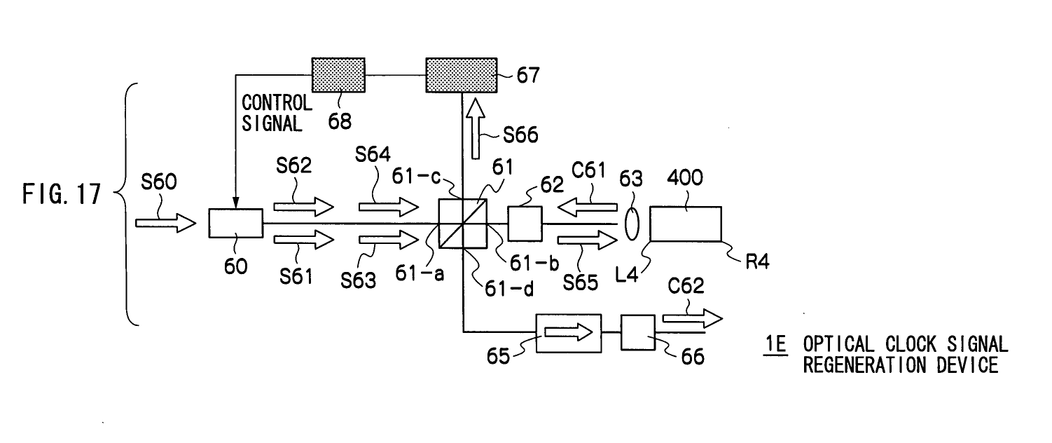

Accordingly, in the fourth embodiment, by employing a structure as in FIG. 16, FIG. 17 or the like, in addition to the effects of the first and third embodiments, even when there is a time delay between orthogonal polarization (light polarization) components of an input optical signal as described above, it is possible, by detecting the time delay between the orthogonal polarization (light polarization) components and correcting the time delay, to provide a stable optical clock signal that does not have phase fluctuations.

In the fourth embodiment, an optical signal S64, which corresponds to the optical signals S34 and S54 which are blocked in the first and third embodiments, is not blocked. This optical signal S64 is characterized in being used as a signal for monitoring a PMD amount that has been applied to the input optical signal.

### (D-1) Structure of the Fourth Embodiment

FIG. 16 is a block diagram describing structure of an optical clock signal regeneration device 1D of the fourth embodiment.

In FIG. 16, the optical clock signal regeneration device 1D is structured to include at least a mode-locking semiconductor laser 400, a variable birefringence medium 60, a light polarization separation circuit 61, a Faraday rotator 62, focusing lenses 63 and 64, an optical isolator 65, a wavelength filter 66, a waveform monitor 67 and a control signal generation device 68.

The fourth embodiment includes structure which adds a control function that, when there is a time delay between orthogonal polarization (light polarization) components of an input optical signal due to the effects of polarization mode dispersion in a fiber propagation network, detects the time delay between the polarization (light polarization) components and corrects the time delay.

The structure shown in FIG. 16 is an example of structure of the optical clock signal regeneration device 1D of the fourth embodiment, and is a structure with a form based on the structure of the first embodiment. Naturally, it is also possible to add the particular functional structure of the fourth embodiment, which will be described below, to forms based on the structures of the second and third embodiments.

The fourth embodiment employs the variable birefringence medium 60. The variable birefringence medium 60 is a medium capable of changing the polarization (light polarization) group delay time ΔT in accordance with a control signal from thereoutside. In the fourth embodiment, the variable birefringence medium 60 is capable of changing the polarization (light polarization) delay time ΔT on the basis of a control signal from the control signal generation device 68.

The fourth embodiment also employs the light polarization separation circuit 61 instead of the polarization (light polarization)-dependent type optical isolator 31 that is used in the first embodiment. The light polarization separation circuit 61 is a circuit including three or more input/output ports such as, for example, a polarization (light polarization) prism or the like. FIG. 16 shows an example with four input/output ports.

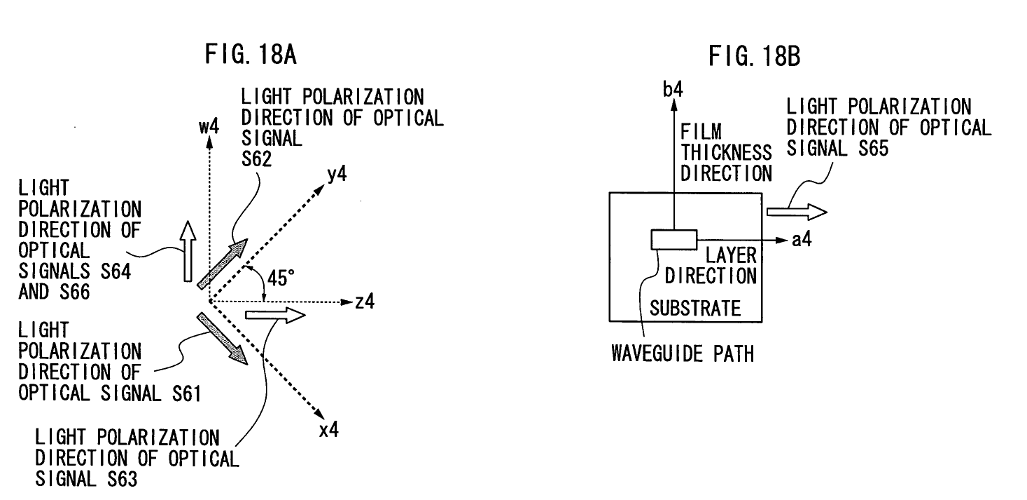

When light is inputted through a port 61-a, the light polarization separation circuit 61 outputs, of the input light, light with a certain polarization (light polarization) direction through a port 61-b. At this time, as shown in FIG. 18A and FIG. 18B, a light polarization direction of the light inputted to the port 61-a of the light polarization separation circuit 61 is defined as the direction of an axis z4.

Further, when the light is inputted through the port 61-a, the light polarization separation circuit 61 outputs light of a light polarization direction orthogonal to the direction of axis z4 through a port 61-c. At this time, as shown in FIG. 18A and FIG. 18B, the light polarization direction of the light inputted to the port 61-a of the light polarization separation circuit 61 is defined as the direction of an axis w4.

Further, when light is inputted through the port 61-b of the light polarization separation circuit 61 that is in a light polarization state parallel with light that is outputted from the port 61-b if light that is light-polarized in the direction of axis z4 is inputted when light is inputted through the port 61-a, the light polarization separation circuit 61 outputs that light through the port 61-a. Moreover, when light with a light polarization state orthogonal to the axis z4 is inputted through the port 61-b, the light polarization separation circuit 61 outputs that light through a port 61-d. The port 61-d is not necessary in the exemplary structure shown in FIG. 16, and is not required for joining with an optical fiber or the like.

The Faraday rotator 62 is a Faraday rotator which turns a light polarization direction of linearly polarized light through 45°. The focusing lenses 63 and 64 are focusing lenses for inputting an optical signal to the mode-locking semiconductor laser 400 and outputting an optical clock signal from the mode-locking semiconductor laser 400.

The roles of the optical isolator 65 and the wavelength filter 66 are the same as the roles of the optical isolator 34 and the wavelength filter 35 of the first embodiment, being used for, respectively, preventing back-reflected light and removing an input optical signal wavelength component.

The waveform monitor 67 receives an optical signal S66 from the port 61-c of the light polarization separation circuit 61, and performs a waveform evaluation of the optical signal S66.

The control signal generation device 68 receives a result of the waveform evaluation of the optical signal S66 from the waveform monitor 67, generates a control signal for altering the polarization (light polarization) group delay time ΔT of the variable birefringence medium 60, and provides this control signal to the variable birefringence medium 60.

Adjustment of optical axis directions of optical components that structure the optical clock signal regeneration device 1D of the fourth embodiment is performed, for example, as follows.

The axis z4 and axis w4 defined at the light polarization separation circuit 61 are set so as to respectively form angles of 45° with each of the orthogonal optical axes x4 and y4 of the variable birefringence medium 60. A light polarization direction of an optical signal S65 that is outputted from the Faraday rotator 62 is caused to match an oscillation polarization (light polarization) direction of the mode-locking semiconductor laser 400 (i.e., the TE polarization (light polarization) direction, which is the direction of an axis a4).

For output of an optical clock signal C61 from the mode-locking semiconductor laser 400, in FIG. 16, a case is shown in which the optical clock signal C61 is outputted from another resonator end face R4 different from the resonator end face L4 at which the optical signal S65 is inputted. However, this is not limiting, and it is also possible for the optical clock signal C61 to be outputted from the resonator end face L4 at which the optical signal S65 is inputted, such that the resonator end face L4 is used for both input and output. A variant example of device structure in such a case is shown in FIG. 17. In FIG. 17, a circuit which includes a fourth port (the port 61-d) is used as the light polarization separation circuit 61 for an optical clock signal regeneration device 1E. Moreover, as will be described in detail later, because the optical clock signal C61 from the mode-locking semiconductor laser 400 is also outputted from the port 61-d, it is possible to obtain a desired regenerated optical clock signal C62 by connecting the optical isolator 65 and the wavelength filter 66 to the port 61-d.

### (D-2) Operation of the Fourth Embodiment

Next, an optical clock signal regeneration operation of the optical clock signal regeneration device 1D of the fourth embodiment will be described in detail with reference to the drawings.

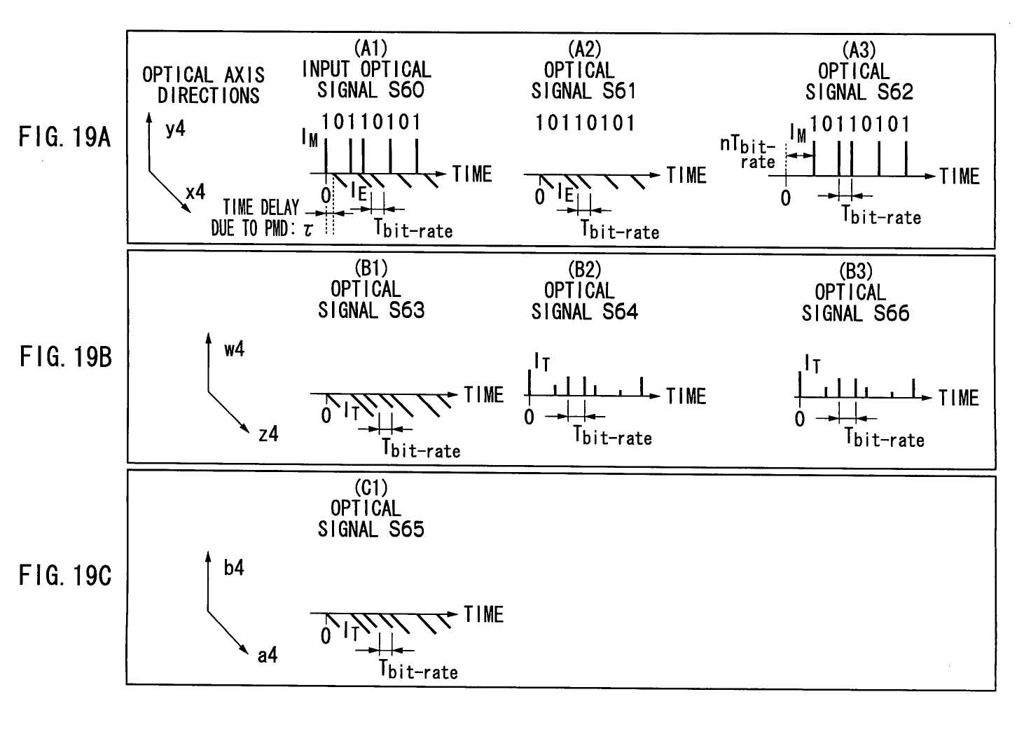

FIG. 19A to FIG. 19C schematically show states of signal waveforms and polarization (light polarization) states of an input optical signal and the like in the fourth embodiment.

In FIG. 19A to FIG. 19C, of the input optical signal S60, a light polarization component in the axis y4 direction is in a state which is advanced relative to a light polarization component in the x4 direction by a time τ, due to the effects of PMD in a fiber propagation network. In such a case, if a polarization (light polarization) group delay time of an amount provided by equation (8) is applied at the variable birefringence medium 60, a relationship between the optical signal S61 and the optical signal S62 at an output terminal from the variable birefringence medium 60 can be set to an optical signal relationship in which the signal positions are offset by an amount corresponding to n bits (in terms of time, nT_{bit-rate}).

nT_{bit-rate}+τ (8)

The optical signals S61 and S62 outputted so as to satisfy equation (8) and optical signals S63 and S64, which are interference waveforms thereof, are identical in quality to the optical signals S31 and S32 and the optical signals S33 and S34 of the first embodiment. Moreover, a function of light inputted at the port 61-a of the polarization (light polarization) separation circuit being outputted from the port 61-b is equivalent to the function effected by the polarization (light polarization)-dependent type optical isolator 31 of the first embodiment.

Therefore, the optical signal S65 is identical in quality to the optical signal S35 of the first embodiment. Accordingly, the mode-locking semiconductor laser 400 receiving the optical signal S65 generates a stable optical clock signal C61 in accordance with the effects of steps (A) and (B) described for the first embodiment.

Meanwhile, the optical signal S66 is an optical signal that is complementary to the optical signal S65. A signal waveform of the optical signal S65 can be expressed as in equation (9), similarly to equation (7).

$${I}_{S 65} ( t ) = {\vert \sqrt{\frac{{I}_{E} I ( t )}{2}} + \sqrt{\frac{{I}_{M} I ( t - n {T}_{bit - rate} )}{2}} {e}^{j ( φ + θ )} \vert}^{2} \qquad ( 9 )$$

A signal waveform of the optical signal S66 can be expressed as in equation (10).

$${I}_{S 66} ( t ) = {\vert \sqrt{\frac{{I}_{E} I ( t )}{2}} - \sqrt{\frac{{I}_{M} I ( t - n {T}_{bit - rate} )}{2}} {e}^{j ( φ + θ )} \vert}^{2} \qquad ( 10 )$$

As shown in equations (9) and (10), the optical signal S66 and the optical signal S65 are mutually complementary signals. Therefore, it is possible to detect a state of the optical signal S65 by detecting a state of the optical signal S66 with the waveform monitor 67.

If a polarization (light polarization) group delay time applied by the variable birefringence medium 60 did not satisfy equation (8), then a relative time difference between the optical signal S61 and the optical signal S62 would not be nT_{bit-rate}, that is, a time difference corresponding to a timeslot corresponding to a number of bits. Consequently, an intensity waveform of the optical signal S66 would commonly be a waveform that included plural maxima in a timeslot corresponding to a single bit. Therefore, the control signal generation device 68 provides control signals to the variable birefringence medium 60, for controlling the polarization (light polarization) group delay time of the variable birefringence medium 60, and controls the polarization (light polarization) group delay time of the variable birefringence medium 60 such that such a signal waveform will not be formed.

The variable birefringence medium 60 that is controlled as described above features a polarization (light polarization) group delay time which satisfies equation (8). Therefore, even when the input optical signal S60 features a polarization (light polarization) delay time τ due to PMD in the fiber propagation network, the delay time can be corrected for. As a result, a stable optical clock signal C61 without phase fluctuations is outputted from the mode-locking semiconductor laser 400.

The role of the Faraday rotator 62 is as follows. Firstly, the light polarization plane of the light outputted from the port 61-b of the light polarization separation circuit 61 (which is linearly polarized light) is turned through +45° by the Faraday rotator 62, and this becomes the optical signal S65 that reaches the resonator end face L4 of the mode-locking semiconductor laser 400. At this time, light of the optical signal S65 is reflected by the resonator end face L4, the light polarization plane thereof is again turned through +45° by the Faraday rotator 62, and this light enters the port 61-b of the light polarization separation circuit 61 and is hence outputted at the port 61-d. In the example of FIG. 16, the port 61-d of the light polarization separation circuit 61 is formed as a non-reflecting end terminal, and thus can remove back-reflected light on the path of input to the mode-locking semiconductor laser 400 from the signal light. Moreover, output light from the mode-locking semiconductor laser 400 that is outputted through the resonator end face L4 of the mode-locking semiconductor laser 400 also passes along the path from the Faraday rotator 62 to the port 61-b of the light polarization separation circuit 61 and to the port 61-d. Hence, because the port 61-d of the light polarization separation circuit 61 is formed as a non-reflecting end terminal, this optical signal will not be inputted to the mode-locking semiconductor laser 400 again.

As described above, because the Faraday rotator 62 is used, operational instability of clock regeneration operations due to back-reflected light through the resonator end face L4 of the mode-locking semiconductor laser 400 can be suppressed.

In the case of the example shown in FIG. 16, because the regenerated clock signal is outputted through the resonator end face R4 of the mode-locking semiconductor laser 400, the optical isolator 65 for preventing back-reflected light is included on an output path joined with the resonator end face R4.

On the other hand, in the case of the example shown in FIG. 17, the port 61-d of the light polarization separation circuit 61 does not serve as a non-reflecting end terminal but is instead joined with the optical isolator 65. Thus, back-reflected light can be prevented, and input of the optical signal and output of the regenerated optical clock signal can be performed using the same resonator end face L4 of the mode-locking semiconductor laser 400.

As described above, because the variable birefringence medium 60 which can alter the polarization (light polarization) group delay time thereof with control signals inputted from thereoutside is used, even when an optical signal featuring a polarization (light polarization) time delay is inputted, it is possible to supply a stable optical clock signal without phase fluctuations.

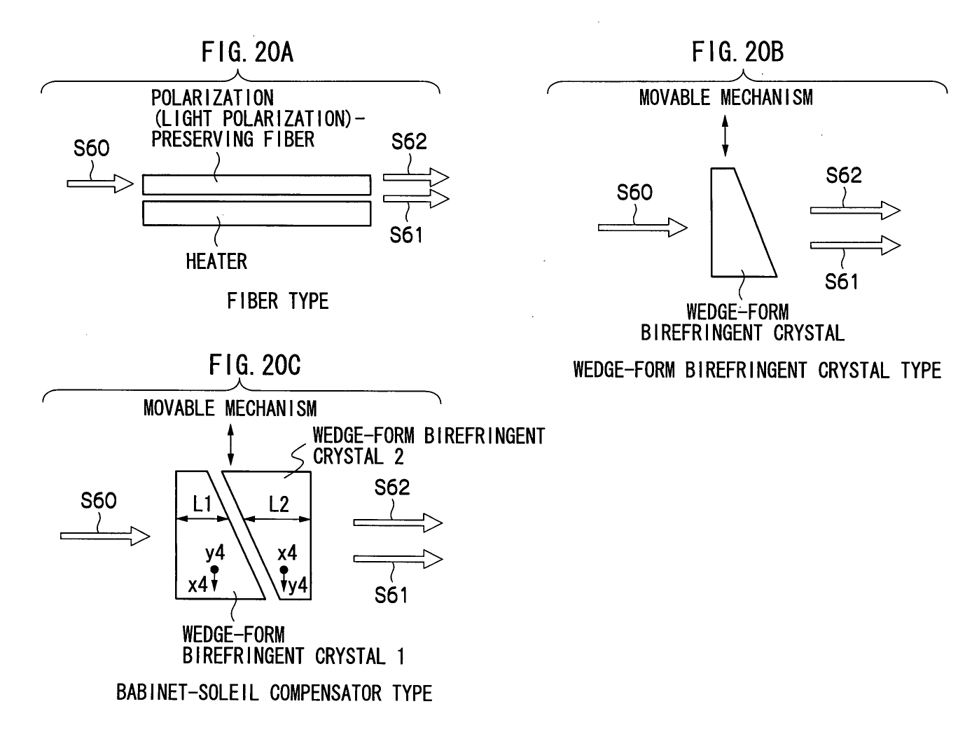

As the variable birefringence medium 60, it is possible to use, for example, mediums as shown in FIG. 20A to FIG. 20C. FIG. 20A is an excellent example of a case in which the PANDA fiber described for the first embodiment is used.

Δn (referred to as modal birefringence in the case of an optical fiber) of a PANDA fiber is known to feature temperature dependency. According to, for example, the test results described from page 29 to page 31 of reference 8, a representative value of Δn of a PANDA fiber is provided by the following equation (11), which includes a temperature change.

Δn=3×10⁻⁴(1+1.2×10⁻³×δTemp) (11)

Therein, δTemp is a change in temperature from room temperature (30° C.).

Herein, 40 Gbit/s (T_{bit-rate}=25 ps) is the bit rate of the input optical signal, n=1 is set, and a length (L) of the PANDA fiber is set to 25 m, such that a polarization (light polarization) group delay time at room temperature is 25 ps. Accordingly, a rate of change of the polarization (light polarization) group delay time when the temperature of the PANDA fiber is changed by 1° C. is estimated from equation (2) and equation (11) at about 0.03 ps/° C.

The rate of change with respect to temperature of the polarization (light polarization) group delay time can be increased to about 0.12 ps/° C. in a case in which the PANDA fiber is lengthened to, for example, n=4, that is, the polarization (light polarization) group delay time is an amount corresponding to four bits.

Anyway, as shown in FIG. 20A, it is possible to structure the variable birefringence medium 60 required for the fourth embodiment by altering the temperature of the PANDA fiber.

Alternatively, as described for the first embodiment, the variable birefringence medium 60 can be structured using a birefringent optical crystal. In such a case, as shown in FIG. 20B, it is possible to realize variability of the polarization (light polarization) group delay time by using a wedge-form birefringent crystal, attaching a movable mechanism thereto, and sliding so as to alter the light path length.

Further still, as shown in FIG. 20C, it is possible to use a “Babinet-Soleil compensator”, in which two wedge-shaped birefringent crystals of which optical axis directions are orthogonal are stuck together. In such a case, a state in which the polarization (light polarization) group delay time is zero (a state in which L1=L2) can be easily realized. When T_{bit-rate} is shortened and this is applied to an ultra-high bit rate optical signal, it is possible to specify a more precise polarization (light polarization) group delay time.

### (D-3) Effects of the Fourth Embodiment

As described above, according to the fourth embodiment, in addition to the effects of the first and third embodiments, the following effect can be provided: Even if an optical signal that includes a polarization (light polarization) time delay due to the effect of polarization mode dispersion in a fiber propagation network or the like is inputted, it is possible to supply a stable optical clock signal that does not have phase fluctuations.

### (E) Fifth Embodiment

Next, a fifth embodiment in which an optical clock signal regeneration device of the present invention is employed will be described with reference to the drawings.

As is well known, an NRZ signal includes a bit-rate frequency component, in a frequency spectrum thereof, of which an intensity component is only zero or extremely weak and, at a spectral component that is dispersed by encoding, only has an intensity of a degree which is virtually invisible.

Therefore, if an NRZ signal is inputted as is to a mode-locking semiconductor laser 500, a stable clock signal will not arise at all, regardless of whether or not clock regeneration operations of the mode-locking semiconductor laser have a polarization (light polarization) dependency.

Therefore, in order to obtain clock signal regeneration operations, it is necessary to convert an NRZ signal to an RZ signal and strengthen the bit-rate frequency component.

Accordingly, the fifth embodiment is characterized in the provision of a conversion component which converts an NRZ signal to an RZ signal.

### (E-1) Structure of the Fifth Embodiment

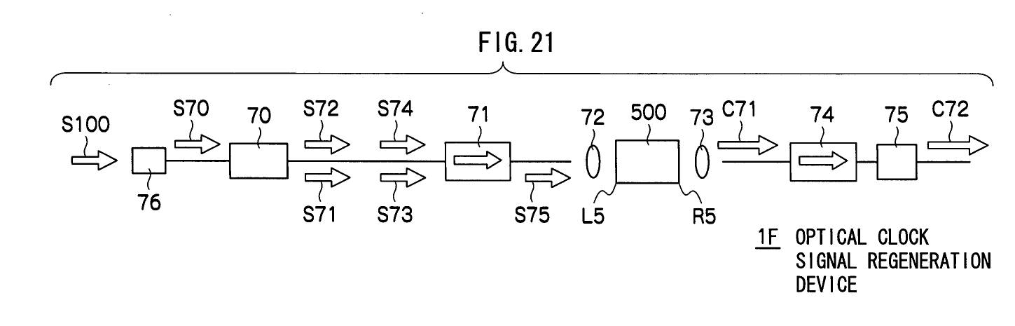

FIG. 21 is a block diagram describing structure of an optical clock signal regeneration device 1F of the fifth embodiment.

In FIG. 21, the optical clock signal regeneration device 1F is structured to include at least the mode-locking semiconductor laser 500, a birefringent medium 70, a polarization (light polarization)-dependent type optical isolator 71, focusing lenses 72 and 73, an optical isolator 74, a wavelength filter 75 and an optical delay interferometer 76.

The structure shown in FIG. 21 is an example of structure of the optical clock signal regeneration device 1F of the fifth embodiment, and is a structure with a form based on the structure of the first embodiment. Naturally, it is also possible to add the particular functional structure of the fifth embodiment, which will be described below, to forms based on the structures of the second, third and fourth embodiments.

For the fifth embodiment, an input optical signal which is a “non-return-to-zero” signal (which may hereafter be referred to as an NRZ signal), of which light intensity does not fall to zero between successive ‘1’ signals, will be considered.

The optical delay interferometer 76 is for converting an input NRZ signal S100 to an RZ converted signal S70, and is disposed on a light path by which an input optical signal is inputted to the birefringent medium 70. Herein, the optical delay interferometer 76 may be a widely employed interferometer provided it is capable of converting NRZ signals to RZ signals. However, it will be effective to employ, for example, a fiber grating illustrated in reference 9, a Mach-Zender interferometer illustrated in reference 3, or the like.

### (E-2) Operation of the Fifth Embodiment

Next, an optical clock signal regeneration operation of the optical clock signal regeneration device 1F of the fifth embodiment will be described with reference to the drawings.

Below, a case in which a Mach-Zender interferometer-type optical delay interferometer is employed as the optical delay interferometer 76 will be illustrated and described.

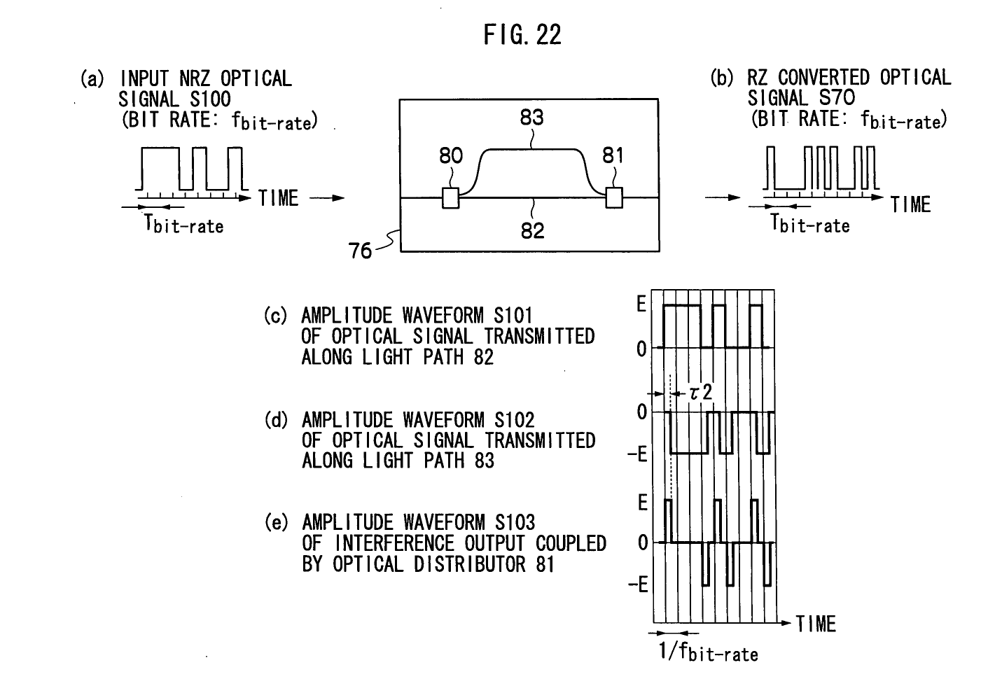

Firstly, with reference to FIG. 22, the principle of a conversion method from an optical signal (an NRZ optical signal) to an RZ optical signal for a case of using a Mach-Zender interferometer-type optical delay interferometer will be described.

The input NRZ optical signal S100 is inputted to the optical delay interferometer 76 and split into two at an optical distributor 80. The optical signal split in two is passed through, respectively, light paths 82 and 83 of the Mach-Zender interferometer, and recoupled at an optical distributor 81.

Here, on the light paths 82 and 83, a relative group delay time τ2 occurs and a phase difference of π arises between the respective optical signals passing along the light paths 82 and 83.

(c) in FIG. 22 is an amplitude waveform of an optical signal S101 upon passing along the light path 82 and reaching the optical distributor 81, if the relative group delay time τ2 is smaller than the signal time interval 1/f_{bit-rate} of the input optical signal S100. (d) in FIG. 22 is an amplitude waveform of an optical signal S102 upon passing along the light path 83 and reaching the optical distributor 81, if the relative group delay time τ2 is smaller than the signal time interval 1/f_{bit-rate} of the input optical signal S100.

Therein, E is a maximum value of amplitude, and in a case in which splitting ratios of the optical distributors 80 and 81 are 1:1, takes the same value for the optical signals S101 and S102.

An interference output amplitude waveform S103 from the optical distributor 81 that is obtained by coupling of these signals is shown in (e) of FIG. 22. As is seen from (e) of FIG. 22, the interference output amplitude waveform S103 is converted to an “RZ signal”, of which the signal level returns to zero between successive bits.

A signal pattern of the RZ converted optical signal S70 differs from a signal pattern of the input NRZ optical signal S100.

For example, in the example of FIG. 22, a signal pattern of the input NRZ optical signal S110 is ‘111010010’, but the signal pattern of the RZ converted optical signal S70 is ‘100111011’. However, because the ultimate objective of clock extraction, as described earlier, is the objective of obtaining output of a continuous pulse series (or sinusoidal wave), such changes from the signal pattern of the input optical signal will not be a problem. Furthermore, as has been described in reference 3, because the process of conversion to the RZ optical signal is all-optically implemented without going through any opto-electronic conversion, this conversion from an NRZ optical signal to an RZ optical signal can be applied to a high-bit rate optical signal without being subject to electronic bandwidth limitations of optical devices and electronic devices.

Provided a “polarization (light polarization)-independent type interferometer”, in which light path differences of orthogonal optical axis directions are equal, is used as the optical delay interferometer 76, conversion from the NRZ optical signal to the RZ optical signal is performed as described above, regardless of the polarization (light polarization) state of the input NRZ optical signal.

The RZ converted optical signal S70 is polarization (light polarization)-undefined light, because the input NRZ optical signal S100 is thus. However, because the RZ converted optical signal S70 is an RZ optical signal, it has a strong bit-rate frequency component, to such an extent that clock regeneration operations can be stably implemented.

Further, when this RZ converted optical signal S70 is inputted to the birefringent medium 70 and thereafter provided to the mode-locking semiconductor laser 500, regenerated optical clock signals C71 and C72 can be provided from the mode-locking semiconductor laser 500 in accordance with the effects described for the first embodiment.

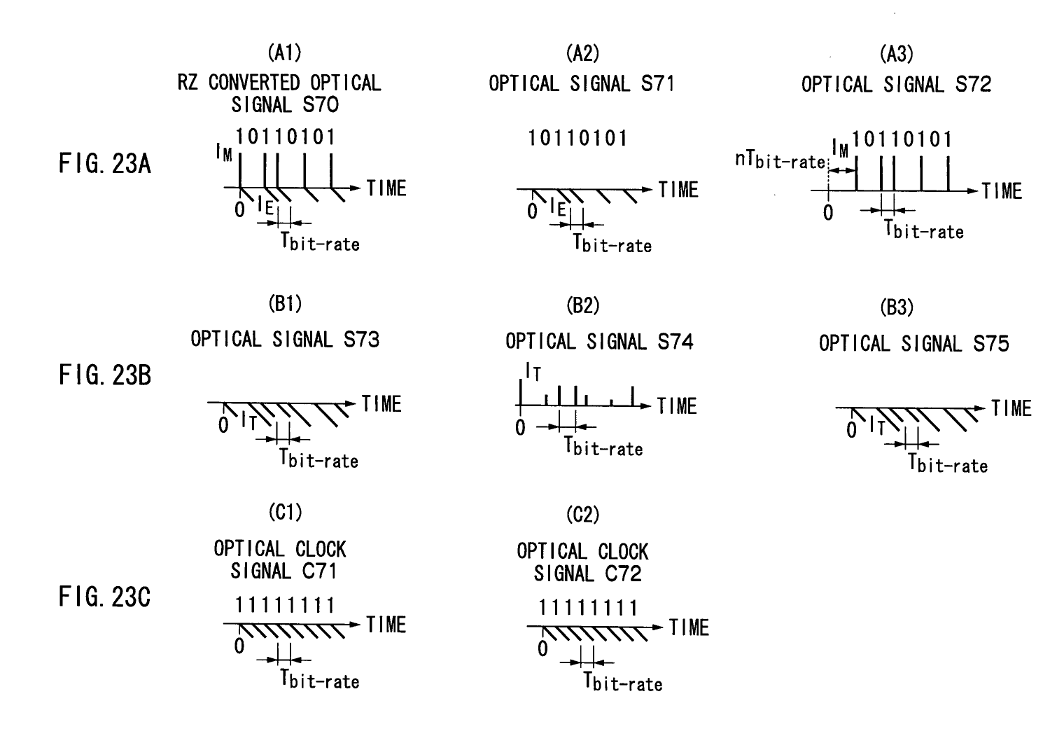

FIG. 23A to FIG. 23C are diagrams schematically showing signal waveforms and polarization (light polarization) states of optical signals and optical clock signals in the fifth embodiment.

As shown in FIG. 23A to FIG. 23C, the RZ converted optical signal S70, the optical signals S71 to S74, and the optical clock signals C71 and C72 correspond, respectively, to the input optical signal S30, the optical signals S31 to S34 and the optical clock signals C31 and C32 of the first embodiment shown in FIG. 4A to FIG. 4C. Detailed descriptions of these have already been given and so will be spared here.

### (E-3) Effects of the Fifth Embodiment

As described above, according to the fifth embodiment, in addition to the effects described for the first to fourth embodiments, the effect illustrated following can be provided: Even if an input optical signal is an NRZ optical signal, all-optical clock signal regeneration can be implemented independently of a polarization (light polarization) state of the input optical signal.

### (F) Other Embodiments

The first to fifth embodiments have been described as structures in which mode-locking semiconductor lasers oscillate with the TE polarization (light polarization). However, similar effects will be provided with passive mode-locking semiconductor lasers which oscillate with the TM polarization (light polarization). Further, for the first to fifth embodiments, “passive mode-locking semiconductor lasers” including saturable absorption regions, which operate as mode lockers to cause mode-locking operations, have been considered as the mode-locking semiconductor lasers 100, 200, 300, 400 and 500. However, it is also possible to employ mode-locking semiconductor lasers of types which do not include saturable absorption regions, provided adjustments in the optical gain, optical absorption and/or refractive index within the lasers occur when optical signals are inputted and optical clock regeneration operations can be caused thereby.

### (G) Sixth Embodiment

Next, a sixth embodiment in which an optical clock signal regeneration device of the present invention is employed will be described in detail with reference to the drawings.

### (G-1) Structure of the Sixth Embodiment

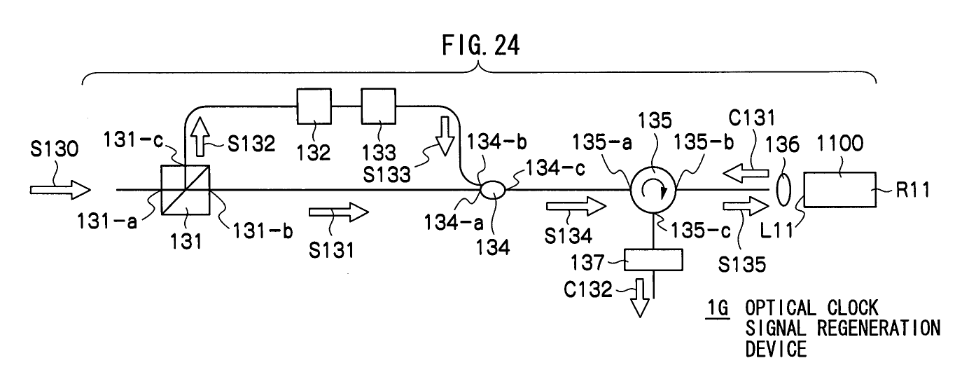

FIG. 24 is a block structural diagram describing structure of an optical clock signal regeneration device 1G of the sixth embodiment.

In FIG. 24, the optical clock signal regeneration device 1G of the sixth embodiment is structured to include at least a mode-locking semiconductor laser 1100, a polarization (light polarization) separation circuit 131, a λ/2 wavelength plate 132, an optical delay circuit 133, an optical coupler 134, an optical circulator 135, a focusing lens 136 and a wavelength filter 137.

In FIG. 24, S130 indicates an input optical signal (signal light) of which a bit rate is f_{bit-rate} (bit/s) and a polarization (light polarization) state is undefined. A frequency corresponding to the bit rate is defined as being a bit-rate frequency. That is, a bit-rate frequency corresponding to the input optical signal with bit rate f_{bit-rate} (bit/s) is f_{bit-rate} (Hz). A signal time interval T_{bit-rate} of the input optical signal is provided by a reciprocal of the bit-rate frequency. That is, the signal time interval T_{bit-rate} of the input optical signal with bit rate f_{bit-rate} (Hz) is 1/f_{bit-rate} (s).

The mode-locking semiconductor laser 1100 is a passive mode-locking semiconductor laser which includes resonator end faces R11 and L11, and in which a repetition frequency of an optical pulse series generated when mode-locking operations occur is close to the bit-rate frequency of the input optical signal. The condition that the repetition frequency of the passive mode-locking semiconductor laser is close to the bit-rate frequency of the input optical signal means that a difference between the bit-rate frequency of the input optical signal and the repetition frequency of oscillation light in the form of a pulse series generated by the passive mode-locking semiconductor laser is small to such an extent that a frequency pulling effect is manifested.

The mode-locking semiconductor laser 1100 is desirably a semiconductor laser with a multi-electrode structure. Moreover, it is desirable that the mode-locking semiconductor laser 1100 assures operational stability in practice and, with a view to providing the device at a lower cost, is an integrated semiconductor laser which is not structured with an external resonator using focusing lenses or the like.

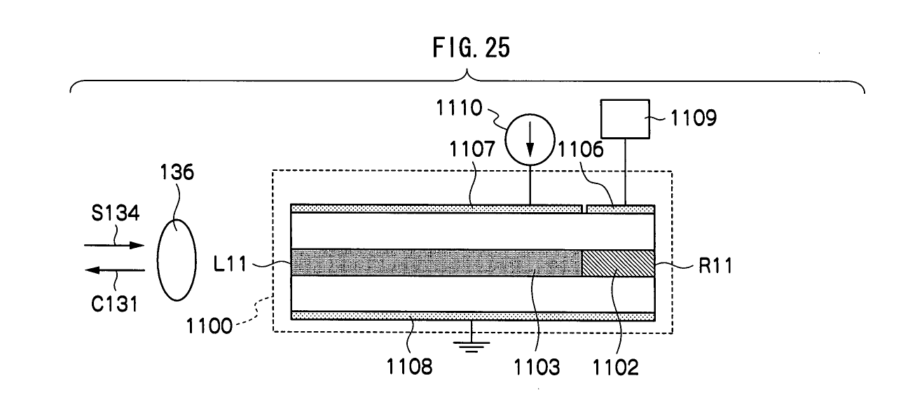

FIG. 25 is a diagram showing a structural example of the mode-locking semiconductor laser 1100. The mode-locking semiconductor laser 1100 of FIG. 25 shows an example of a two-electrode passive mode-locking semiconductor laser. An element structure of the mode-locking semiconductor laser 1100 is structured with a gain region 1103, for providing laser oscillation, and a saturable absorption region 1102, which operates as an optical switch for mode-locking operations. Current is applied to the gain region 1103 from a constant current source 1110 via a p-type electrode 1107 and an n-type common electrode 1108, and a reverse bias voltage is applied to the saturable absorption region 1102 from a constant voltage source 1109 via a p-type electrode 1106 and the n-type common electrode 1108. Hence, a passive mode-locking operation occurs, and an optical pulse series with a repetition frequency close to a natural number multiple of a resonator cycling frequency of the element is generated.

The element structure of the mode-locking semiconductor laser 1100 is not limited to the structure shown in FIG. 25. That is, a structure in which a passive waveguide region, a distributed Bragg reflector region and the like are integrated could also provide the effects of the sixth embodiment. Moreover, for objectives such as an improvement in pulse characteristics and the like, the gain region could just as well have a plurally divided structure. In regard to material type, parallel mode-locking semiconductor lasers which use various semiconductor compounds, such as an InP-type, a GaAs-type or the like, in accordance with desired operation wavelengths can be employed. Further yet, a substrate that is used is not limited to an n-doped substrate and could just as well be a p-doped substrate.

A reflectance of the resonator end face L11 at which the input optical signal is inputted is set to a reflectance low enough that the input optical signal is guided into the mode-locking semiconductor laser 1100. Meanwhile, a reflectance of the resonator end face R11 is not particularly limited, but providing effects of an improvement in previously mentioned mode-locking pulse characteristics and an increase in light intensity of an optical clock signal that is outputted from the resonator end face L11 by the formation of a high reflection coating will be desirable in practice. An arrangement of the gain region 1103 and the saturable absorption region 1102 is not particularly limited, but in order to express an earlier-mentioned effect of colliding pulse mode-locking, it is desirable to dispose the saturable absorption region 1102 in connection with the resonator end face R11 and form a high reflection film coating at the resonator end face R11, as illustrated.

Here, linearly polarized light having a light polarization direction perpendicular to the plane of a drawing is defined as TE polarization (light polarization) light. Linearly polarized light that is orthogonal to such TE polarization (light polarization) light, having a light polarization direction in the plane of a drawing, is defined as TM polarization (light polarization) light. An oscillation polarization (light polarization) direction of the mode-locking semiconductor laser 1100 is the TE polarization (light polarization).

The polarization (light polarization) separation circuit 131 is a polarization (light polarization) separation circuit featuring three input/output ports. The polarization (light polarization) separation circuit 131 inputs light through a port 131-a, outputs a TE polarization (light polarization) component of the input light through a port 131-b, and outputs a TM polarization (light polarization) component of the input light through a port 131-c.

The λ/2 wavelength plate 132 is a λ/2 wavelength plate which takes in light outputted from the polarization (light polarization) separation circuit 131 and turns a light polarization direction of linearly polarized light through 90°.

The optical delay circuit 133 applies a predetermined delay time to light outputted from the λ/2 wavelength plate, and provides the light to the optical coupler 134.

The optical coupler 134 takes in the light outputted from the port 131-b of the polarization (light polarization) separation circuit 131 and the light from the optical delay circuit 133, and couples these lights. The splitting ratio of the optical coupler 134 is 50:50. That is, lights inputted through a port 134-a and a port 134-b of the optical coupler 134 are respectively coupled in 50% amounts of intensities thereof and outputted from a port 134-c.

The optical circulator 135 outputs light inputted through a port 135-a from a port 135-b, and outputs light inputted through the port 135-b from a port 135-c.

As described above, a light path passing through the optical components 131 to 135 is desirably structured by a polarization (light polarization)-preserving optical system including the optical components 131 to 135. Alternatively, the effects of the sixth embodiment can be obtained by including a polarization (light polarization) plane controller at a suitable location in the light path.

The focusing lens 136 is disposed at the resonator end face L11 of the mode-locking semiconductor laser 1100 and is for joining between the mode-locking semiconductor laser 1100 and an optical fiber or the like.

The wavelength filter 137 is disposed in an optical path of the light from the port 135-c of the optical circulator 135, that is, an optical clock signal which is outputted from the mode-locking semiconductor laser 1100, and transmits only a wavelength component of the optical clock signal and blocks light of a wavelength component of the input optical signal.

### (G-2) Operation of the Sixth Embodiment

Next, operation of the optical clock signal regeneration device 1G of the sixth embodiment will be described with reference to the drawings.

Firstly, in FIG. 24, the input optical signal S130, which has been transmitted through an optical fiber propagation network or the like and is undefined polarization (light polarization) light, is inputted to the port 131-a of the polarization (light polarization) separation circuit 131.

Of polarization (light polarization) components of the input optical signal S130, a TE polarization (light polarization) component is outputted from the port 131-b of the polarization (light polarization) separation circuit 131 to serve as an optical signal S131, and a TM polarization (light polarization) component is outputted from the port 131-c of the polarization (light polarization) separation circuit 131 to serve as an optical signal S132.

Hence, the optical signal S132 passes through the λ/2 wavelength plate 132 and the optical delay circuit 133. Thus, the polarization (light polarization) direction thereof is turned through 90° to the TE polarization (light polarization) and a time delay of nT_{bit-rate} (n being an integer other than zero) is applied to the optical signal S131, converting the optical signal S131 to an optical signal S133.

The optical signal S131 and the optical signal S133 are inputted to, respectively, the ports 134-a and 134-b of the optical coupler 134, and coupled output thereof is outputted from the port 134-c to serve as an optical signal S134.

Because the optical signal S131 and the optical signal S133 are both TE polarization (light polarization) light, the optical signal S134 is always TE polarization (light polarization) light regardless of states of polarization (light polarization) of the input optical signal S130. The optical signal S134 is inputted to the port 135-a of the optical circulator 135, and is outputted from the port 135-b to serve as an optical signal S135.

This optical signal S135 is also TE polarization (light polarization) light. The optical signal S135 passes through the focusing lens 136 and is inputted into the resonator end face L11 of the passive mode-locking semiconductor laser 1100.

Then, the optical clock signal C131 that is outputted from the resonator end face L11 of the passive mode-locking semiconductor laser 1100 is inputted, via the focusing lens 136, at the port 135-b of the optical circulator 135.

Hence, a desired final optical clock signal C132 is provided from the port 135-c of the optical circulator 135. If it is necessary to remove light of the input optical signal wavelength component from the optical clock signal C132, then as appropriate, the wavelength filter 137 is introduced connected to the port 135-c of the optical circulator 135, and output from the wavelength filter 137 is provided to serve as the desired final optical clock signal C132.

Now, operations of the optical clock signal regeneration device 1G of the sixth embodiment are principally realized by the following two steps.

(A) A step of obtaining the optical signal S135 with the TE polarization (light polarization) from the input optical signal S130 with undefined polarization (light polarization), and (B) a step of generating a regenerated optical clock signal C131 by inputting the optical signal S135.

Firstly, operations of step (A) will be described with reference to the drawings.

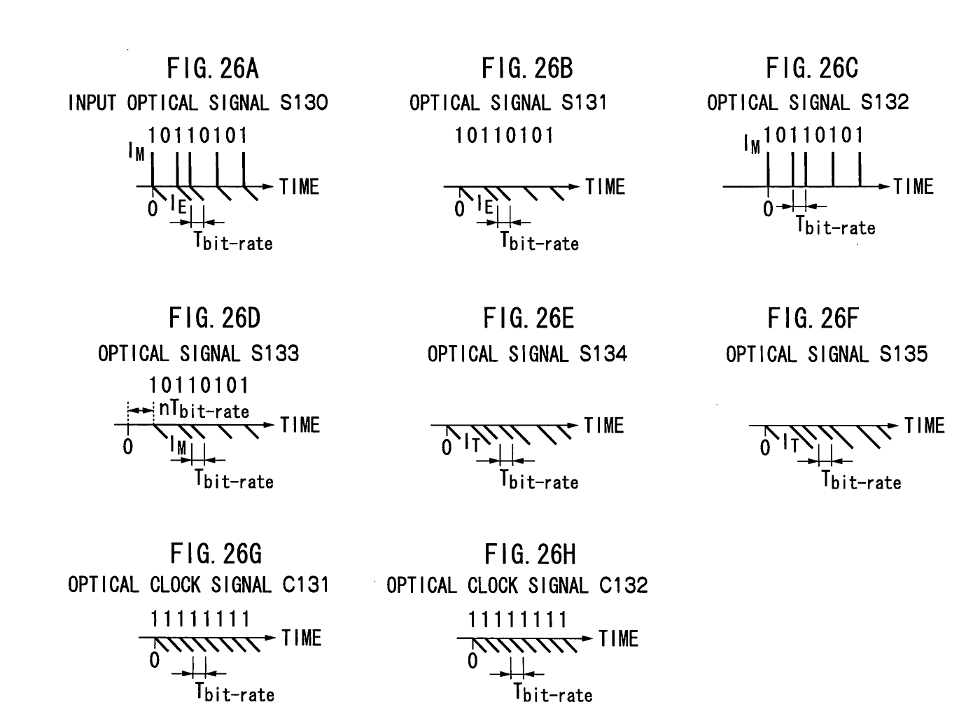

FIG. 26A to FIG. 26H schematically show states of signal waveforms and polarization (light polarization) states of the input optical signal S130, the optical signals S131 to S135 and the optical clock signals C131 and C132.

In FIG. 26A to FIG. 26H, a case in which the input optical signal S130 is an 8-bit signal ‘10110101’ is illustrated. Here, a signal being ‘1’ means a state with a peak intensity being a significant intensity, and ‘0’ means a state which is substantially weaker than the peak intensity of the ‘1’ (and is desirably close to zero). In ordinary digital communications, binary digital signals with these strong and weak signal intensities are distinguished.

First, when a signal of the input optical signal S130 is a ‘1’, the peak intensity of a TE component of the optical signal is I_{E}, and the peak intensity of a TM component of the optical signal is I_{M}. A total signal intensity for ‘1’ is given by I_{E}+I_{M}.

Here, the polarization extinction ratio of the input optical signal (below referred to as the PER) is defined as a value in which the TE component intensity is divided by the TM component intensity, that is, I_{E}/I_{M}.

The input optical signal S130 is an undefined polarization (light polarization) signal, which means that arbitrary polarization extinction ratios can be obtained. Furthermore, because phase relationships of optical carrier waves between the TE component and the TM component are also undefined, a relative phase difference (φ) between the optical carrier waves can take arbitrary values between 0 and 2π. The polarization (light polarization) state of the input optical signal can be defined by the above-mentioned polarization extinction ratio and relative phase difference φ.

Clock regeneration operations being independent of the polarization (light polarization) state of the input optical signal means that, with arbitrary values of the polarization extinction ratio and the relative phase difference φ, large differences in time jitter of a regenerated optical clock signal do not occur, and values at or below certain defined values can always be realized.

The input optical signal S130 is polarization (light polarization)-separated by the polarization (light polarization) separation circuit 131, and separated into the TE polarization (light polarization) optical signal S131 and the TM polarization (light polarization) optical signal S132 (see FIG. 26B and FIG. 26C).

Next, the optical signal S132 passes through the λ/2 wavelength plate 132, and thus the polarization (light polarization) direction thereof is turned through 90°. Thus, the optical signal S132 is converted to the TE polarization (light polarization) and, staying in this polarization (light polarization) state, at the optical delay circuit 133 the optical signal S132 is converted to an optical signal S133 in which a time position of the optical signal is delayed by nT_{bit-rate} (see FIG. 26D).

Then, the optical signal S131 and the optical signal S133 are coupled by the optical coupler 134, and the optical signal S134, which is the coupled output light, is outputted from the port 134-c of the optical coupler 134.

Because the optical signal S134 is coupled light of the optical signal S131 and the optical signal S133, which are TE polarization (light polarization) lights, the optical signal S134 will always be in the TE polarization (light polarization) regardless of an initial polarization (light polarization) state of the input optical signal S130 (see FIG. 26E).

Therefore, when the optical signal S134 has passed through the optical circulator 135 and is inputted to the mode-locking semiconductor laser 1100, the optical signal S135 can always be set to the TE polarization (light polarization) regardless of the initial polarization (light polarization) state of the input optical signal S130 (see FIG. 26F).

This can be simply realized by using a polarization (light polarization)-preserving optical system as the optical components 131 to 135, or including a polarization (light polarization) plane controller at a suitable position of a light path of the optical components 131 to 135.

Consequently, the optical signal S135 is always inputted to the mode-locking semiconductor laser 1100 with the TE polarization (light polarization) regardless of the initial polarization (light polarization) state of the input optical signal S130. Furthermore, similarly to the cases of reference 1 and reference 4, optical clock signal regeneration effects are caused at the mode-locking semiconductor laser 1100 by the application of the effects of step (B), which is described in detail below, and a desired optical clock signal can be obtained.

Next, operations of step (B) will be described with reference to the drawings.

By the processing described for step (A), the optical signal S135 inputted to the mode-locking semiconductor laser 1100 can always be set to the TE polarization (light polarization) regardless of a polarization (light polarization) state of the input optical signal S130.

The next matter to be considered is whether a signal waveform of the optical signal S135 changes in some way in accordance with a polarization (light polarization) state of the input optical signal S130, that is, with values of the polarization extinction ratio and the relative phase difference φ thereof, and whether this then in some way affects clock signal regeneration operations.

An intensity time waveform I_{S130}(t) of the input optical signal S130 is defined by the following equation.

I_{S130}(t)=(I_{E}+I_{M})I(t) (12)

Therein, I_{S130}(t) is a time waveform of the signal, with a peak intensity being defined as 1.

Now, intensity time waveforms I_{S131}(t) and I_{S132}(t) of the optical signals S131 and S132 are as in equations (13) and (14), respectively.

S131:I_{S131}(t)=I_{E}I(t), for an \sqrt{I_{E}I(t)} amplitude waveform (13)

S132:I_{S132}(t)=I_{M}I(t), \sqrt{I_{M}I(t)e^{jφ}} for an amplitude waveform (14)

An intensity time waveform I_{S135}(t) of the optical signal S135 that is inputted to the mode-locking semiconductor laser 1100 can be represented as in equation (15), in accordance with the discussion of step (A).

$${I}_{S 135} ( t ) = {\vert \sqrt{\frac{{I}_{S 131} ( t )}{2}} + \sqrt{\frac{{I}_{S 132} ( t - n {T}_{bit - rate} )}{2}} {e}^{j ( φ + θ )} \vert}^{2} \qquad ( 15 )$$

Herein, θ is the relative phase difference between the optical carrier wave phases which occurs when the optical signals S131, S132 and S1133 pass through the optical components 131, 132, 133 and 134 and the optical path joining the same. θ is included in the form of a sum in the same term with the initial relative phase φ of the original input optical signal S130. Therefore, in the following discussion, it will not be necessary to treat changes in θ separately from changes in φ. That is, a discussion concerning changes in the initial relative phase φ of the input signal S130 is actually a discussion of changes in φ+θ, which includes changes in ƒ. Therefore, for arbitrary values which can be taken by φ+0 (arbitrary values from zero to 2π), provided stability of clock regeneration operations is assured, effects which are objectives for the sixth embodiment will be achieved. Furthermore, assuring stability of clock regeneration operations for arbitrary values of θ means that, in the device structure, control of the optical delay circuit 133, which includes control of the optical carrier wave phase, is not necessary. This means that assembly of a device capable of realizing the effects of the present invention can be implemented at low cost.

For the sake of simplicity in the above equations, excess light losses in the optical components 131, 132, 133, 134 and 135 are ignored.

If the signal waveform of the optical signal I_{S135}(t) is considered on the basis of equation (15), the following will be understood.

(i) In a case in which the relative delay time difference is zero (n=0), when I_{E}=I_{M} (the polarization extinction ratio=1) and φ+θ=π, a contribution from the optical signal S131 and a contribution from the optical signal S133 completely cancel out, and I_{S135}(t)=0.

(ii) In a case in which a relative delay difference is provided (n≠0), when there is a state in which the optical signal S131 is at ‘1’ and the optical signal S133 is at ‘0’, the optical signal S135, which is an interference waveform thereof, has a ‘1’ signal with a peak intensity (I_{T}) of I_{E}/2. On the other hand, when there is a state in which the optical signal S133 is at ‘1’ and the optical signal S131 is at ‘0’, there is a ‘1’ signal in the optical signal S135 of which the peak intensity (I_{T}) is I_{M}/2. Further, when there is a state in which the optical signal S131 and the optical signal S133 are both at ‘0’, there is a ‘0’ signal in the optical signal S135. On the other hand, when there is a state in which the optical signal S131 and the optical signal S133 are both at ‘1’, there is a ‘1’ signal in the optical signal S135, of which a peak intensity (I_{T}) will ordinarily be I_{E}/2+I_{M}/2+(I_{E}I_{M})² cos(φ+θ). However, in the state in which the optical signal S131 and the optical signal S133 are both at ‘1’, under conditions in which I_{E}=I_{M} (the polarization extinction ratio=1) and φ+θ=π, the optical signal S135 is a ‘0’ signal.

(iii) n must be a natural number. That is, n cannot be a rational number such as ½ or the like or an irrational number. When n is a natural number, even if the values of the polarization extinction ratio and/or φ+θ change, ‘1’ signals of the optical signal S135, referred from a single ‘1’ signal, are disposed regularly at time positions which are separated therefrom by integer multiples of T_{bit-rate}. By contrast, if n were not a natural number, time positions of ‘1’s of the optical signal S135 would be disposed irregularly at time positions differing from integer multiples of T_{bit-rate}, in accordance with values of the polarization extinction ratio and φ+θ. As a result, phase shifts would arise in the regenerated optical clock signal that was generated, depending on values of the polarization extinction ratio and φ+θ.

From (i), when no relative delay time difference is obtained between the optical signals S131 and S133, under conditions of I_{E}=I_{M} and φ+θ=π, the optical signal S135 completely disappears. Under such conditions, no optical signal at all is inputted to the mode-locking semiconductor laser 1100, and thus clock regeneration operations cannot occur. In order to avoid such conditions, it is necessary to obtain relative delay times corresponding to numbers of bits between the optical signals S131 and S133.

From (iii), it is necessary to avoid the occurrence of a phase shift, in the regenerated optical clock signal that is generated, for which the delay time difference is a natural number multiple of the signal time interval.

Furthermore, (ii) means the following. Firstly, as is understood from FIG. 26A to FIG. 26H, the signal pattern of the optical signal S135, which is to say a series of bits which are ‘1’s and bits which are ‘0’s, differs from the series of the original input clock signal S130. However, because an ultimate objective of the clock generation is the objective of obtaining output of a continuous pulse series (or sine wave), such a change from the signal pattern of the input optical signal will not be a problem in practice.

(ii) also means the following. Peak intensities of the ‘1’s of the optical signal S135 are not constant but are fundamentally provided with level changes. That is, even if the input optical signal S130 is a tidy signal in which peak intensities of ‘1’ signals are aligned and there are no intensity fluctuations, the optical signal S135 that is inputted to the mode-locking semiconductor laser 1100 will be an optical signal with large “intensity fluctuations” in which peak intensities of ‘1’ signals are not aligned. As is seen from equation (15), these intensity fluctuations are dependent on the polarization extinction ratio and the relative phase difference φ. Furthermore, this means that even if an average intensity of the input signal S130 is constant, an average intensity of the optical signal S135 will change with dependency on the polarization extinction ratio and the phase difference φ (and θ) of the input signal S1130.

Accordingly, because the above-described issues do not affect clock regeneration operations, the mode-locking semiconductor laser 1100 of the sixth embodiment features the following characteristics.

(1) The optical clock regeneration operations feature an intensity noise absorption effect, which can absorb variations in peak intensity of the input optical signal.

(2) In the optical clock regeneration operations, a variation tolerance amount of average input intensity of the optical signal features a significant margin, which enables the realization of a significantly low time jitter in practice.

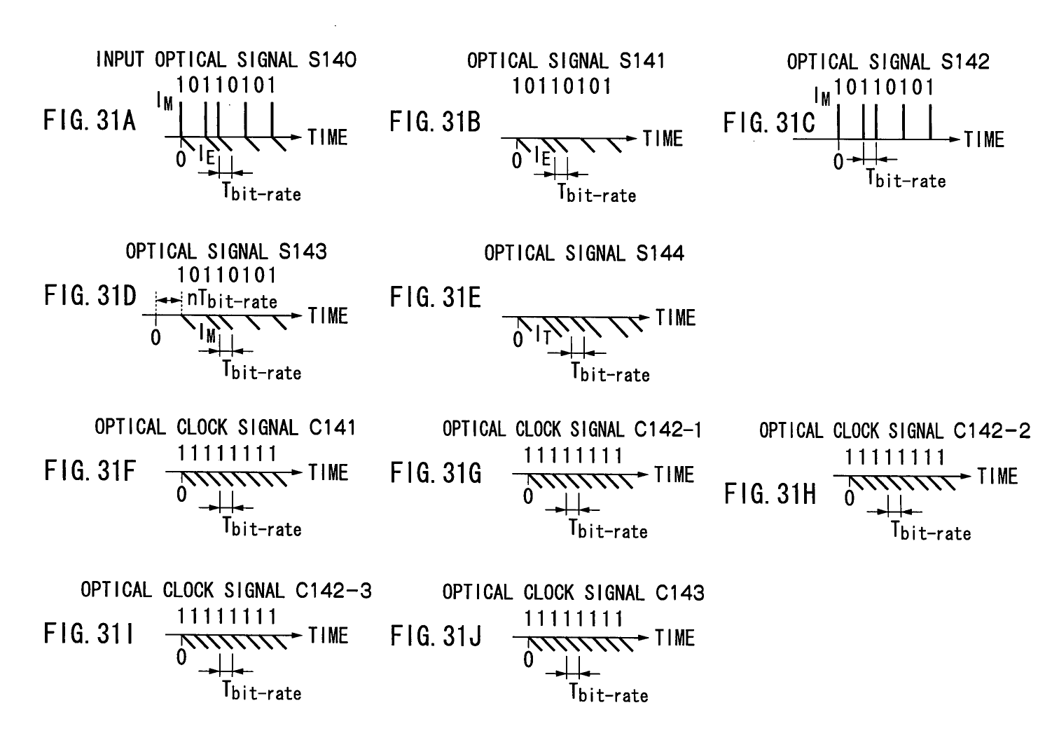

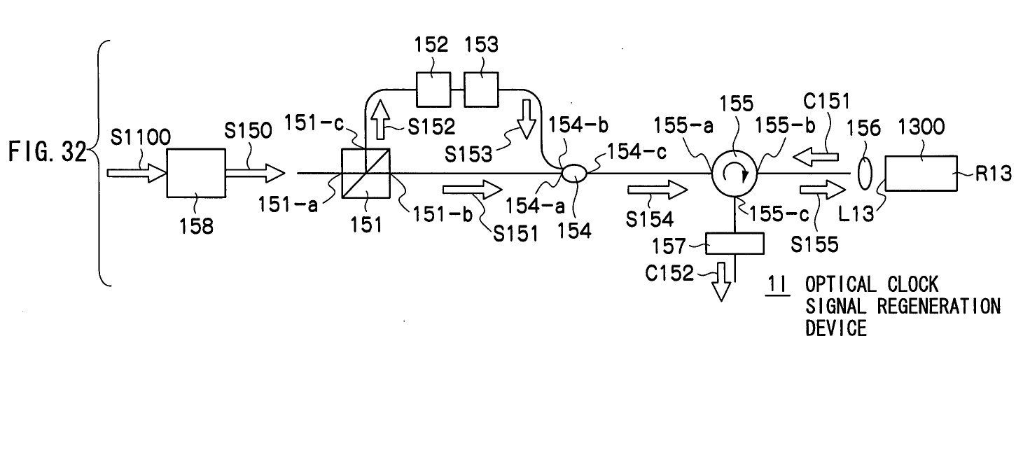

In regard to (1), we have already reported, in the previously mentioned reference 5, an intensity noise absorption effect in all-optical clock regeneration using a mode-locking semiconductor laser. According to the test results illustrated in FIG. 31A to FIG. 31J and FIG. 32 of reference 5, even with signal inputs with ±25% intensity noise, excellent optical clock signal regeneration is achieved, with small intensity fluctuations and time jitter.

As test results to be described in detail later will show, provided an intensity noise absorption effect is present to such an extent, this is sufficient in practice for realizing the sixth embodiment of the present invention. Therefore, peak intensity variations of ‘1’ signals of the optical signal S135 can be sufficiently absorbed in the sixth embodiment of the present invention, and consequently will not be a problem.

Now, in order to advance investigation of (2), it is estimated to what extent the average intensity of the optical signal S135 varies in accordance with the polarization extinction ratio and the phase (φ+θ) of the input optical signal S130.

Here, a pseudo-random signal, which are commonly used in evaluations of optical communication systems, is assumed as the signal pattern of the input optical signal S130. This signal pattern is the same as that illustrated in table 1. The signal is a “7-state bit pseudo-random signal”, and a number of bits is 2⁷−1=127 bits, of which 64 bits are ‘1’ signals and the other 63 bits are ‘0’ signals.

If signal energies of the individual ‘1’ signals are normalized to 1, a normalized average intensity of the input optical signal S30 is 1×64=64.

Results of measurement of polarization extinction ratio (PER) dependencies of maximum values and minimum values of normalized average intensities of the optical signal S135 at such a time are similar to those shown in FIG. 5A and FIG. 5B, but with bit offsets of the optical signals S131 and S133 as the horizontal axes. Here, the maximum values and minimum values of the normalized average intensities are respective maximum values and minimum values when the phase φ+θ is altered for a respective polarization extinction ratio.

When the bit offset n=0, the maximum value of the normalized average intensity is 64, and the minimum value is 0. The maximum value occurs when the polarization extinction ratio=1 and φ+θ=0, and the minimum value occurs when the polarization extinction ratio=1 and φ+θ=π. Such cases are, as has already been mentioned, results of the optical signals S131 and S133 with the same signal patterns and the same peak intensities interfering in phase and in anti-phase, respectively. However, because a case of obtaining a time delay corresponding to a number of bits between the optical signals S131 and S133 is being investigated here, this result can be excluded from consideration in the following discussion.

When the bit offset n≠0, the minimum value of the normalized average intensity is 16, while the maximum value is 48, which is a value three times the minimum value. The maximum value occurs when the polarization extinction ratio=1 and φ+θ=0, and the minimum value occurs when the polarization extinction ratio=1 and φ+θ=π. Dependencies on changes in the bit offset n are not apparent in the current results, which is a result reflecting characteristics of the pseudo-random signal pattern used for the evaluation.

From the above discussion, it is postulated that, for the optical clock signal regeneration device 1G relating to the sixth embodiment, the average intensity of the optical signal S135 inputted to the mode-locking semiconductor laser 1100 varies in a range of ×3 (of the order of around 4.8 dB) in accordance with light polarization states of the input optical signal S130. Therefore, the mode-locking semiconductor laser 1100 of the sixth embodiment uses a structure in which clock regeneration operations have a margin in average input intensity of an optical signal of at least around 4.8 dB.

Furthermore, from the above discussion, because the mode-locking semiconductor laser 1100 that is used has these clock regeneration operations with a margin for average input intensity of an optical signal of around 4.8 dB or more, even when the polarization (light polarization) state of the input optical signal S130 changes, a stable regenerated optical clock signal C131 with small time jitter is outputted from the mode-locking semiconductor laser 1100 to which the optical signal S135 is inputted.

If the regenerated optical clock signal C131 is then inputted to the port 135-b of the optical circulator 135 and outputted from the port 135-c, and it is thereafter necessary to remove an input optical signal wavelength component, the finally desired optical clock signal C132 can be obtained subsequent to using the wavelength filter 137 to remove the input optical signal wavelength component.

### Example

Next, a demonstrative test performed in order to demonstrate the effects of the sixth embodiment will be described.

Here, an InP-based multi-electrode semiconductor laser with a saturable absorption region (length 250 μm), a gain region (610 μm) and a phase adjustment region (150 μm) arranged in this order is used as the passive mode-locking semiconductor laser 1100. The resonator length is 1050 μm and the resonator cycling frequency is about 40 GHz. In a waveguide layer of the gain region, a multiple-quantum well structure is employed in which wells are formed by 0.6%-compressed InGaAsP layers and barrier layers are formed by unstrained InGaAsP layers, and the structure that is used is designed with composition ratios and thicknesses of the layers such that a photoluminescence peak wavelength thereof is 1562 nm. In waveguide layers of the saturable absorption region and the phase adjustment region, a multiple-quantum well structure is employed in which wells are formed by 0.6%-compressed InGaAsP layers and barrier layers are formed by unstrained InGaAsP layers, and the structures that are used are designed with composition ratios and thicknesses of the layers such that photoluminescence peak wavelengths thereof are 1480 nm. Resonator end faces at the two ends of the passive mode-locking semiconductor laser 1100 utilize elements which are simply cleavage surfaces. When current is applied to the gain region of the mode-locking semiconductor laser 1100, the laser oscillation threshold is about 30 mA and a slope efficiency is about 0.1 W/A, illustrating typical values for a semiconductor laser.

The length and composition of each region, thickness of each layer, photoluminescence peak wavelength and suchlike of the mode-locking semiconductor laser 1100 illustrated here are simply a single structural example, and are not limitations.

When a direct current of 145.5 mA is applied to the gain region of the mode-locking semiconductor laser 1100 and a reverse bias voltage of −0.91 V is applied to the saturable absorption region, passive mode-locking operations occur. A pulse width of a mode-locking optical pulse series that is generated at this time is about 3.7 ps, a central wavelength is 1557.4 nm, and a full-width half-maximum spectrum width is 4.3 nm. A repetition frequency of the mode-locking optical pulse series generated at this time is 39.6855 GHz. An average light intensity output from the end face of the mode-locking semiconductor laser 1100 at the phase adjustment region side thereof at this time is about 8.9 dBm.

The input optical signal is a pseudo-random optical signal in a “return-to-zero” (RZ) format, with a bit rate of 39.69012 Gbit/s, a central wavelength of 1547.84 nm and a pulse width of 5.0 ps, of which the light intensity temporarily falls to zero between successive ‘1’ signals. The number of pseudo-random state bits is 7 state bits (2⁷−1=127 bits).

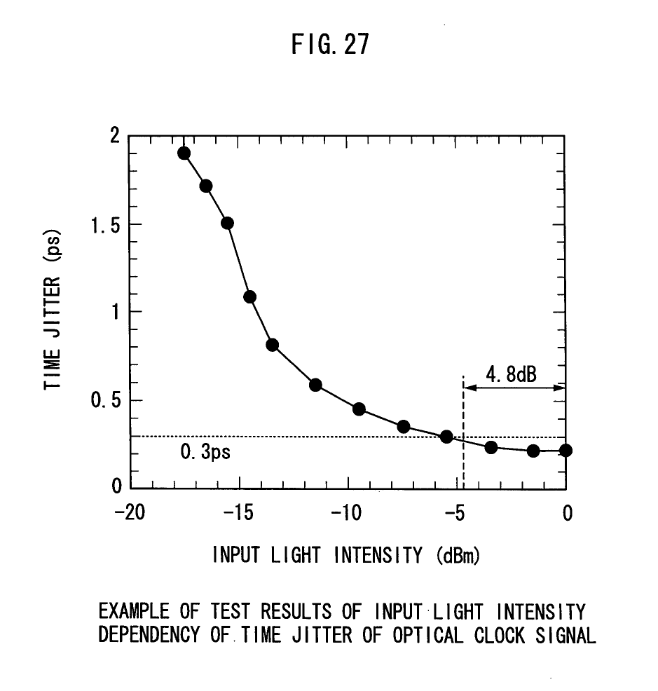

FIG. 27 shows test results of measurement of changes in time jitter of the regenerated optical clock signal generated by the mode-locking semiconductor laser 1100 when the input optical signal intensity (average intensity) into the mode-locking semiconductor laser 1100 changes.

This shows test results for an optical clock signal regeneration device of a previous type illustrated in reference 1, reference 4 and reference 5, at which the polarization (light polarization) state of an input optical signal is fixed in the TE polarization (light polarization). The optical signal is inputted through an end face of a mode-locking semiconductor laser device at a phase adjustment region side thereof.

From FIG. 27, it is seen that time jitter decreases as the input light intensity increases. In FIG. 27, it is seen that a lowered time jitter of not more than 0.3 ps is obtained with a range of input light intensity being from −5.4 dBm to 0 dBm. That is, this shows that obtaining an average input intensity margin in the optical signal of 5.4 dB realizes a time jitter of 0.3 ps or less. This value is a value which satisfies the earlier-described condition for providing the effects of the sixth embodiment (i.e., at least about 4.8 dB). This means that a margin of the average input intensity that is required in order to realize the sixth embodiment can be realized with a practical mode-locking semiconductor laser element.

Next, test results of optical clock signal regeneration operations using the optical clock signal regeneration device 1G formed with the structure shown in FIG. 24 will be described with reference to the drawings.

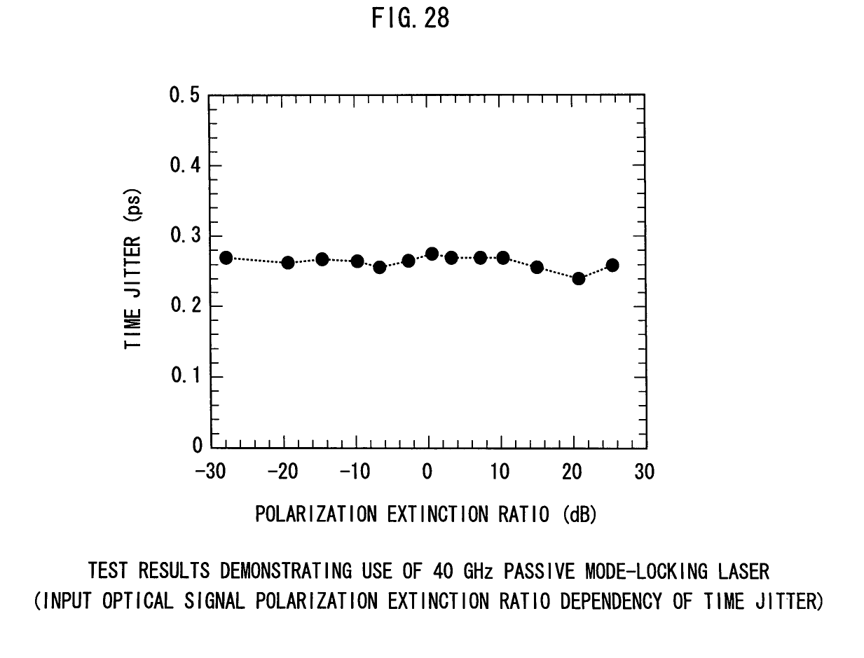

FIG. 28 is a diagram showing a relationship of changes in time jitter of a regenerated optical clock signal to changes in the polarization extinction ratio of the input optical signal. For the test of FIG. 28, a case is shown in which the input light intensity is a fixed value at −4.47 dBm.

From FIG. 28, it is seen that even if the polarization extinction ratio of the input optical signal changes greatly, from +26 dB to −28 dB, the time jitter changes in a very small range, within a range of 0.23 ps to 0.28 ps. This result demonstrates that, when the optical clock signal regeneration device 1G of the sixth embodiment is employed, operations to regenerate a stable all-optical clock signal regardless of polarization (light polarization) states of an input optical signal can be realized with a practical mode-locking semiconductor laser element, and is a test result which demonstrates the effects of the sixth embodiment.

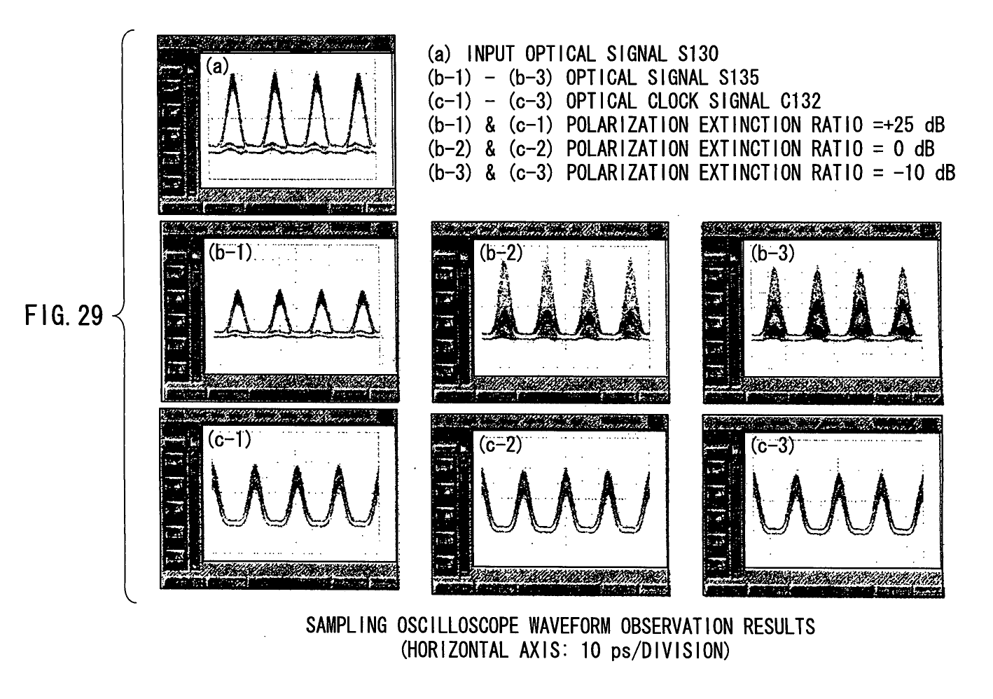

FIG. 29 is views showing sampling oscilloscope observation waveforms of respective signals in cases, using the optical clock signal regeneration device 1G between which the polarization extinction ratio of the input optical signal is changed. (a) of FIG. 29 shows the input optical signal S130, (b) of FIG. 29 show the optical signal S135, and (c) of FIG. 29 show the regenerated optical clock signal C132.

When the polarization extinction ratio of the input optical signal is changed, variations in ‘1’ levels of the optical signal S135 change. In particular, the variations in the ‘1’ levels are large if the polarization extinction ratio is close to 1 (that is, if a TE component intensity and a TM component intensity are about the same).

This is shown, according to the results shown in (b-2) and (b-3) of FIG. 29, by the sampling oscilloscope waveforms of the optical signal S135 being waveforms which have deteriorated to an extent such that eye-openings are not visible when the polarization extinction ratio is 0 dB or −10 dB. Even in such conditions, the sampling oscilloscope waveforms of the regenerated optical clock signal C132 in these cases ((c-2) and (c-3) of FIG. 29), are not inferior in comparison with a sampling oscilloscope waveform of the regenerated optical clock signal C132 when the polarization extinction ratio of the input optical signal S130 is high and thus variations in the ‘1’ levels of the optical signal S135 are small ((c-1) of FIG. 29). This is a test result demonstrating the effects of the sixth embodiment, illustrating that the intensity fluctuation absorption effect operates significantly at the mode-locking semiconductor laser 1100.

From the test results described above, the effects of the sixth embodiment can be demonstrated.

### Variant Example

For the sixth embodiment, the optical clock signal regeneration device 1G with the structure shown in FIG. 24 has been described as an example. However, as long as it is possible to realize the effects of the sixth embodiment, optical components that are required, arrangements thereof and the like are not limited to the optical components, arrangement, etc. shown in the block structural diagram illustrated in FIG. 24, and it is possible to employ a structure using different optical components.

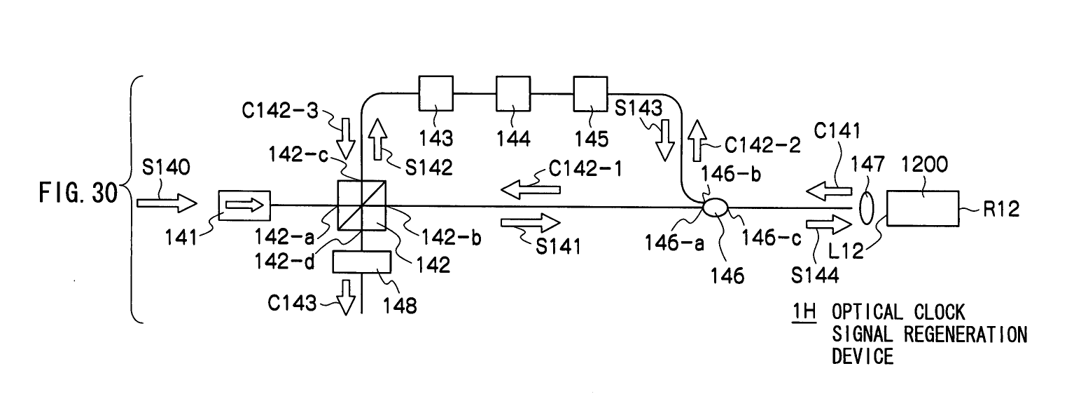

FIG. 30 is a block diagram describing structure of an optical clock signal regeneration device 1H which is a variant example of the sixth embodiment.

In FIG. 30, the optical clock signal regeneration device 1H is structured to include at least a mode-locking semiconductor laser 1200, a polarization (light polarization)-independent type optical isolator 141, a 4-port polarization (light polarization) separation/coupling circuit 142, a Faraday rotator 143, a λ/2 wavelength plate 144, an optical delay circuit 145, an optical coupler 146, a focusing lens 147 and a wavelength filter 148.

The structural example of the optical clock signal regeneration device 1H shown in FIG. 30 differs from the optical clock signal regeneration device 1G shown in FIG. 24 in the following respects.

In the structure of the optical clock signal regeneration device 1H of FIG. 30, the optical circulator 135 is not required. Further, the optical clock signal regeneration device 1H, instead of the λ/2 wavelength plate 132 which turns a light polarization direction through 90° when linearly polarized light is inputted thereto, uses the λ/2 wavelength plate 144, which turns a light polarization direction through +45° when linearly polarized light is inputted thereto, and the Faraday rotator 143, which turns a polarization (light polarization) direction through +450 when linearly polarized light is inputted thereto from the left side of the drawing. Further, instead of the three-port polarization (light polarization) separation circuit 131, the polarization (light polarization) separation/coupling circuit 142 which has four input/output ports is used.

The mode-locking semiconductor laser 1200 is the same as the mode-locking semiconductor laser 1100 of FIG. 24. That is, the mode-locking semiconductor laser 1200 includes resonator end faces L12 and R12, and a repetition frequency of an optical pulse series generated when mode-locking operations occur is close to the bit-rate frequency of the input optical signal. Similarly to the case in FIG. 24, a reflectance of the resonator end face L12 at which the input optical signal is inputted is set to a reflectance low enough that the input optical signal is guided into the mode-locking semiconductor laser 1200. Meanwhile, it is desirable to form a high-reflection film coating at the resonator end face R12.

When light is inputted at a port 142-a, the polarization (light polarization) separation/coupling circuit 142 outputs a TE polarization (light polarization) component thereof through a port 142-b, and outputs a TM polarization (light polarization) thereof component through a port 142-c. Further, when light is inputted at the port 142-b, the polarization (light polarization) separation/coupling circuit 142 outputs a TE polarization (light polarization) component thereof through the port 142-a, and outputs a TM polarization (light polarization) component thereof through a port 142-d. Furthermore, when light is inputted through the port 142-c, the polarization (light polarization) separation/coupling circuit 142 outputs a TE polarization (light polarization) component thereof through the port 142-d, and outputs a TM polarization (light polarization) component through the port 142-a.

The polarization (light polarization)-independent type optical isolator 141 is connected to the port 142-a of the polarization (light polarization) separation/coupling circuit 142, in order to suppress operational instability due to back-reflected light.

The optical coupler 146 is an optical coupler with a splitting ratio of 50:50, similarly to the optical coupler 134 of FIG. 24. Lights that are inputted through a port 146-a and a port 146-b of the optical coupler 146 are respectively coupled in 50% amounts of intensities thereof and outputted by a port 146-c. Further, light that is inputted through the port 146-c is outputted from the port 146-a and the port 146-b in respective 50% amounts of intensity thereof.

The optical delay circuit 145 is the same as the optical delay circuit 133 of the sixth embodiment.

As described above, a light path passing through the optical components 142 to 146 is desirably structured by a polarization (light polarization)-preserving optical system including the optical components 142 to 146. Alternatively, the effects of the sixth embodiment can be obtained by including a polarization (light polarization) plane controller at a suitable location in the light path.

The optical delay circuit 145, similarly to the case in FIG. 24, could be included on a light path joining the port 142-b of the polarization (light polarization) separation/coupling circuit 142 with the port 146-a of the optical coupler 146, for transmitting an optical signal S141.

Optical clock signal regeneration operations of the optical clock signal regeneration device 1H shown in FIG. 30 will be described. FIG. 31A to FIG. 31J are diagrams schematically showing signal waveforms and polarization (light polarization) states of an input optical signal, optical signals and optical clock signals.

Firstly, in FIG. 30, an input optical signal S140, which has been transmitted through an optical fiber propagation network or the like and is undefined polarization (light polarization) light, is transmitted through the polarization (light polarization)-independent type optical isolator 141 and is then inputted to the port 142-a of the polarization (light polarization) separation/coupling circuit 142.

Of polarization (light polarization) components of the input optical signal S140, a TE polarization (light polarization) component is outputted from the port 142-b of the polarization (light polarization) separation/coupling circuit 142 to serve as the optical signal S141, and a TM polarization (light polarization) component is outputted from the port 142-c of the polarization (light polarization) separation/coupling circuit 142 to serve as an optical signal S142.

Hence, the optical signal S142 passes through the Faraday rotator 143, the λ/2 wavelength plate 144 and the optical delay circuit 145. Thus, the polarization (light polarization) direction thereof is turned through a total of 90°, by being turned through +45° by the Faraday rotator 143 and +45° by the λ/2 wavelength plate 144, to the TE polarization (light polarization). Furthermore, a time delay of nT_{bit-rate} (n being an integer other than zero) is applied to the optical signal S141 by the optical delay circuit 145, to convert the same to an optical signal S143.

The optical signal S141 and the optical signal S143 are inputted to, respectively, the ports 146-a and 146-b of the optical coupler 146, and coupled output light thereof is outputted from the port 146-c to serve as an optical signal S144.

Because the optical signal S141 and the optical signal S143 are both TE polarization (light polarization) light, the optical signal S144 is always TE polarization (light polarization) light regardless of states of polarization (light polarization) of the input optical signal S140. The optical signal S144 is inputted, via the focusing lens 147, into the resonator end face L12 of the passive mode-locking semiconductor laser 1200.

Then, an optical clock signal C141 that is outputted from the resonator end face L12 of the passive mode-locking semiconductor laser 1200 is inputted, via the focusing lens 147, at the port 146-c of the optical coupler 146.

Then, optical clock signals C142-1 and C142-2 with the TE polarization (light polarization) are splittedly outputted from, respectively, the port 146-a and the port 146-b of the optical coupler 146.

The optical clock signal C142-1 is inputted to the port 142-b of the polarization (light polarization) separation/coupling circuit 142, and because the polarization (light polarization) direction thereof is the TE polarization (light polarization), is outputted at the port 142-a. Hence, output thereof is cut off by the polarization (light polarization)-independent type optical isolator 141.

Meanwhile, the optical clock signal C142-2 passes through the optical delay circuit 145, the λ/2 wavelength plate 144 and the Faraday rotator 143. At this time, the polarization (light polarization) plane of the optical clock signal C142-2 turns through +45° at the λ/2 wavelength plate 144 and −45° at the Faraday rotator 143. Therefore, the polarization (light polarization) plane is not turned overall, and an optical clock signal C142-3 with the TE polarization (light polarization) is outputted from the Faraday rotator 143. The optical clock signal C142-3 is inputted at the port 142-c of the polarization (light polarization) separation/coupling circuit 142, and because the polarization (light polarization) state thereof is the TE polarization (light polarization), is outputted at the port 142-d.

Hence, if it is necessary to remove light of the input optical signal wavelength component, the optical clock signal C142-3 is passed through the wavelength filter 148 as appropriate, and a final optical clock signal C143 is provided.

With the structure illustrated in FIG. 30 too, a polarization (light polarization) state of the optical signal S1144 that is inputted to the mode-locking semiconductor laser 1200 will always be the TE polarization (light polarization) irrespective of a polarization (light polarization) state of the input optical signal.

Furthermore, similarly to the case shown in FIG. 24, because a time delay corresponding to a number of bits is applied between the optical signal S141 and the optical signal S143, as long as output of the optical signal S144 does not go to zero and clock regeneration operations feature a margin in average input intensity of the optical signal of at least 4.8 dB, stable clock regeneration operations are guaranteed.

### (G-3) Effects of the Sixth Embodiment

As described above, according to the sixth embodiment, the following effects can be expected: All-optical clock signal regeneration operations from a high-bit rate optical data signal, which are not dependent on polarization (light polarization) of the optical data signal that is inputted, are enabled. Furthermore, because these operations can be implemented by inputting the input light signal at one laser end face of a mode-locking semiconductor laser, these operations can be implemented even in a case in which the other laser end face of the mode-locking semiconductor laser has a high reflectance. Thus, because it is possible to employ a mode-locking semiconductor laser at which a high-reflection film coating has been formed at a saturable absorber side end face as the mode-locking semiconductor laser, there are effects of an increase in speed, an increase in output power and suchlike of the regenerated optical clock signal that is generated, and an improvement in pulse characteristics.

### (H) Seventh Embodiment

Next, a seventh embodiment in which an optical clock signal regeneration device of the present invention is employed will be described in detail with reference to the drawings.

As is well known, an NRZ signal includes a bit-rate frequency component, in a frequency spectrum thereof, which is only zero or extremely weak and, at a spectral component that is dispersed by encoding, only has an intensity of a degree which is virtually invisible.

Therefore, if an NRZ signal is inputted as is to a mode-locking semiconductor laser, a stable clock signal will not arise at all, regardless of whether or not clock regeneration operations of the mode-locking semiconductor laser have a polarization (light polarization) dependency.

Therefore, in order to obtain clock signal regeneration operations, it is necessary to convert an NRZ signal to an RZ signal and strengthen the bit-rate frequency component.

Accordingly, the seventh embodiment is characterized in the provision of a conversion component which converts an NRZ signal to an RZ signal.

### (H-1) Structure of the Seventh Embodiment

FIG. 32 is a block diagram describing structure of an optical clock signal regeneration device 1I of the seventh embodiment.

In FIG. 32, the optical clock signal regeneration device 1I of the seventh embodiment is structured to include at least a mode-locking semiconductor laser 1300, a polarization (light polarization) separation circuit 151, a λ/2 wavelength plate 152, an optical delay circuit 153, an optical coupler 154, an optical circulator 155, a focusing lens 156, a wavelength filter 157 and an optical delay interferometer 158.

For the seventh embodiment, an input optical signal which is a “non-return-to-zero” signal (which may hereafter be referred to as an NRZ signal), of which light intensity does not fall to zero between successive ‘1’ signals, will be considered.

The seventh embodiment is provided with, in addition to the structure of the optical clock signal regeneration device 1G shown in FIG. 24, the optical delay interferometer 158, for converting an input NRZ signal S1100 to an RZ converted signal S150.

The structure shown in FIG. 32 is based on the structure of the optical clock signal regeneration device 1G of the sixth embodiment. However, this is not limiting and it is also possible for structure of a light path reaching from the mode-locking semiconductor laser 1300 to output of a regenerated optical clock signal to be formed as a structure based on the structure of the optical clock signal regeneration device 1H shown in FIG. 30.

The optical delay interferometer 158 is for converting the input NRZ signal S1100 to the RZ converted signal S150, and is disposed on a light path by which an input optical signal is inputted to the polarization (light polarization) separation circuit 151. As the optical delay interferometer 158, it is possible to employ, for example, a fiber grating illustrated in reference 6, a Mach-Zender interferometer illustrated in reference 3, or the like.

### (H-2) Operation of the Seventh Embodiment

Next, an optical clock signal regeneration operation of the optical clock signal regeneration device 1I of the seventh embodiment will be described with reference to the drawings.

Below, a case in which a Mach-Zender interferometer-type optical delay interferometer is employed as the optical delay interferometer 158 will be illustrated and described.

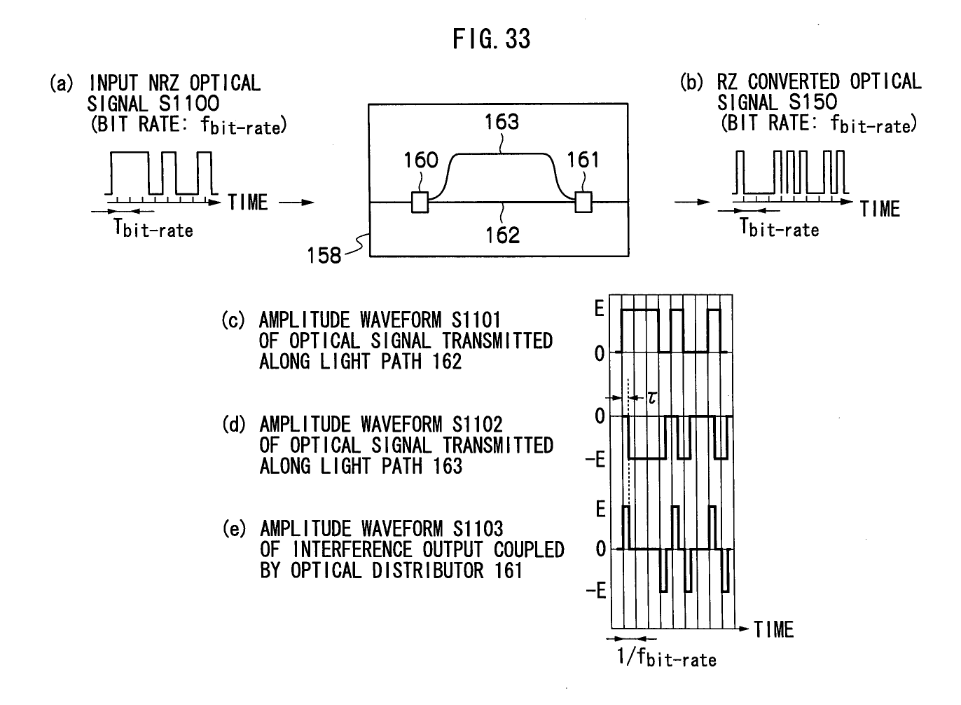

Firstly, with reference to FIG. 33, the principle of a conversion method from an optical signal (an NRZ optical signal) to an RZ optical signal for a case of using a Mach-Zender interferometer-type optical delay interferometer will be described.

The input NRZ optical signal S1100 is inputted to the optical delay interferometer 158 and split into two at an optical distributor 160. The optical signal split in two is passed through, respectively, light paths 162 and 163 of the Mach-Zender interferometer, and recoupled at an optical distributor 161.

Here, on the light paths 162 and 163, a relative group delay time τ occurs and a phase difference of π arises between the respective optical signals passing along the light paths 162 and 163.

(c) in FIG. 33 is an amplitude waveform of an optical signal S1101 upon passing along the light path 162 and reaching the optical distributor 161, if the relative group delay time τ is smaller than the signal time interval 1/f_{bit-rate} of the input optical signal S1100. (d) in FIG. 33 is an amplitude waveform of an optical signal S1102 upon passing along the light path 163 and reaching the optical distributor 161, if the relative group delay time τ is smaller than the signal time interval 1/f_{bit-rate} of the input optical signal S1100.

Therein, E is a maximum value of amplitude, and in a case in which splitting ratios of the optical distributors 160 and 161 are 1:1, takes the same value for the optical signals S1101 and S1102.

An interference output amplitude waveform S1103 from the optical distributor 161 that is obtained by coupling of these signals is shown in (e) of FIG. 33. As is seen from (e) of FIG. 33, the interference output S103 is converted to an “RZ signal”, of which the signal level returns to zero between successive bits.

A signal pattern of the RZ converted optical signal S150 differs from a signal pattern of the input NRZ optical signal S1100.

For example, in the example of FIG. 33, a signal pattern of the input NRZ optical signal S1100 is ‘111010010’, but the signal pattern of the RZ converted optical signal S150 is ‘100111011’. However, because the ultimate objective of clock extraction, as described earlier, is the objective of obtaining output of a continuous pulse series (or sinusoidal wave), such changes from the signal pattern of the input optical signal will not be a problem. Furthermore, as has been described in reference 3, because the process of conversion to the RZ optical signal is all-optically implemented without going through any opto-electronic conversion, this conversion from an NRZ optical signal to an RZ optical signal can be applied to a high-bit rate optical signal without being subject to electronic bandwidth limitations of optical devices and electronic devices.

Provided a “polarization (light polarization)-independent type interferometer”, in which light path differences of orthogonal optical axis directions are equal, is used as the optical delay interferometer 158, conversion from the NRZ optical signal to the RZ optical signal is performed as described above, regardless of the polarization (light polarization) state of the input NRZ optical signal.

The RZ converted optical signal S150 is polarization (light polarization)-undefined light, because the input NRZ optical signal S1100 is thus. However, because the RZ converted optical signal S150 is an RZ optical signal, it has a strong bit-rate frequency component, to such an extent that clock regeneration operations can be stably implemented.

Further, when this RZ converted optical signal S150 is inputted to the polarization (light polarization) separation circuit 151, regenerated optical clock signals C151 and C152 can be provided from the mode-locking semiconductor laser 1300 in accordance with the effects described for the sixth embodiment.

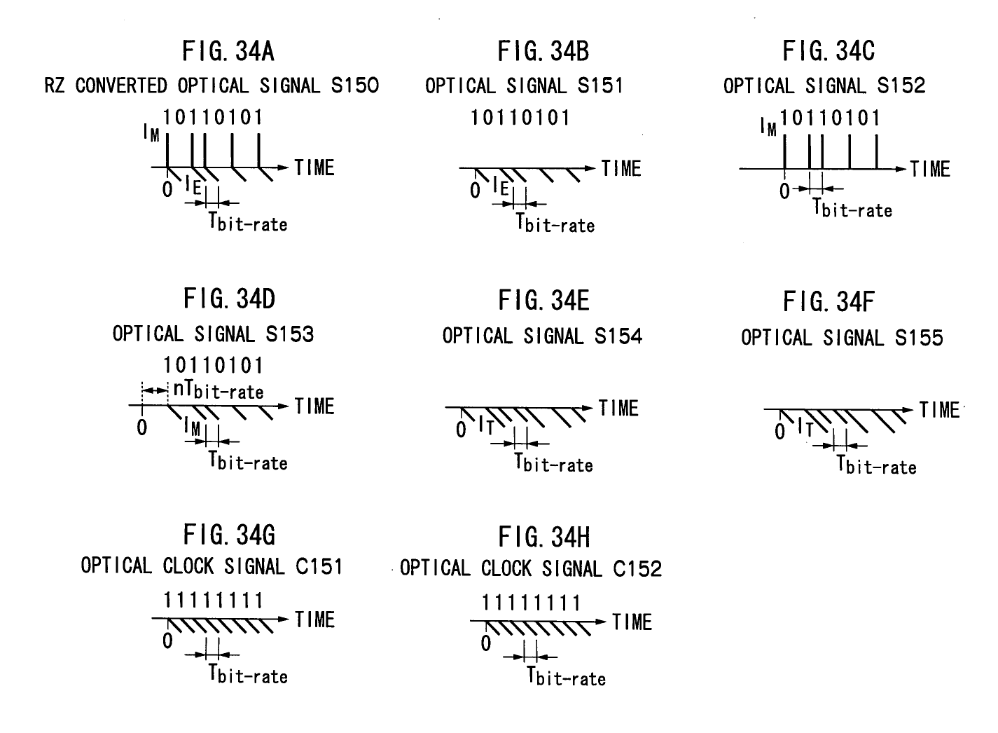

FIG. 34A to FIG. 34H are diagrams schematically showing signal waveforms and polarization (light polarization) states of an input optical signal, optical signals and optical clock signals in the seventh embodiment.

As shown in FIG. 34A to FIG. 34H, the RZ converted optical signal S150, optical signals S151 to S154, and the optical clock signals C151 and C152 correspond, respectively, to the input optical signal S130, the optical signals S131 to S134 and the optical clock signals C131 and C132 of the sixth embodiment shown in FIG. 26A to FIG. 26H. Detailed descriptions of these have already been given and so will be spared here.

### (H-3) Effects of the Seventh Embodiment

As described above, according to the seventh embodiment, in addition to the effects described for the sixth embodiment, the following effect can be provided: Even if an input optical signal is an NRZ optical signal, all-optical clock signal regeneration can be implemented independently of a polarization (light polarization) state of the input optical signal.

### (I) Other Embodiments

The sixth and seventh embodiments have been described as structures in which mode-locking semiconductor lasers oscillate with the TE polarization (light polarization). However, similar effects will be provided with passive mode-locking semiconductor lasers which oscillate with the TM polarization (light polarization). In a case of employing a passive mode-locking semiconductor laser which oscillates with the TM polarization (light polarization), the same effects as in the sixth and seventh embodiments can be obtained by providing structure that turns the polarization (light polarization) direction of a TE polarization (light polarization) component optical signal through 90°.

For the sixth and seventh embodiments, “passive mode-locking semiconductor lasers” including saturable absorption regions, which operate as mode lockers to cause mode-locking operations, have been considered as the mode-locking semiconductor lasers 1100, 1200 and 1300. However, it is also possible to employ mode-locking semiconductor lasers of types which do not include saturable absorption regions, provided adjustments in the optical gain, optical absorption and/or refractive index within the lasers occur when optical signals are inputted and optical clock regeneration operations can be caused thereby.

For the sixth and seventh embodiments, cases have been described of employing passive mode-locking semiconductor lasers coated with a high-reflection film at one resonator end face R11, R12, or R13. However, it is possible to employ a passive mode-locking semiconductor laser in which the resonator end face R11, R12 or R13 is not coated with a high-reflection film. Such a case will be a structure in which the optical signal S135, S144 or S155 that is inputted to the passive mode-locking semiconductor laser is inputted through the resonator end face L11, L12 or L13, and the optical clock signal C131, C141 or C151 that is generated is outputted through the resonator end face R11, R12 or R13. Thus, a structure may be formed in which the optical circulator 135 or 155 is not provided and the wavelength filter 137 or 157, or the like, is connected with the resonator end face R11, R12 or R13.

For the sixth and seventh embodiments, cases have been described in which the polarization (light polarization) direction of one optical signal which has been separated by a polarization (light polarization) separation circuit is turned through 90°. However, provided the optical axis directions of polarization (light polarization) directions of one optical signal and another optical signal which have been polarization (light polarization)-separated can be caused to match, other methods can be employed. For example, the polarization (light polarization) direction of one optical signal that has been polarization (light polarization)-separated may be turned through +45°, and the polarization (light polarization) direction of the other optical signal turned through −45°. In such a case, it will still be necessary to match the two optical axis directions of the polarization (light polarization) direction of a coupled optical signal and the oscillation polarization (light polarization) direction of the mode-locking semiconductor laser.

In FIG. 24, FIG. 30 and FIG. 32, structures are provided in which the polarization (light polarization) direction of one polarization (light polarization)-separated light is turned through 90° and then a time delay is applied. However, structures are possible in which a time delay is applied and then the polarization (light polarization) direction is turned.

Further, a progress direction selection section (for example, an optical isolator or the like) may be provided on the optical path of an optical clock signal in order to block back-reflected light in the light path.

What is claimed is:

1. An optical clock signal regeneration device comprising:
a mode-locking laser element that oscillates laser oscillation light in the form of a series of light pulses with a repetition frequency close to a bit-rate frequency of an inputted signal light;
a signal light provision component that
includes a birefringent medium, at which a polarization (light polarization) group delay time between orthogonal polarization (light polarization) signals, which is caused by a difference in refractive indices between orthogonal optical axes, is a natural number multiple of a signal time interval of the inputted signal light, and,
on the basis of orthogonal polarization (light polarization) signal light obtained by passing input signal light which is inputted from outside through the birefringent medium, provides at least a signal light component with a light polarization direction that matches an oscillation polarization (light polarization) direction of the mode-locking semiconductor laser to the mode-locking laser element; and
an optical clock signal formation component that forms a regenerated optical clock signal based on the laser oscillation light in the form of the series of light pulses oscillated from the mode-locking laser element.

2. The optical clock signal regeneration device of claim 1, wherein
the signal light provision component includes a light polarization and progression direction selection section that is connected with an output end of the birefringent medium, transmits only a signal light component with a light polarization direction in a direction that forms angles of 45° with the orthogonal optical axis directions of the birefringent medium, and blocks light that is propagated in a direction opposite to a light progression direction.

3. The optical clock signal regeneration device of claim 1, wherein
the mode-locking laser element does not provide at least optical gain with respect to a signal light component with a light polarization direction orthogonal to the oscillation polarization (light polarization) direction, and
the birefringent medium of the signal light provision component is disposed such that a direction which forms angles of 45° with the orthogonal optical axis directions matches the oscillation polarization (light polarization) direction of the mode-locking laser element.

4. The optical clock signal regeneration device of claim 3, wherein
the signal light provision component includes a progress direction selection section that is connected with an input end of the birefringent medium and blocks light that is propagated in a direction opposite to a signal light direction.

5. The optical clock signal regeneration device of claim 1, wherein
the mode-locking laser element implements input of the signal light and output of the oscillation laser light through the same resonator end face, and
the device includes a light polarization selection section that is provided in common to each of the signal light provision component and the optical clock signal formation component, transmits only a light component with a light polarization direction in a direction that forms angles of 45° with the orthogonal optical axis directions of the birefringent medium, and outputs the oscillation laser light from the mode-locking laser element toward the optical clock signal formation component.

6. The optical clock signal regeneration device of claim 1, wherein
the signal light provision component includes a variable birefringence medium, substituting for the birefringent medium, at which the polarization (light polarization) group delay time is variable, and
the signal light provision component includes:
a light polarization separation section that is connected with an output end of the variable birefringence medium, outputs a signal light component with a light polarization direction in a direction that forms angles of 45° with orthogonal optical axis directions of the variable birefringence medium at a first port, and outputs a signal light component with a light polarization direction orthogonal thereto at a second port;
a light polarization plane rotation section that turns a light polarization plane of the signal light component from the first port of the light polarization separation section through 45°, and provides the signal light component to the mode-locking laser element with a light polarization direction that matches the oscillation polarization (light polarization) direction of the mode-locking laser element;
a waveform monitoring section that monitors a waveform of the signal light component from the second port of the light polarization separation section; and
a polarization (light polarization) group delay time control section that controls the polarization (light polarization) group delay time of the variable birefringence medium on the basis of a monitoring result from the waveform monitoring section such that, when the input signal light is outputted from the variable birefringence medium, a signal time delay between the orthogonal optical axes of the variable birefringence medium is a natural number multiple of the signal time interval of the input signal light.

7. The optical clock signal regeneration device of claim 6, wherein
the mode-locking laser element implements input of the signal light and output of the oscillation laser light through the same resonator end face, and
the light polarization separation section receives the oscillation laser light from the mode-locking laser element through the second port, via the light polarization plane rotation section, outputs the oscillation laser light through a third port, and passes the oscillation laser light to the optical clock signal formation component.

8. The optical clock signal regeneration device of claim 1, wherein
the optical clock signal formation component includes a progress direction selection section that blocks back-reflected light on a light path.

9. The optical clock signal regeneration device of claim 1, wherein
the optical clock signal formation component includes a wavelength filter that blocks light of a predetermined wavelength component of the oscillation laser light.

10. The optical clock signal regeneration device of claim 1, further comprising, preceding the signal light provision component, an NRZ-RZ conversion component that converts input NRZ signal light to RZ signal light.

11. An optical clock signal regeneration device comprising:
a mode-locking laser element that oscillates laser oscillation light in the form of a series of light pulses with a repetition frequency close to a bit-rate frequency of an inputted signal light;
a signal light provision component that
includes a polarization (light polarization) separation section that polarization (light polarization)-separates inputted input signal light,
adjusts a polarization (light polarization) direction of at least one of one polarization (light polarization)-separated light and another polarization (light polarization)-separated light with respectively orthogonal optical axes, which have been polarization (light polarization)-separated by the polarization (light polarization) separation section, such that the respective polarization (light polarization) directions of the two polarization (light polarization)-separated lights match,
adjusts a signal time interval such that a time interval between the two polarization (light polarization)-separated lights is a natural number multiple of a signal time interval of the input signal light, and
provides coupled light, in which the one polarization (light polarization)-separated light and the other polarization (light polarization)-separated light are coupled, to the mode-locking laser element; and
an optical clock signal formation component that forms a regenerated optical clock signal based on the laser oscillation light in the form of the series of light pulses oscillated from the mode-locking laser element.

12. The optical clock signal regeneration device of claim 11, wherein
the signal light provision component matches the polarization (light polarization) direction of the coupled light to be provided to the mode-locking laser element with an oscillation polarization (light polarization) direction of the mode-locking laser element.

13. The optical clock signal regeneration device of claim 11, wherein
the signal light provision component includes a polarization (light polarization) direction adjustment section that includes at least one optical component, which adjusts the light polarization direction of at least one of the one polarization (light polarization)-separated light and the other polarization (light polarization)-separated light.

14. The optical clock signal regeneration device of claim 11, wherein
the signal light provision component includes a coupling section that couples such that a coupling ratio of the one polarization (light polarization)-separated light and the other polarization (light polarization)-separated light is 1:1.

15. The optical clock signal regeneration device of claim 11, wherein
the mode-locking laser element implements input of the signal light and output of the oscillation laser light through the same resonator end face, and
the device includes a light polarization selection section that is provided in common to each of the signal light provision component and the optical clock signal formation component, provides the coupled light from the signal light provision component to the mode-locking semiconductor laser, and outputs the oscillation laser light from the mode-locking laser element to the optical clock signal formation component.

16. The optical clock signal regeneration device of claim 11, wherein
the mode-locking laser element implements input of the signal light and output of the oscillation laser light through the same resonator end face, and
the polarization (light polarization) separation section of the signal light formation component includes four input/output ports, one input/output port of these four input/output ports being connected with the optical clock signal formation component.

17. The optical clock signal regeneration device of claim 16, wherein
the signal light formation component includes, preceding the polarization (light polarization) separation section, a progress direction selection section that blocks light propagating in a direction opposite to a progress direction of the input signal light.

18. The optical clock signal regeneration device of claim 11, wherein
the optical clock signal formation component includes a wavelength filter that blocks light of a predetermined wavelength component of the oscillation laser light.

19. The optical clock signal regeneration device of claim 11, further comprising, preceding the signal light provision component, an NRZ-RZ conversion component that converts input NRZ signal light to RZ signal light.
